(19) United States
(12) Patent Application Publication
(10) Pub. No.: US 2026/0125498 A1
(43) Pub. Date: May 7, 2026

(54) ION-EXCHANGE MEMBRANES AND METHODS OF MAKING SAME

(71) Applicant: REGENTS OF THE UNIVERSITY OF MICHIGAN, Ann Arbor, MI (US)

(72) Inventors: Jovan Kamcev, Ann Arbor, MI (US); David Kitto, Ann Arbor, MI (US)

(21) Appl. No.: 19/120,649

(22) PCT Filed: Nov. 15, 2023
(86) PCT No.: PCT/US23/79743

§ 371 Date: Apr. 11, 2025

Related U.S. Application Data
(60) Provisional application No. 63/383,907, filed on Nov. 15, 2022.

(51) Int. Cl. C08F 26/06; B01J 39/20

(52) U.S. Cl. CPC C08F 26/06; B01J 39/20

(57) ABSTRACT

Ion-exchange polymers prepared from cross-linkable monomers including at least two polymerizable groups and at least one ionic functional group, copolymers including the cross-linkable monomers and optionally monofunctional monomers including one polymerizable group and at least one ionic functional group, and methods of preparing same.

### CROSS REFERENCE TO RELATED APPLICATIONS

This application claims the benefit under 35 U.S.C. § 119 (e) of U.S. Provisional Application No. 63/383,907, filed Nov. 15, 2023, the entire disclosure of which is incorporated herein by reference in its entirety.

### STATEMENT OF GOVERNMENT INTEREST

This invention was made with government support under grant number DE-SC0022040, awarded by the Department of Energy. The government has certain rights in the invention.

### FIELD

The disclosure relates generally to an ion-exchange polymer and methods of making same, and ion-exchange membranes comprising the ion-exchange polymer of the disclosure. More specifically, the disclosure relates to an ion-exchange polymer prepared from a plurality of polymerizable monomers including monomers including two polymerizable units and at least one ionic functional group.

### BACKGROUND

Ion-exchange membranes (IEMs) are an important class of polymeric materials which primarily see industrial use in water purification and energy storage/generation applications, such as electrodialysis (ED), reverse electrodialysis (RED), redox flow batteries (RFBs), and fuel cells. IEMs have also been implemented in more diverse areas including drug delivery devices, food processing lines, and (bio) chemical reactors. In all of these applications, IEMs are valued for their ability to enhance or impede the transport of species based not only on their size, but also on their ionic state. IEMs feature polymer backbones with ionized or ionizable functional groups, which serve to expedite the transport of ions with opposing charge (counter-ions) while impeding that of those with similar charge (co-ions).

Ion-exchange membranes have two main performance metrics, selectivity and throughput. These performance metrics are primarily derived from charge density, water content, and charge concentration (the ratio of charge density to water content). In general, selectivity increases with charge concentration of the membrane and throughput increases with charge density and water content. Thus, there is a trade-off relationship between the selectivity and throughput, based on their opposing dependence on water content.

Ion-exchange membranes are often prepared from linear polymers. For linear polymers, increasing the ion-exchange capacity (IEC) of a given backbone increases the water content. Charge density initially increases with ion-exchange capacity but reaches a plateau and ultimately decreases due to a “dilution” effect which is a result of the charges being hydrophilic. The swelling of membranes can be reduced by including cross-links which trap the chains in specific configurations and prevent expansion/swelling of the polymer chains. However, commercially employed cross-linkers are neutral and, because of this, the inclusion of the cross-linkers fails to break the co-dependency of water content and IEC. Recently, charged cross-linkers have been incorporated to improve the properties of traditional ion-exchange membranes. Diamines, for example, have been reacted with some polymers to cross-link the polymer chains and introduce additional charge to the polymer.

The usefulness of a single IEM is not universal. The various applications mentioned above have different performance needs. Thus, there is a need in the art for an IEM that can be tuned to have improved performance and efficiency for any given application.

### SUMMARY

One aspect of the disclosure provides an ion-exchange polymer having a structure represented by Formula (I), Formula (II), Formula (III), Formula (IV), Formula (V), Formula (VI), Formula (VII), Formula (VIII), or Formula (IX):

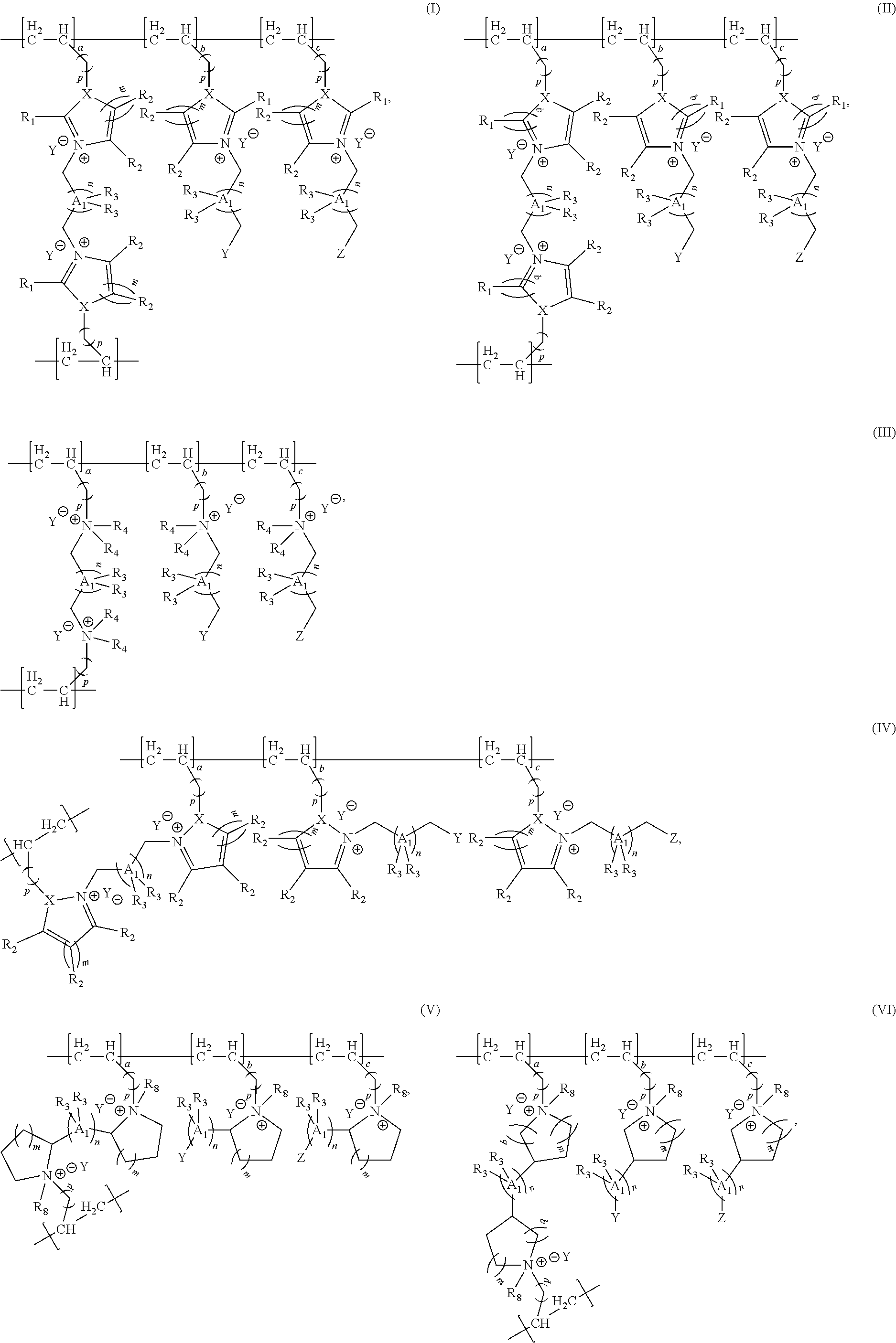

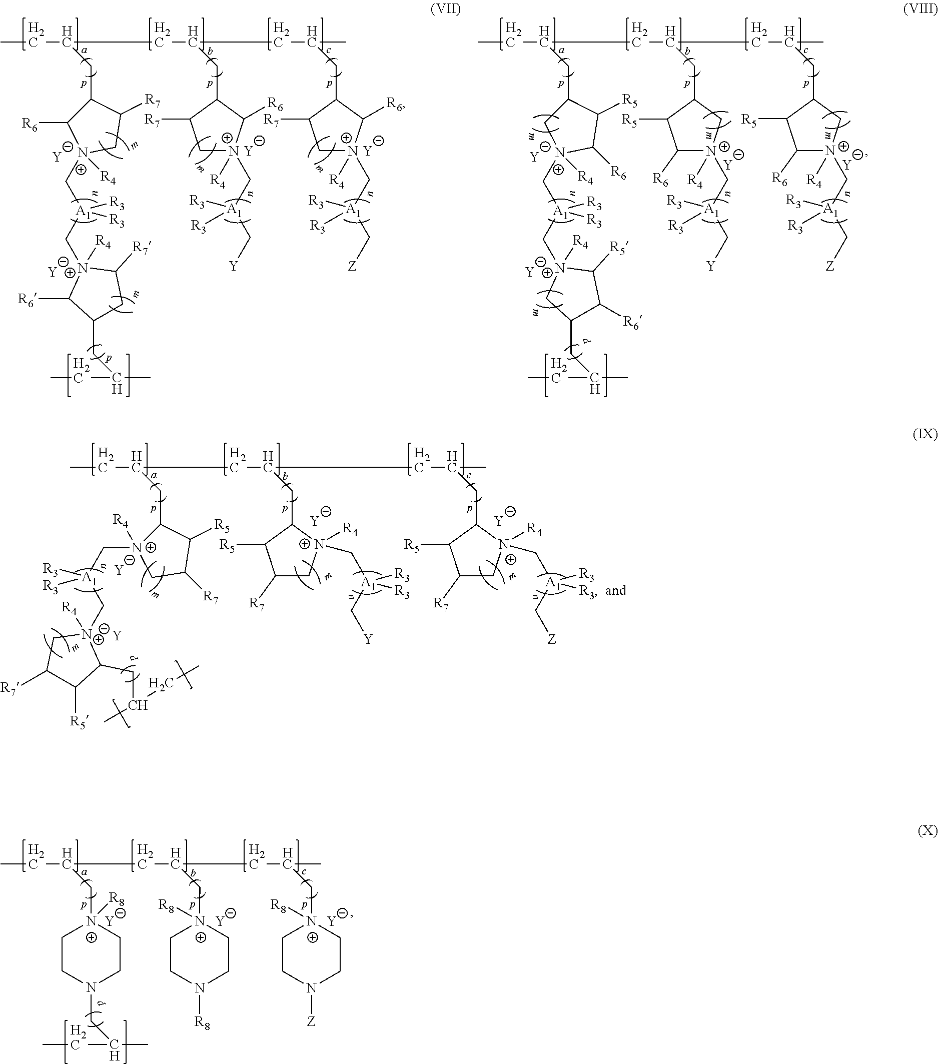

wherein each X is independently selected from C(H) and N; each A₁ is independently selected from C, N, and O, wherein when two adjacent A₁ are N, then one R₃ on at least one N is absent; each n is independently an integer 0 to 10, for example, 0, 1, 2, 3, 4, 5, 6, 7, 8, 9, or 10; each m is independently 1 or 2; each q is independently 1 or 2; each p is independently 0 or 1; each Y is independently an inorganic anion or an organic anion; each Z is independently selected from H, OH, NH₂, C(O)OH, C₁-C₆alkyl, C₁-C₆alkyl-OH, C₁-C₆alkyl-C(O)OH, CH═CH₂, and CH₂CH═CH₂; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl; each of R₅, R₅′, R₆, R₆′, R₇, and R₇′ are independently selected from CH═CH₂, CH₂CH═CH₂, and H; each Rₑ is independently selected from CH═CH₂, CH₂CH═CH₂, C₁-C₆alkyl, C₅-C₆cycloalkyl, and substituted or unsubstituted phenyl; and wherein 0.75≤a+c≤1, 0<a≤0.75, 0≤b≤0.25, 0≤c<0.75, and a+b+c=1. In embodiments wherein R₅, R₅′, R₆, R₆′, R₇, R₇′, and R₈ are CH═CH₂ or CH₂CH═CH₂, the CH═CH₂ and/or CH₂CH═CH₂ group(s) can be polymerized as part of the polymer network.

Another aspect of the disclosure provides an ion-exchange polymer prepared from polymerizing a plurality of monomers, wherein the plurality of monomers comprises monomers of Compound (I), Compound (II), Compound (III), Compound (IV), Compound (V), Compound (VI), Compound (VII), Compound (VIII), and a combination thereof:

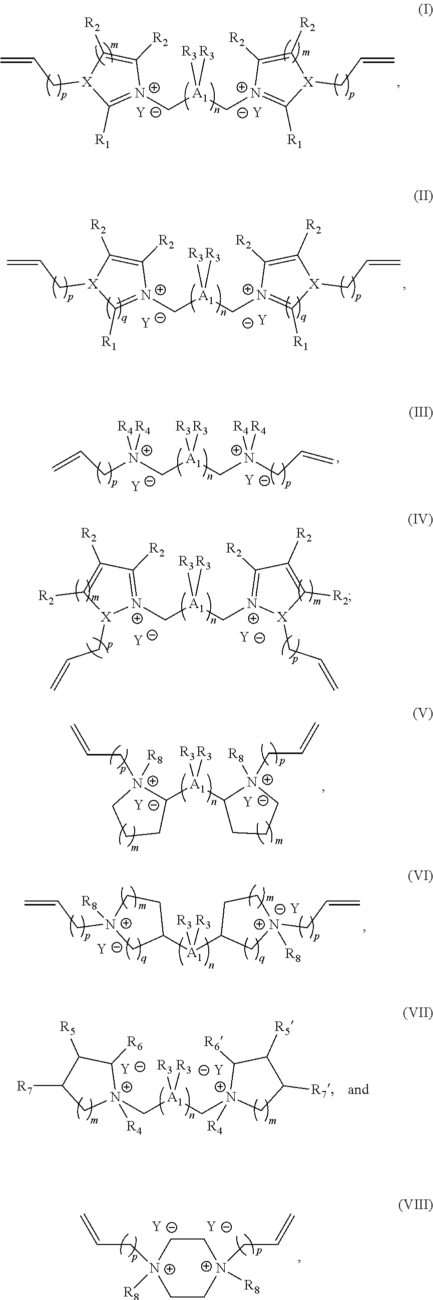

wherein each x is independently selected from C(H) and N; each A₁ is independently selected from C, N, and O, wherein when two adjacent A₁ are N, then one R₃ on at least one N is absent; n is 0-10, for example, 0, 1, 2, 3, 4, 5, 6, 7, 8, 9, or 10; each m is independently 1 or 2; each q is independently 1 or 2; each p is 0 or 1; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl; each of R₅, R₅′, R₅, R₅′, R₇, and R₇′ are selected from CH═CH₂, CH₂CH═CH₂ and H, wherein at least one of R₅, R₆, and R₇ is CH═CH₂ or CH₂CH═CH₂ and at least one of R₅′, R₆′, and R₇′ is CH═CH₂ or CH₂CH═CH₂; each R₈ is independently selected from CH═CH₂, CH₂CH═CH₂, C₁-C₆alkyl, C₅-C₆cycloalkyl, and substituted or unsubstituted phenyl; and each Y is independently an inorganic anion or an organic anion.

In embodiments of the foregoing aspect, the plurality of monomers can further comprise monomers of Compound (IX), Compound (X), Compound (XI), Compound (XII), Compound (XIII), Compound (XIV), or Compound (XV):

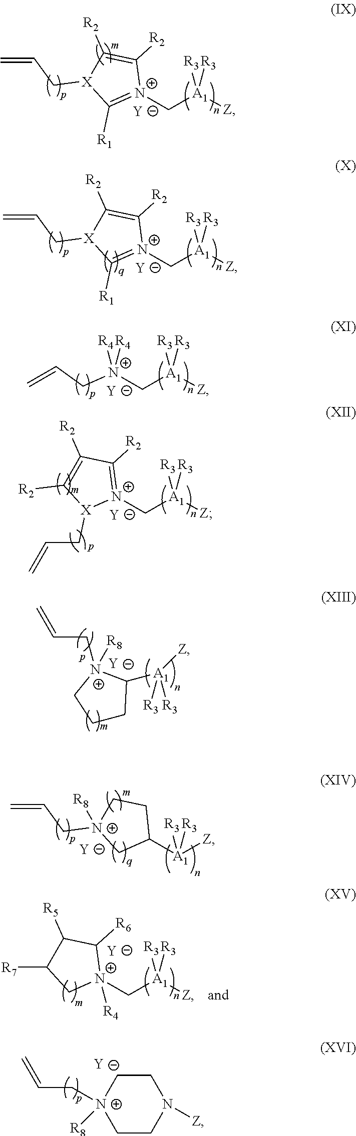

wherein each of X, A₁, R₁, R₂, R₃, R₄, R₅, R₆, R₇, R₈, n, m, q, p, and Y are defined as defined herein for the Compounds (I)-(VII) and each Z can independently be selected from H, OH, NH₂, C(O)OH, C₁-C₆alkyl, C₁-C₆alkyl-OH, C₁-C₆alkyl-C(O)OH, CH═CH₂, and CH₂CH═CH₂.

Another aspect of the disclosure provides a method of preparing an ion-exchange polymer, the method including a) admixing (i) a polymerization initiator; and (ii) a monomer solution comprising (iia) an optional solvent and (iib) a plurality of monomers, wherein the plurality of monomers comprises monomers according to Compound (I), Compound (II), Compound (III), Compound (IV), Compound (V), Compound (VI), Compound (VII), Compound (VIII), and a combination thereof:

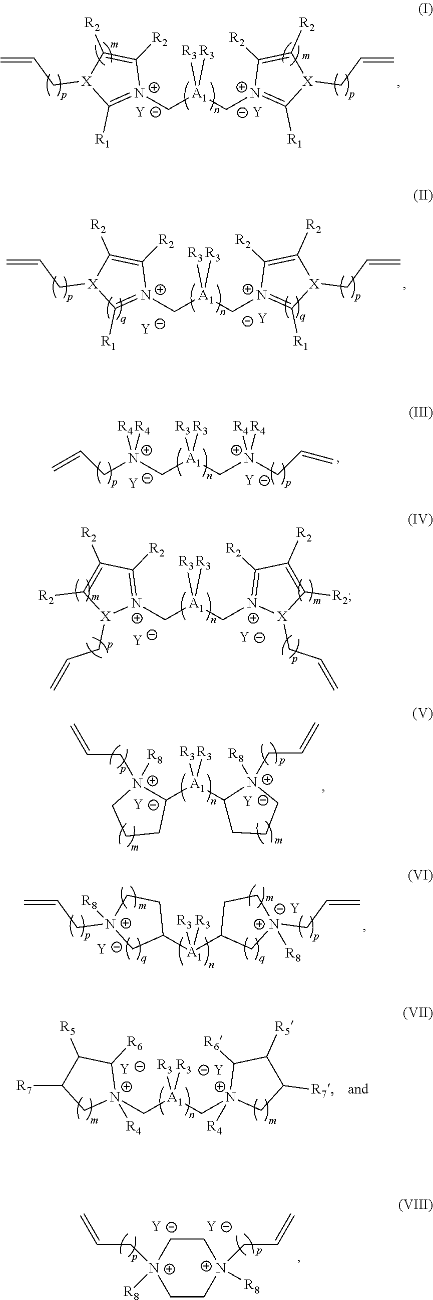

wherein each X is independently selected from C(H) and N; each A₁ is independently selected from C, N, and O, wherein when two adjacent A₁ are N, then one R₃ on at least one N is absent; n is 0, 1, 2, 3, 4, 5, 6, 7, 8, 9, or 10; each m is independently 1 or 2; each q is independently 1 or 2; each p is 0 or 1; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl; each of R₅, R₅′, R₆, R₆′, R₇, and R₇′ are selected from CH═CH₂, CH₂CH═CH₂ and H, wherein at least one of R₅, R₆, and R₇ is CH═CH₂ or CH₂CH═CH₂ and at least one of R₅′, R₆′, and R₇′ is CH═CH₂ or CH₂CH═CH₂; each R₈ is independently selected from CH═CH₂, CH₂CH═CH₂, C₁-C₆alkyl, C₅-C₆cycloalkyl, and substituted or unsubstituted phenyl; and each Y is independently an inorganic anion or an organic anion; and b) polymerizing the monomer solution to form the ion-exchange polymer. In embodiments, the monomer solution consists of the plurality of polymers and optionally the solvent.

In embodiments of the foregoing aspect, the plurality of monomers can further comprise monomers of Compound (IX), Compound (X), Compound (XI), Compound (XII), Compound (XIII), Compound (XIV), or Compound (XV):

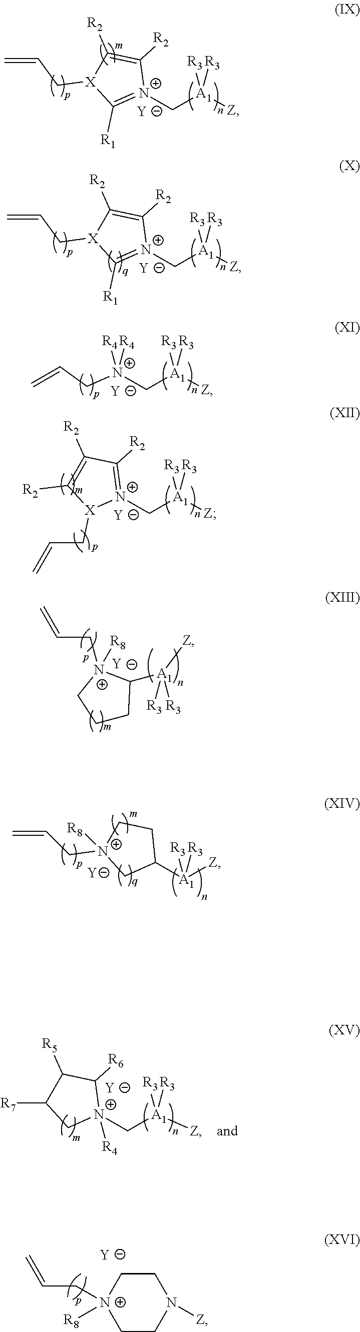

wherein each of X, A₁, R₁, R₂, R₃, R₄, R₅, R₆, R₇, R₈, n, m, q, p, and Y are defined as defined herein for the Compounds (I)-(VII) and each Z can independently be selected from H, OH, NH₂, C(O)OH, C₁-C₆alkyl, C₁-C₆alkyl-OH, C₁-C₆alkyl-C(O)OH, CH═CH₂, and CH₂CH═CH₂.

Further aspects and advantages will be apparent to those of ordinary skill in the art from a review of the following detailed description. While the compositions and methods are susceptible of embodiments in various forms, the description hereafter includes specific embodiments with the understanding that the disclosure is illustrative, and is not intended to limit the disclosure to the specific embodiments described herein.

### BRIEF DESCRIPTION OF THE DRAWINGS

While the specification concludes with claims particularly pointing out and distinctly claiming the subject matter, which is regarded as forming the present invention, it is believed that the invention will be better understood from the following description taken in conjunction with the accompanying drawings.

FIG. 1 is plot of charge density (mol/L membrane) versus water volume fraction in the membrane for ion-exchange polymers of the disclosure and prior art membranes.

FIG. 2 is a plot of counter-ion/co-ion selectivity versus throughput (mol/cm/s) for ion-exchange polymers of the disclosure and commercially available prior art membranes tested with 1 m NaCl solutions.

FIG. 3 is a plot of counter-ion/co-ion conductivity versus water volume fraction for membranes of the disclosure and prior art membranes in the Cl⁻ form contacting DI water.

FIG. 4 is a plot of fixed charge density (mol/L membrane) versus water volume fraction in the membrane from ion-exchange polymers of the disclosure and prior art membranes.

FIG. 5 is a plot of counter-ion/co-ion selectivity versus throughput (mol/cm/s) for ion-exchange polymers of the disclosure and commercially available prior art membranes tested with 1 m NaCl solutions.

FIG. 6 is a plot of fixed charge density (mol/L membrane) versus water volume fraction in the membrane from ion-exchange polymers of the disclosure and prior art membranes.

### DETAILED DESCRIPTION

Provided herein are ion-exchange polymers having a structure represented by Formulas (I), (II), (III), (IV), (V), (VI), (VII), and (VIII) and methods of making said ion-exchange polymers. Polymers having a structure represented by Formulas (I), (II), (III), (IV), (V), (VI), (VII), and (VIII) can be used to facilitate the exchange of ions in solution. The polymers and methods of the disclosure can provide one or more advantages including, for example, providing an ion-exchange polymer and ion-exchange membrane (IEM) having significantly higher charge densities than commercially available IEMs, allowing the selectivity of the ion-exchange polymer to be tuned according to the needs of a given application, allowing control over the water volume fraction of the ion-exchange polymer, allowing the charge density of the ion-exchange polymer to be tuned according to the needs of a given application, providing ion-exchange membranes that perform in water-based systems, and/or providing ion-exchange polymers and membranes that are stable in caustic environments.

The ion-exchange polymers of the disclosure are generally free of ester (—O—C(O)—) and amide (—N—C(O)—) functional groups and, accordingly, the monomers used to prepare the ion-exchange polymers of the disclosure are generally free of acrylate and acrylamide polymerizable units. The cross-linkable monomers of the disclosure advantageously include only a vinyl or an allyl moiety as the polymerizable group, instead of other common polymerizable moieties, e.g., (meth)acrylates, (meth)acrylamides, or styrenes. Styrenes produce a bulky hydrophobic polymer backbone, which becomes limiting when trying to improve the performance of water-based systems, such as systems where IEMs are implemented.

(Meth)acrylates and (meth)acrylamides are less hydrophobic than styrenes; however, such polymerizable groups have disadvantages over the vinyl and allyl groups of the monomers of the disclosure. For example, the acrylate and acrylamide groups are larger and bulkier than a vinyl or an allyl group, which limits the charge density attainable by a membrane. More significantly, the ester and amide groups incorporated into the polymer are susceptible to base-catalyzed transesterification and transamidation reactions, respectively. Energy applications of IEMs (e.g., fuel cells, electrolysis, and batteries) almost exclusively operate under caustic conditions. There has been growing attention towards hydroxide-based anion-exchange membrane (AEM) applications in the past decade or so because of their comparatively cheap catalysts. However, the stability and performance of AEMs is currently a limiting factor, and next-generation IEMs should be able to operate in caustic environments. Broadly, there are two sites on an IEM where base-catalyzed degradation may occur: the cation itself or the surrounding polymer structure. The stability of the ion can be addressed by substituting electron donating groups in proximity of the cation that can delocalize its structure and remove acidic protons. The stability of the polymer backbone is addressed in the monomers of the disclosure by minimizing reactive sites such as esters or amides. As a direct result, the vinyl and allyl polymerization sites are well suited for energy-sector IEMs. Additionally, there is ongoing interest in energy applications of IEMs that operate under acidic conditions. Without intending to be bound by theory, it is believed that the ion-exchange polymers/membranes of the disclosure will demonstrate enhanced stability in acidic environments, relative to polymers/membranes including ester and/or amide reactive sites that result from polymerizing (meth)acrylate and/or (meth)acrylamide monomers.

The ion-exchange polymers of the disclosure have structures represented by Formulas (I), (II), (III), (IV), (V), (VI), (VII), and (VIII) and these polymers may also be referred herein to as “polymers of (or according to) Formula (I),” “polymers of Formula (II),” “polymers of Formula (III)”, and “polymers of Formula (IV),” and the like. Similarly, cross-linkable monomers of the disclosure have structures represented by Compounds (I), (II), (III), (IV), (V), (VI), (VII), and (VIII) and these monomers may also be referred to as “monomers of (or according to) Compound . . . ” and/or “bifunctional monomers of (or according to) Compound . . . ” Similarly, the disclosure provides monofunctional monomers having structures represented by Compounds (IX), (X), (XI), (XII), (XIII), (XIV) and (XV) and these monomers may also be referred to as “monomers of (or according to) Compound . . . ” and/or “monofunctional monomers of (or according to) Compound . . . ” Similarly, the disclosure provides imperfect monomers having structures represented by Compounds (Ia), (IIa), (IIIa), (IVa), (Va), (VIa), and (VIIa), and these monomers may also be referred to as “monomers of (or according to) Compound . . . ” and/or “imperfect monomers of (or according to) Compound . . . ” In structures shown herein, hydrogen atoms are shown where necessary for clarity. Any hydrogen atom not shown can be considered implied where necessary to provide a full valence shell for, e.g., a central carbon atom.

It is also to be understood that the terminology used herein is for the purpose of describing particular aspects only and is not intended to be limiting. As used in the specification and in the claims, the term “comprising” can include the aspects of “consisting of” and “consisting essentially of.” Unless defined otherwise, all technical and scientific terms used herein have the same meaning as commonly understood by one of ordinary skill in the art to which the disclosed compositions and methods belong.

The term “about” is used according to its ordinary meaning, for example, to mean approximately or around. In one embodiment, the term “about” means±10% of a stated value or range of values. In another embodiment, the term “about means±5% of a stated value or range of values. A value or range described in combination with the term “about” expressly includes the specific value and/or range as well (e.g., for a value described as “about 40,” “40” is also expressly contemplated).

The terms ion-exchange polymer and ion-exchange membranes are generally used interchangeably herein, unless the context dictates otherwise. An ion-exchange membrane can consist of an ion-exchange polymer, or can optionally include a support material as described herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

### Compounds of the Disclosure

The disclosure provides an ion-exchange polymer, the ion-exchange polymer comprising the product of polymerizing a plurality of cross-linkable monomers and, optionally, imperfect monomers and monofunctional monomers. In general the cross-linkable monomers include two terminal vinyl polymerizable groups, two terminal allyl polymerizable groups, or a vinyl polymerizable group and an allyl polymerizable group and at least one ionic functional group. When referring to the cross-linkable monomers of the disclosure, the term “bifunctional” refers to the presence of two polymerizable groups. The cross-linkable monomer can be designed and selected to provide an ion-exchange polymer with tunable properties including, but not limited to, charge density, selectivity, and throughput. In embodiments, the cross-linkable monomers can be selected from the group of Compound (I), Compound (II), Compound (III), Compound (IV), Compound (V), Compound (VI), Compound (VII), Compound (VIII), or a combination thereof:

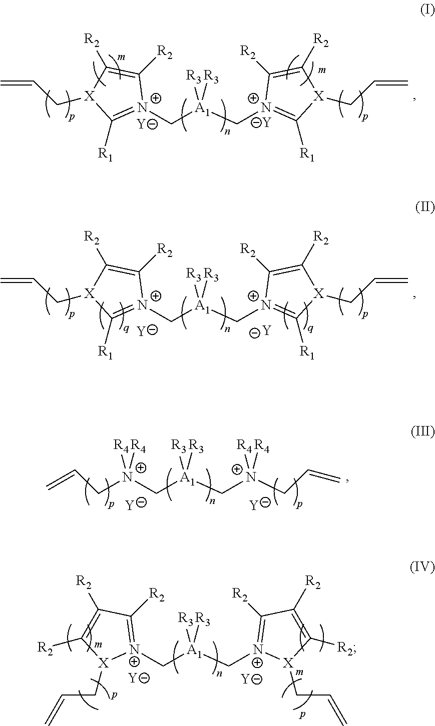

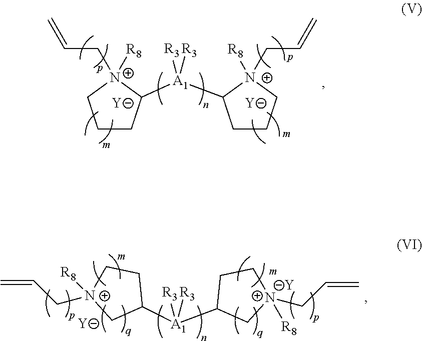

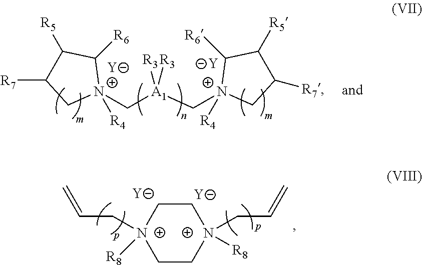

wherein each X is independently selected from C(H) and N; each A₁ is independently selected from C, N, and O, wherein when two adjacent A₁ are N, then one R₃ on at least one N is absent; each n is independently 0-10, for example 0, 1, 2, 3, 4, 5, 6, 7, 8, 9, or 10; each m is independently 1 or 2; each q is independently 1 or 2; each p is 0 or 1; each Y is independently an inorganic anion or an organic anion; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl, each of R₅, R₅′, R₆, R₆′, R₇, and R₇′ are selected from CH═CH₂, CH₂CH═CH₂ and H, wherein at least one of R₅, R₅, and R₇ is CH═CH₂ or CH₂CH═CH₂ and at least one of R₅′, R₆′, and R₇′ is CH═CH₂ or CH₂CH═CH₂, and each R₈ is independently selected from CH═CH₂, CH₂CH═CH₂, C₁-C₆alkyl, C₅-C₆cycloalkyl, and substituted or unsubstituted phenyl.

As used herein, the abbreviation “C(H)” refers to a carbon atom having a hydrogen atom bonded thereto. In the case wherein a structure shows a central atom having an R group, such as an R₃ group, bound to the central atom, the R group is considered to be “on” the central atom. Thus, in cases wherein “one R₃ on at least one N is absent” the actual compound does not include at least one R₃ group that is depicted in the drawn structure of the corresponding general formula.

As used herein, the abbreviation “C(O)OH” refers to a carboxylic acid group wherein the “(O)” represents the oxygen double bonded to the carbon.

As used herein, the term “alkyl” refers to straight chained and branched saturated hydrocarbon groups containing one to thirty carbon atoms, for example, one to twenty two carbon atoms, or one to twenty carbon atoms, one to ten carbon atoms, or one to six carbon atoms. The term Cn means the alkyl group has “n” carbon atoms. For example, C₄ alkyl refers to an alkyl group that has 4 carbon atoms. C₁₋₂₀alkyl and C₁-C₂₀ alkyl refer to an alkyl group having a number of carbon atoms encompassing the entire range (i.e., 1 to 20 carbon atoms), as well as all subgroups (e.g., 1-20, 2-15, 1-10, 5-12, 1, 2, 3, 4, 5, 6, 7, 8, 9, 10, 11, 12, 13, 14, 15, 16, 17, 18, 19, and 20 carbon atoms). Nonlimiting examples of alkyl groups include, methyl, ethyl, n-propyl, isopropyl, n-butyl, sec-butyl (2-methylpropyl), t-butyl (1,1-dimethylethyl), 3,3-dimethylpentyl, and 2-ethylhexyl. Unless otherwise indicated, an alkyl group can be an unsubstituted alkyl group or a substituted alkyl group. A specific substitution on an alkyl can be indicated by inclusion in the term, e.g., “haloalkyl” indicates an alkyl group substituted with one or more (e.g., one to 10) halogens.

As used herein, the term “cycloalkyl” refers to an aliphatic cyclic hydrocarbon group containing four to twenty carbon atoms, for example, four to fifteen carbon atoms, four to ten carbon atoms, five to eight carbon atoms, or five to six carbon atoms (e.g., 4, 5, 6, 7, 8, 10, 12, 14, 15, 16, 17, 18, 19 or 20 carbon atoms). The term Cn means the cycloalkyl group has “n” carbon atoms. For example, C₅ cycloalkyl refers to a cycloalkyl group that has 5 carbon atoms in the ring. C₅₋₈cycloalkyl and C₅-C₈ cycloalkyl refer to cycloalkyl groups having a number of carbon atoms encompassing the entire range (i.e., 5 to 8 carbon atoms), as well as all subgroups (e.g., 5-6, 6-8, 7-8, 5-7, 5, 6, 7, and 8 carbon atoms). Nonlimiting examples of cycloalkyl groups include cyclobutyl, cyclopentyl, cyclohexyl, cycloheptyl, and cyclooctyl. Unless otherwise indicated, a cycloalkyl group can be an unsubstituted cycloalkyl group or a substituted cycloalkyl group. The cycloalkyl groups described herein can be isolated or fused to another cycloalkyl group, a heterocycloalkyl group, an aryl group and/or a heteroaryl group, or a bicyclic group or a tricyclic group. For example, the cycloalkyl groups described herein can be a cyclohexyl fused to another cyclohexyl, or an adamantyl.

As used herein, the term “heterocycloalkyl” refers to an aliphatic cyclic hydrocarbon group having four to twenty carbon atoms and at least one heteroatom selected from the group of N, O, and S. As used herein, the term “n-member heterocycloalkyl” refers to a heterocycloalkyl having “n” backbone atoms selected from the group of C, N, O, and S. For example, a 5-member heterocycloalklyl refers to a heterocycloalkyl group that has 5 atoms in the ring. A 5- to 8-member heterocycloalkyl refers to heterocycloalkyl groups having a number of atoms in the cyclic backbone encompassing the entire range (i.e., 5 to 8 atoms), as well as all subgroups (e.g., 5-6, 6-8, 7-8, 5-7, 5, 6, 7, and 8 atoms). Unless otherwise indicated, a heterocycloalkyl group can be an unsubstituted heterocycloalkyl group or a substituted cycloalkyl group.

As used herein, the term “substituted,” when used to modify a chemical functional group, refers to the replacement of at least one hydrogen radical on the functional group with a substituent. Substituents can include, but are not limited to, alkyl, cycloalkyl, alkenyl, cycloalkenyl, alkynyl, heterocycloalkyl, heterocycloalkenyl, ether, polyether, thioether, polythioether, aryl, heteroaryl, hydroxyl, oxy, alkoxy, heteroalkoxy, aryloxy, heteroaryloxy, ester, thioester, carboxy, cyano, nitro, amino, amido, acetamide, and halo (e.g., fluoro, chloro, bromo, or iodo). When a chemical functional group includes more than one substituent, the substituents can be bound to the same carbon atom or to two or more different carbon atoms.

In embodiments, in the monomers according to Compound (I), Compound (II), or Compound (IV) at least one X is N. In some embodiments, both X are N. In some embodiments, at least one X is C(H). In some embodiments, both X are C(H).

In general, in the monomers according to Compound (I), Compound (II), Compound (III), Compound (IV), Compound (V), Compound (VI), and Compound (VII), each n can be 0 or any integer. Without intending to be bound by theory, it is believed that as n increases above 1, the charge density of the resulting polymer decreases. Further, without intending to be bound by theory, it is believed that as n increases, the flexibility of the cross-linkable monomer increases, which can help accommodate more sterically bulky R₁, R₂, R₃, and R₄ groups into the monomers and resulting polymers. Thus, in some embodiments, n can be in a range of 0-10, 0-9, 0-8, 0-7, 0-6, 0-5, 0-4, 0-3, 0-2, 0-1, 1-10, 1-9, 1-8, 1-7, 1-6, 1-5, 1-4, 1-3, or 1-2. In embodiments, n can be 0, 1, 2, 3, 4, 5, 6, 7, 8, or 9. In embodiments, n can be 0, 1, 2, 3, 4, 5, 6, or 7. In embodiments, n can be 0, 1, 2, 3, 4, or 5. In embodiments, n can be 0, 1, 2, or 3. In embodiments, n can be 0, 1, or 2. In embodiments, n can be 0 or 1. In embodiments, n can be 0. In embodiments, n can be 1. In embodiments, n can be 2.

In general, in the monomers according to Compound (I), Compound (IV), Compound (V), Compound (VI), and Compound (VII), each m can be 0 or 1. In embodiments, at least one m is 0. In embodiments, both m are 0. In embodiments, at least one m is 1. In embodiments, both m are 1.

In general, in the monomers in the monomers according to Compound (II) and compound (VI), each q can be 0 or 1. In embodiments, at least one q is 0. In embodiments, both q are 0. In embodiments, at least one q is 1. In embodiments, both q are 1.

In general, in the monomers according to Compound (I), Compound (II), Compound (III), Compound (IV), Compound (V), Compound (VI), and Compound (VIII) each p is 0 or 1. In embodiments, at least one p is 0. In embodiments, both p are 0. In embodiments, at least one p is 1. In embodiments, both p are 1.

In general, in the monomers according to Compound (I), Compound (II), Compound (III), Compound (IV), Compound (V), Compound (VI), and Compound (VII), A₁ can be any unit that extends the length between the two polymerizable alkene units and is largely resistant to degradation in a caustic environment. Thus, in embodiments, each A₁ can be individually selected from C, O, and N. It will be understood that each A₁ and the corresponding R₃ groups are selected to form chemically stable compositions, and a selection of (i) an A₁ and a corresponding R₃ that would not form a chemically stable composition or (ii) a selection of two adjacent A₁ that would not form a chemically stable composition are not encompassed by the present disclosure. For example, when A₁ is O or N, a corresponding R₃ would not be OH or O—C₁-C₆alkyl. As another example, two adjacent A₁ are not both O or are not O and N. In general, each A₁(R₃)₂ segment can be neutral or ionic. In embodiments, each A₁(R₃)₂ segment is neutral. In embodiments, at least one A₁(R₃)₂ segment is cationic. In embodiments, at least two A₁(R₃)₂ segments are ionic, with the proviso that two cationic A₁(R₃)₂ segments are not adjacent.

In embodiments, at least one A₁ is C. In embodiments, all A₁ are C. In embodiments, at least one A₁ is O. In embodiments, at least two A₁ in the monomer according to Compound (I), Compound (II), Compound (III), Compound (IV), Compound (V), Compound (VI), and Compound (VII), are O, with the proviso that at least one carbon atom (i.e., A₁=C) is provided between each O. In embodiments, at least one A₁ is N. In embodiments, at least two A₁ are N with the proviso that when two adjacent A₁ are N, then at least one N is a tertiary amine.

In general, in the monomers according to Compound (I), Compound (II), Compound (III), Compound (IV), Compound (V), Compound (VI), Compound (VII), and Compound (VIII), each Y is independently an inorganic anion or an organic anion. Each Y on a given monomer can be the same or different. In embodiments, all Y on a given monomer are the same. In embodiments, at least one Y is an inorganic anion. In embodiments, all Y are inorganic anions. Suitable inorganic anions include, but are not limited to, halogen anions. In embodiments, the inorganic anion is selected from a fluoride, a chloride, a bromide, or an iodide anion. In embodiments, the inorganic anion is a bromide anion or a chloride anion. In embodiments, the inorganic anion is chloride. In embodiments, the inorganic anion is bromide.

In embodiments, at least one Y is an organic anion. In embodiments, all Y are organic anions. Examples of suitable organic anions include carboxylate ions and sulfonate ions. In embodiments, the organic anion comprises an acetate anion or a methanesulfonate anion.

In general, in the monomers according to Compound (I) and Compound (II), R₁ is not particularly limited. In embodiments, R₁ can be any group that largely resistant to degradation in a caustic environment. In embodiments, R₁ can be any group that has relatively low steric bulk. In embodiments, each R₁ can independently be selected from H, OH, C₁-C₆alkyl, O—C₁-C₆alkyl, C₅-C₆cycloalkyl, and substituted or unsubstituted phenyl. In embodiments, each R₁ can be independently selected from H, C₁-C₆alkyl, and substituted or unsubstituted phenyl. In embodiments, in Compound (I) or Compound (II), at least one R₁ is H. In embodiments, both R₁ are H. In embodiments, at least one R₁ is C₁alkyl (methyl). In embodiments, both R₁ are C₁alkyl. In embodiments, at least one R₁ is phenyl. In embodiments, both R₁ are phenyl. In embodiments, at least one R₁ is phenyl substituted with one or more methyl groups. In embodiments, both R₁ are phenyl substituted with one or more methyl groups.

In general, in the monomers according to Compound (I), Compound (II), and Compound (IV) R₂ is not particularly limited. In embodiments, R₂ can be any group that largely resistant to degradation in a caustic environment. In embodiments, R₂ can be any group that has relatively low steric bulk. In embodiments, R₂ can be selected from H, OH, C₁-C₆alkyl, O—C₁-C₆alkyl, C₅-C₆cycloalkyl, and substituted or unsubstituted phenyl. In embodiments, each R₂ can be independently selected from H, C₁-C₆alkyl, and substituted or unsubstituted phenyl. In embodiments, in Compound (I), Compound (II), or Compound (III), at least one R₂ is H. In embodiments, at least two R₂ are H. In embodiments, at least three R₂ are H. In embodiments, all R₂ are H. In embodiments, at least one R₂ is C₁alkyl (methyl). In embodiments, at least two R₂ are C₁alkyl. In embodiments, at least three R₂ are C₁alkyl. In embodiments, all R₂ are C₁alkyl. In embodiments, at least one R₂ is phenyl. In embodiments, at least two R₂ are phenyl. In embodiments, at least three R₂ are phenyl. In embodiments, all R₂ are phenyl. In embodiments, at least one R₂ is phenyl substituted with one or more methyl groups. In embodiments, at least two R₂ are phenyl substituted with one or more methyl groups. In embodiments, at least three R₂ are phenyl substituted with one or more methyl groups. In embodiments, all R₂ are phenyl substituted with one or more methyl groups.

In general, in the monomers according to Compound (I), Compound (II), Compound (III), Compound (IV), Compound (V), Compound (VI), and Compound (VII), R₃ is not particularly limited. In embodiments, R₃ can be any group that largely resistant to degradation in a caustic environment. In embodiments, R₃ can be any group that has relatively low steric bulk. In embodiments, each R₃ can independently be absent, H, OH, C₁-C₆alkyl, O—C₁-C₆alkyl, C₅-C₆cycloalkyl, or substituted or unsubstituted phenyl. In embodiments, each R₃ can independently be absent, H, C₁-C₆alkyl, or substituted or unsubstituted phenyl. In embodiments wherein A₁ is O, both corresponding R₃ are absent. In embodiments wherein A₁ is N, one corresponding R₃ can be absent such that the N is a tertiary amine. In embodiments wherein A₁ is N, both R₃ can be present such that the N is a quaternary amine. Any A₁ present in the form of a quaternary amine also include a suitable counteranion. In embodiments, in the monomers according to Compound (I), Compound (II), Compounds (III), and Compound (IV), at least one R₃ is H. In embodiments, at least two R₃ are H. In embodiments, all R₃ are H. In embodiments, at least one R₃ is OH. In embodiments, at least two R₃ are OH.

In general, in the monomers according to Compound (III), and Compound (VII), R₄ is not particularly limited. In embodiments, R₄ can be any group that largely resistant to degradation in a caustic environment. In embodiments, R₄ can be any group that has relatively low steric bulk. In embodiments, each R₄ can independently be C₁-C₆alkyl, C₅-C₆cycloalkyl, or substituted or unsubstituted phenyl. In embodiments, each R₄ can independently be C₁-C₆alkyl or C₅-C₆cycloalkyl. In embodiments, each R₄ can independently be C₁-C₆alkyl. In embodiments, at least one R₄ is C₁alkyl (methyl). In embodiments, at least two R₄ are C₁alkyl. In embodiments, at least three R₄ are C₁alkyl. In embodiments, all R₄ are C₁alkyl. In embodiments, at least one R₄ is C₂alkyl. In embodiments, at least two R₄ are C₂alkyl. In embodiments, at least three R₄ are C₂alkyl. In embodiments, all R₄ are C₂alkyl. In embodiments of Compound (III), two geminal R₄ together with the N atom to which they are attached form a 5-member heterocycloalkyl. In embodiments of Compound (III), two geminal R₄ together with the N atom to which they are attached form a 6-member heterocycloalkyl.

In general, in the monomers according to Compound (VII), a first polymerizable group is provided at one or more of R₅, R₆, and R₇ and a second polymerizable group is provided at one or more of R₅′, R₆′, and R₇′. Each of R₅, R₆, R₇, R₅′, R₆′, and R₇′ can be selected from the group of H, CH═CH₂, and CH₂CH═CH₂ provided that at least one of R₅, R₆, and R₇ and at least one of R₅′, R₅′, and R₇′ is CH═CH₂, and CH₂CH═CH₂. In embodiments, R₅ and R₅′ are both CH═CH₂. In embodiments, R₅ and R₅′ are both CH₂CH═CH₂. In embodiments, R₆ and R₆′ are both CH═CH₂. In embodiments, R₆ and R₆′ are both CH₂CH═CH₂. In embodiments, R₇ and R₇′ are both CH═CH₂. In embodiments, R₇ and R₇′ are both CH₂CH═CH₂. In embodiments, R₅, R₅′, R₆, R₆′ are all CH═CH₂. In embodiments, R₅, R₅′, R₆, R₆′ are all CH₂CH═CH₂. In embodiments, R₅ and R₅′ are both CH═CH₂ and R₆ and R₆′ are both CH₂CH═CH₂. In embodiments, R₅ and R₅′ are both CH₂CH═CH₂ and R₆ and R₆′ are both CH═CH₂. In embodiments, R₅, R₅′, R₇, R₇′ are all CH═CH₂. In embodiments, R₅, R₅′, R₇, R₇′ are all CH₂CH═CH₂. In embodiments, R₅ and R₅′ are both CH═CH₂ and R₇ and R₇′ are both CH₂CH═CH₂. In embodiments, R₅ and R₅′ are both CH₂CH═CH₂ and R₇ and R₇′ are both CH═CH₂. In embodiments, R₇, R₇′, R₆, R₆′ are all CH═CH₂. In embodiments, R₇, R₇′, R₆, R₆′ are all CH₂CH═CH₂. In embodiments, R₇ and R₇′ are both CH═CH₂ and R₆ and R₆′ are both CH₂CH═CH₂. In embodiments, R₇ and R₇′ are both CH₂CH═CH₂ and R₆ and R₆′ are both CH═CH₂.

In general, in the monomers according to Compound (V), Compound (VII), and Compound (VIII), R₈ is not particularly limiting. In embodiments, R₈ can be any group that largely resistant to degradation in a caustic environment. In embodiments, R₈ can be any group that has relatively low steric bulk. In embodiments, each R₈ can independently be CH═CH₂, CH₂CH═CH₂, C₁-C₆alkyl, C₅-C₆cycloalkyl, or substituted or unsubstituted phenyl. In embodiments, each R₈ can independently be CH═CH₂ or CH₂CH═CH₂. In embodiments, each R₈ can independently be C₁-C₆alkyl or C₅-C₆cycloalkyl. In embodiments, each R₈ can independently be C₁-C₆alkyl. In embodiments, at least one R₈ is C₁alkyl (methyl). In embodiments, both R₈ are C₁alkyl. In embodiments, at least one R₈ is C₂alkyl. In embodiments, both R₈ are C₂alkyl.

In embodiments, the monomers according to Compound (I), Compound (II), Compound (III), Compound (IV), Compound (V), Compound (VI), Compound (VII), and Compound (VIII) are symmetrical. For example, for Compounds (I)-(VII), the compounds can be characterized by a structure R*-[A₁(R₃)₂]ₙ—R*, where A₁, R₃, and n are as defined herein and the R* represents the remainder of the monomer and the R* groups are the same.

In general, the ion-exchange polymer can be a homopolymer or a copolymer. In embodiments, the ion-exchange polymer can be a homopolymer of a plurality of cross-linkable monomers according to Compound (I), Compound (II), Compound (III), Compound (IV), Compound (V), Compound (VI), Compound (VII), or Compound (VIII). In embodiments, the ion-exchange polymer can be a copolymer. In embodiments, the copolymer can include a plurality of monomers including two or more monomers according to Compound (I). In embodiments, the copolymer can include a plurality of monomers including two or more monomers according to Compound (II). In embodiments, the copolymer can include a plurality of monomers including two or more monomers according to Compound (III). In embodiments, the copolymer can include a plurality of monomers including two or more monomers according to Compound (IV). In embodiments, the copolymer can include a plurality of monomers including two or more monomers according to Compound (V). In embodiments, the copolymer can include a plurality of monomers including two or more monomers according to Compound (VI). In embodiments, the copolymer can include a plurality of monomers including two or more monomers according to Compound (VII). In embodiments, the copolymer can include a plurality of monomers including two or more monomers according to compound (VIII). In embodiments, the copolymer can include a plurality of monomers including at least a first monomer having a formula according to Compound (I), Compound (II), Compound (III), Compound (IV), Compound (V), Compound (VI), Compound (VII), or Compound (VIII) and a second monomer selected from a different monomer having a formula according to Compound (I), Compound (II), Compound (III), Compound (IV), Compound (V), Compound (VI), Compound (VII), or Compound (VIII). For example, a copolymer of the disclosure can include at least a monomer according to Compound (I) and at least a monomer according to Compound (II), at least a monomer according to Compound (I) and at least a monomer according to Compound (III), at least a monomer according to Compound (I) and at least a monomer according to Compound (IV), at least a monomer according to Compound (I) and at least a monomer according to Compound (V), at least a monomer according to Compound (I) and at least a monomer according to Compound (VI), at least a monomer according to Compound (I) and at least a monomer according to Compound (VII), at least a monomer according to Compound (I) and at least a monomer according to Compound (VIII), at least a monomer according to Compound (II) and at least a monomer according to Compound (III), at least a monomer according to Compound (II) and at least a monomer according to Compound (IV), at least a monomer according to Compound (II) and at least a monomer according to Compound (V), at least a monomer according to Compound (II) and at least a monomer according to Compound (VI), at least a monomer according to Compound (II) and at least a monomer according to Compound (VII), at least a monomer according to Compound (II) and at least a monomer according to Compound (VIII), at least a monomer according to Compound (III) and at least a monomer according to Compound (IV), at least a monomer according to Compound (III) and at least a monomer according to Compound (V), at least a monomer according to Compound (III) and at least a monomer according to Compound (VI), at least a monomer according to Compound (III) and at least a monomer according to Compound (VII), at least a monomer according to Compound (III) and at least a monomer according to Compound (VIII), at least a monomer according to Compound (IV) and at least a monomer according to Compound (V), at least a monomer according to Compound (IV) and at least a monomer according to Compound (VI), at least a monomer according to Compound (IV) and at least a monomer according to Compound (VII), at least a monomer according to Compound (IV) and at least a monomer according to Compound (VIII), at least a monomer according to Compound (V) and at least a monomer according to Compound (VI), at least a monomer according to Compound (V) and at least a monomer according to Compound (VII), at least a monomer according to Compound (V) and at least a monomer according to Compound (VIII), at least a monomer according to Compound (VI) and at least a monomer according to Compound (VII), at least a monomer according to Compound (VI) and at least a monomer according to compound (VIII), or at least a monomer according to Compound (VII) and at least a monomer according to Compound (VIII). In the homopolymer and copolymers of the disclosure the nature of the anions, Y, that are present as mobile, counteranions to the cationic units should not be considered strictly part of the homopolymer or copolymer of the disclosure. Thus, for example, it will be understood that a polymer is considered a homopolymer of the disclosure when prepared from a plurality of monomers consisting of a single monomer type according to Compound (I), even if the counteranions Y include more than one species (e.g., a blend of chloride anions and bromide anions).

The ion-exchange polymer of the disclosure can also be a copolymer including one or more bifunctional cross-linkable monomers and one or more monofunctional monomers including one vinyl polymerizable group or one allyl polymerizable group and at least one ionic functional group. When referring to the monomers of the disclosure, the term “monofunctional” refers to the presence of a single polymerizable group. The monofunctional monomers can have a structure according to Compound (IX), Compound (X), Compound (XI), Compound (XII), Compound (XIII), Compound (XIV), Compound (XV), or Compound (XVI):

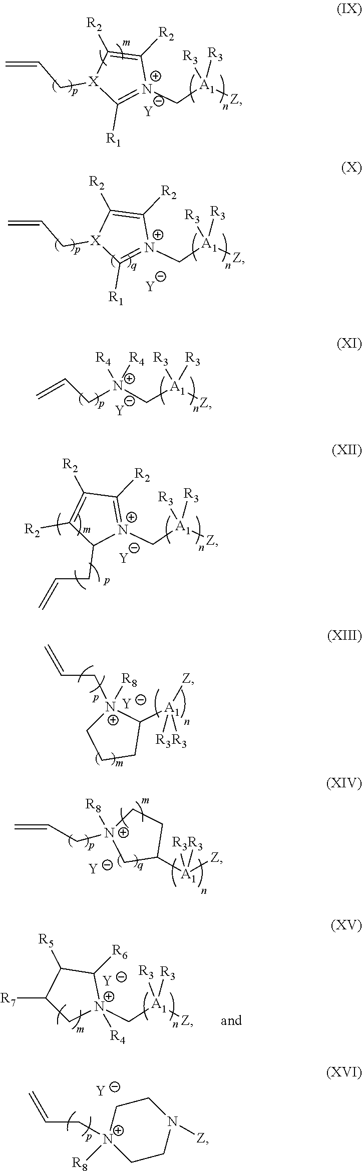

wherein each of X, A₁, R₁, R₂, R₃, R₄, R₅, R₆, R₇, R₈, n, m, q, p, and Y are defined as defined herein for the cross-linkable monomers according to Compounds (I)-(VII) and each Z can independently be selected from H, OH, NH₂, C(O)OH, C₁-C₆alkyl, C₁-C₆alkyl-OH, C₁-C₆alkyl-C(O)OH, CH═CH₂, and CH₂CH═CH₂. In embodiments, Z can be OH. In embodiments, Z can be NH₂. In embodiments, Z can be C(O)OH. In embodiments, Z can be C₁-C₆alkyl. In embodiments, Z can be tert-butyl. In embodiments, Z can be CH═CH₂. In embodiments, Z can be CH₂CH═CH₂.

The monofunctional monomers according to Compounds (IX)-(XVI) can be polymerized with the bifunctional cross-linkable monomers according to Compounds (I)-(VIII) to provide an ion-exchange polymer of the disclosure. In general, the bifunctional monomers and the monofunctional monomers can be used in any suitable ratio to provide an ion-exchange polymer having a desired charge density, throughput, and/or ion selectivity, as disclosed herein. The bifunctional monomers and monofunctional monomers can be provided in a weight ratio of about 99:1 (bifunctional to monofunctional) to about 1:99 (bifunctional to monofunctional), for example about 95:5 to 5:95, about 90:10 to about 10:90, about 80:20 to about 20:80, about 75:25 to about 25:75, about 70:30 to about 30:70, about 60:40 to about 40:60, or about 50:50. In general, as the mass fraction of bifunctional monomer decreases and the mass fraction of monofunctional monomer increases, the water volume fraction of the resulting polymer/membrane generally increases, the charge density of the resulting polymer/membrane generally decreases, the throughput of the resulting polymer/membrane generally increases, and the selectivity of the resulting polymer/membrane generally decreases. For embodiments wherein Z is an alkyl group, as the weight fraction of monofunctional monomer decreases below about 50%, the effect of the amount of monofunctional monomer on the properties of the resulting ion-exchange polymer/membrane decreases. Without intending to be bound by theory, it is believed that at monofunctional monomer weight fractions in a range of about 1% to about 50%, monofunctonal monomers wherein Z includes a hydroxide, an amine, or a carboxylate will have a greater effect on the properties of the resulting ion-exchange polymer/membrane than monofunctional monomers wherein Z is alkyl,

In embodiments, the bifunctional monomers and monofunctional monomers can be provided in a weight ratio of about 99:1 to about 1:99, about 95:5 to about 5:95, about 90:10 to about 10:90, about 80:20 to about 20:80, about 75:25 to about 25:75, about 70:30 to about 30:70, about 60:40 to about 40:60, or about 50:50.

In embodiments wherein the ion-exchange polymer is a copolymer comprising a bifunctional monomer and a monofunctional monomer, the combination of bifunctional monomer and monofunctional monomer is not particularly limiting. In some embodiments, the monofunctional monomer is structurally similar to the bifunctional monomer, e.g., a mixture of a Compound (I) and a Compound (IX). In some embodiments, the monofunctional monomer is structurally different than the bifunctional monomer, e.g., a mixture of a Compound (I) and a Compound (XV). The table below provides contemplated combinations and is not intended to be limiting. In the table, a box with a “Y” indicates the combination of monomers is contemplated and a bold “Y” indicates that the monomers are considered to have structural similarity.

| | (I) | (II) | (III) | (IV) | (V) | (VI) | (VII) | (VIII) |
|---|---|---|---|---|---|---|---|---|
| (IX) | Y | Y | Y | Y | Y | Y | Y | Y |
| (X) | Y | Y | Y | Y | Y | Y | Y | Y |
| (XI) | Y | Y | Y | Y | Y | Y | Y | Y |
| (XII) | Y | Y | Y | Y | Y | Y | Y | Y |
| (XIII) | Y | Y | Y | Y | Y | Y | Y | Y |
| (XIV) | Y | Y | Y | Y | Y | Y | Y | Y |
| (XV) | Y | Y | Y | Y | Y | Y | Y | Y |
| (XVI) | Y | Y | Y | Y | Y | Y | Y | Y |

In embodiments, the ion-exchange homopolymer or copolymer can also include minor amounts of imperfect monomers according to Compounds (I)-(VIII). As used herein, an “imperfect monomer” according to Compounds (I)-(VII) refers to a monomer having a single polymerizable group, generally present due to incomplete separation from the cross-linkable monomer after preparation of the cross-linkable monomer as disclosed herein, and having a structure according to Compounds (Ia)-(VIIIa):

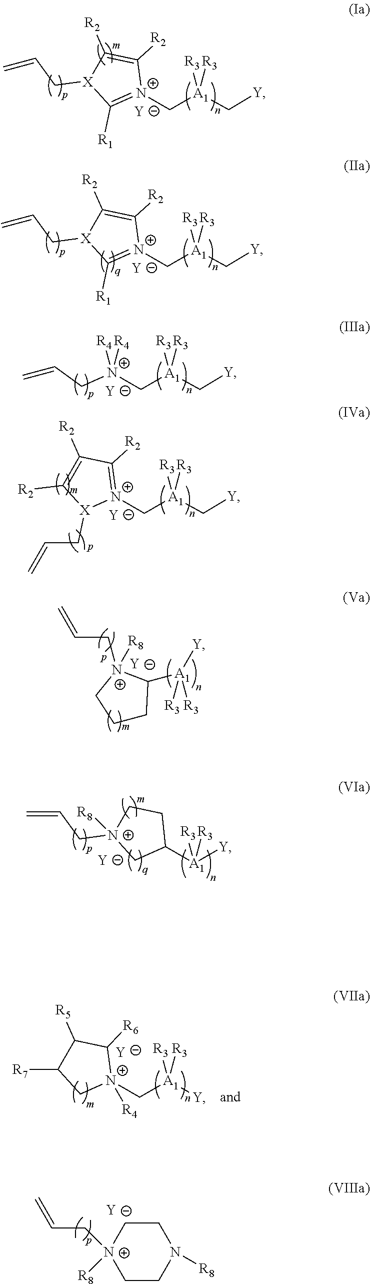

wherein each of X, A₁, R₁, R₂, R₃, R₄, R₅, R₅, R₇, R₈, n, m, q, p, and Y are defined as defined herein for the cross-linkable monomers according to Compounds (I)-(VIII). In the homopolymers and copolymers of the disclosure, the molar ratio of cross-linkable monomers and monofunctional monomers (i.e., total of bifunctional and monofunctional monomers) to imperfect monomers can be in a range of 75:25 to 100:0. In embodiments, the molar ratio of cross-linkable monomers and monofunctional monomers to imperfect monomers can be about 75:25, about 80:20, about 85:15, about 90:10, about 93:7, about 95:5, about 97:3, about 98:2, about 99:1, about 99.5:0.5, about 99.9:0.1, or about 100:0. Without intending to be bound by theory, it is believed that as the amount of imperfect monomer increases, the mechanical strength of the resulting polymer/membrane decreases. Thus, in embodiments, the molar ratio of cross-linkable monomers and monofunctional monomers to imperfect monomers can be about 90:10, or about 93:7, or about 95:5, or about 97:3, or about 98:2, or about 99:1, or about 99.9:0.1, or about 100:0. In embodiments, the molar ratio of cross-linkable monomers and monofunctional monomers to imperfect monomers can be about 97:3 to about 100:0. In embodiments, the ion-exchange polymer of the disclosure can be free of imperfect monomers.

In some embodiments, the ion-exchange homopolymers and copolymers of the disclosure can consist of monomers according to Compounds (I)-(XV) and imperfect monomers according to compounds (Ia)-(VIIIa). As used herein, the term “homopolymer” encompasses ion-exchange polymers prepared from exclusively one cross-linkable monomer having a structure according to Compound (I), Compound (II), Compound (III), Compound (IV), Compound (V), Compound (VI), Compound (VII), or Compound (VIII) (i.e., a true homopolymer) as well as ion-exchange polymers prepared from exclusively one cross-linkable monomer having a structure according to Compound (I), Compound (II), Compound (III), Compound (IV), Compound (V), Compound (VI), Compound (VII), or Compound (VIII) and minor amounts of the corresponding imperfect monomer having a structure according to Compound (Ia), Compound (IIa), Compound (IIIa), Compound (IVa), Compound (Va), Compound (VIa), Compound (VIIa), or Compound (VIIIa). In embodiments, homopolymers of the disclosure include about 3 mol % or less, about 2 mol % or less, about 1 mol % or less, about 0.5 mol % or less, about 0.3 mol % or less, or about 0.1 mol % or less of the imperfect monomer.

Examples of monomers having a structure according to Compounds (I)-(VIII) include, but are not limited to:

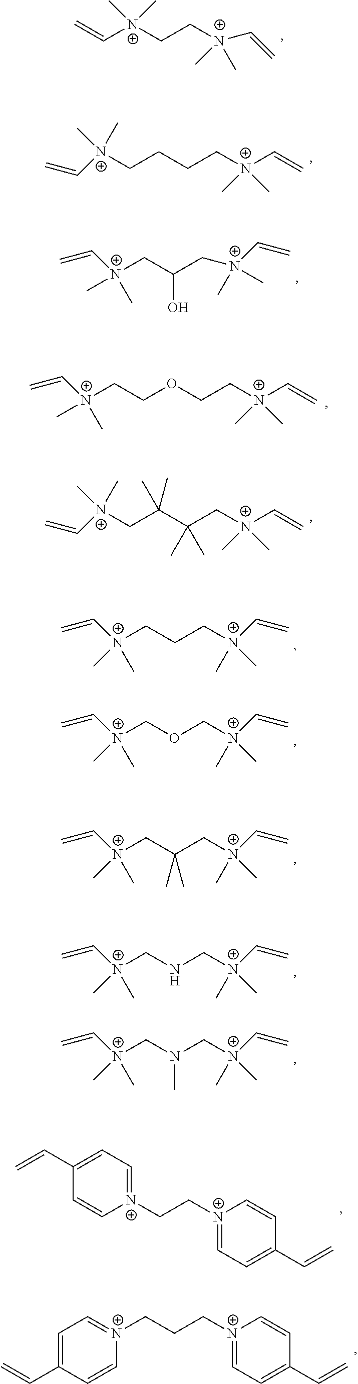

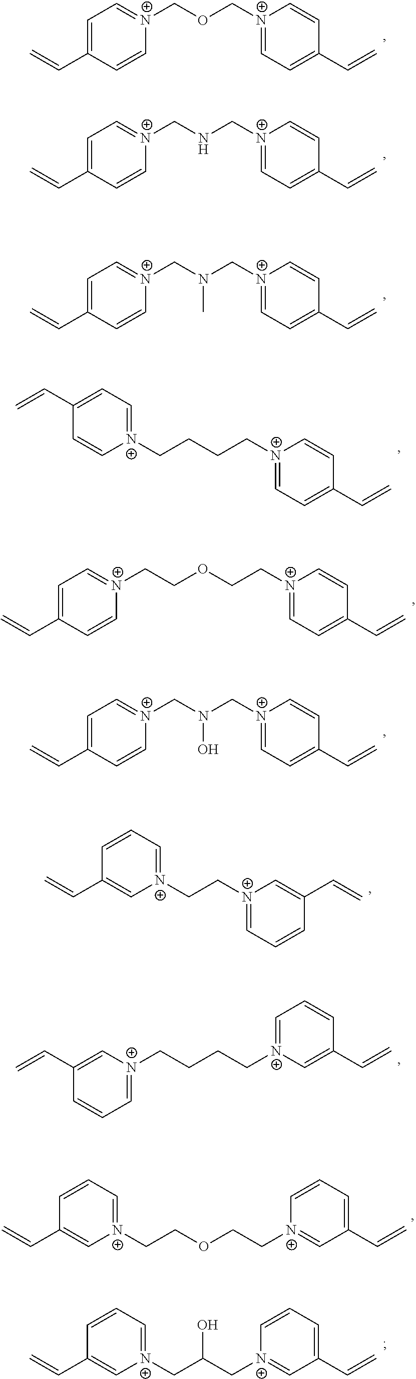

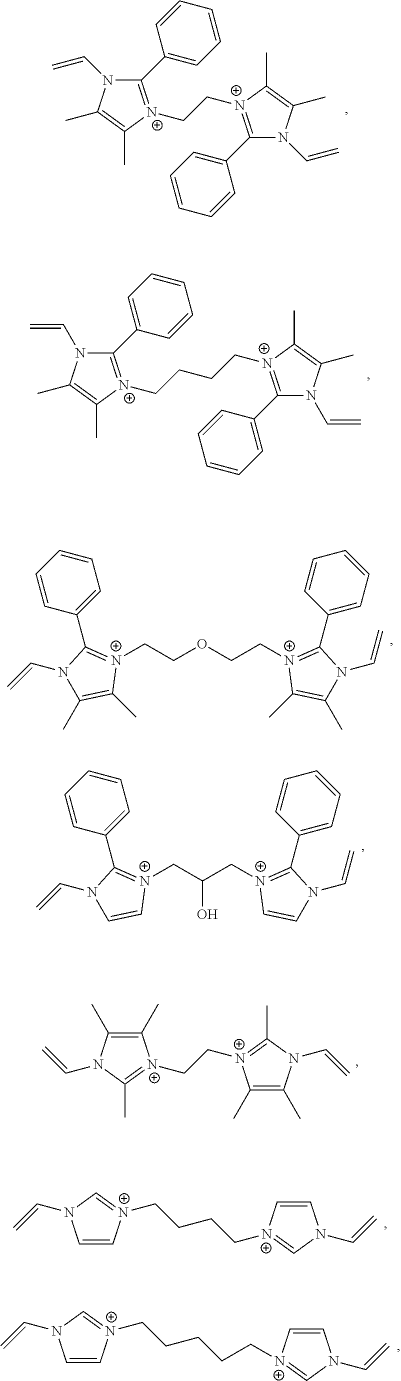

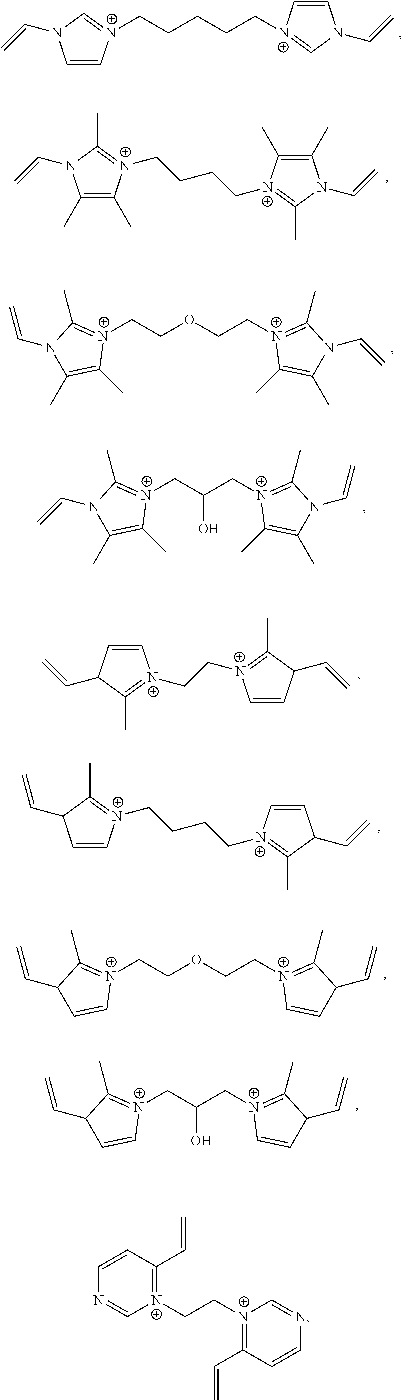

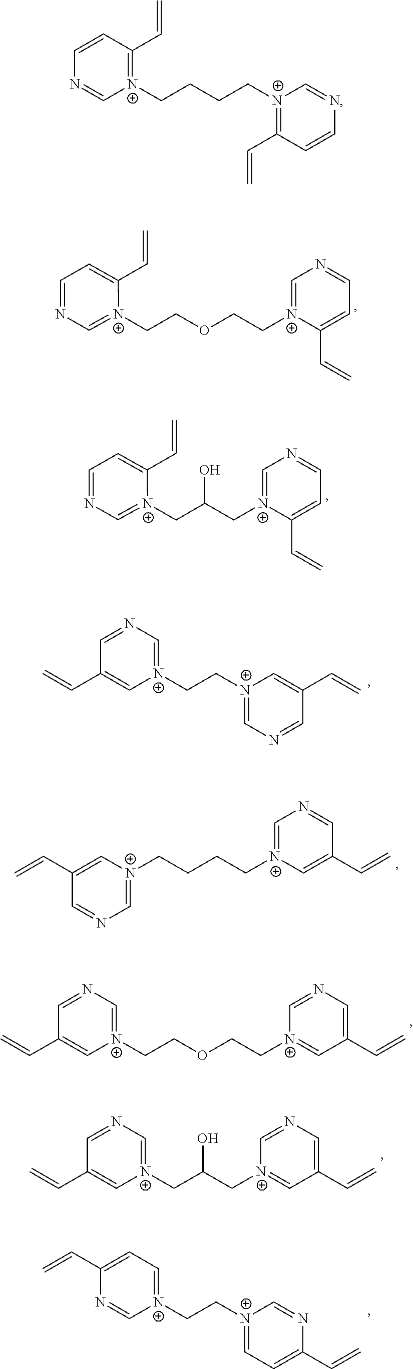

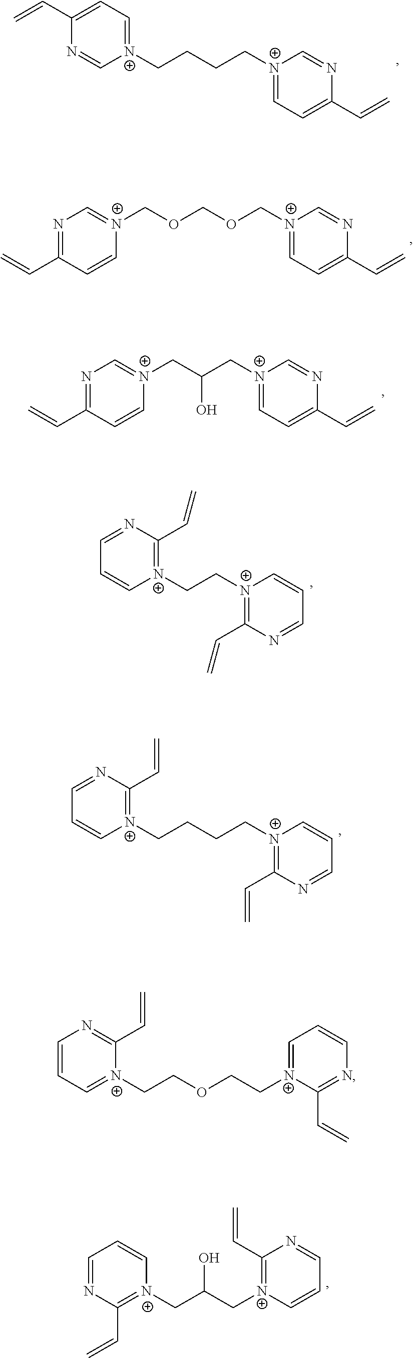

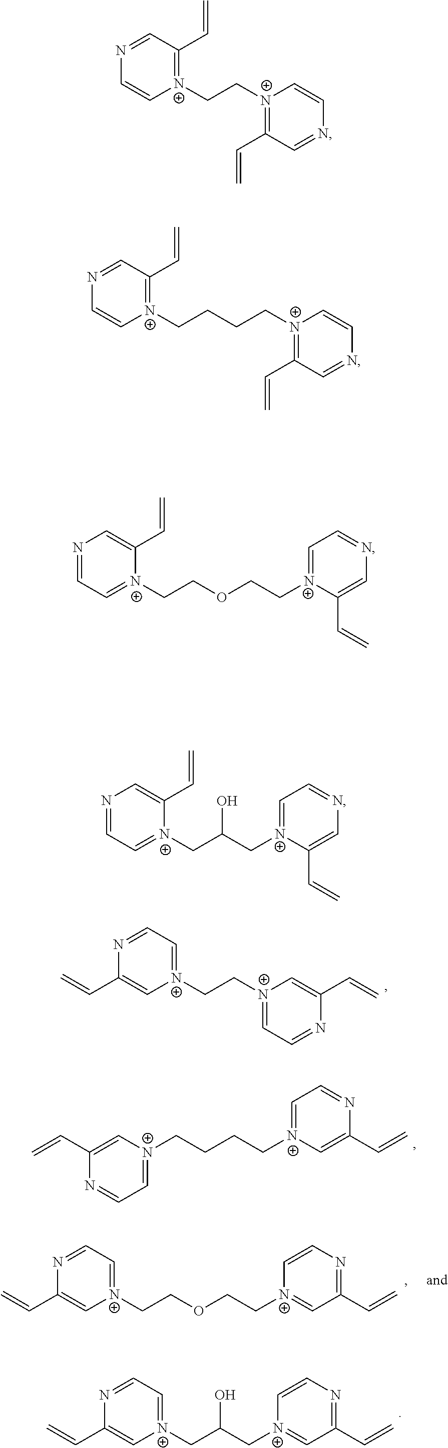

It will be understood that the foregoing monomers include suitable counteranions such that the monomers have electroneutrality.

Examples of monomers having a structure according to Compounds (I)-(VIII) include, but are not limited to:

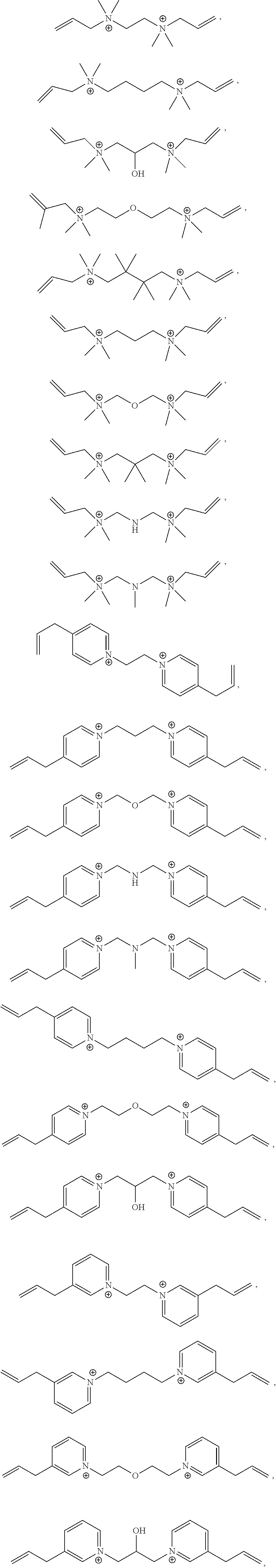

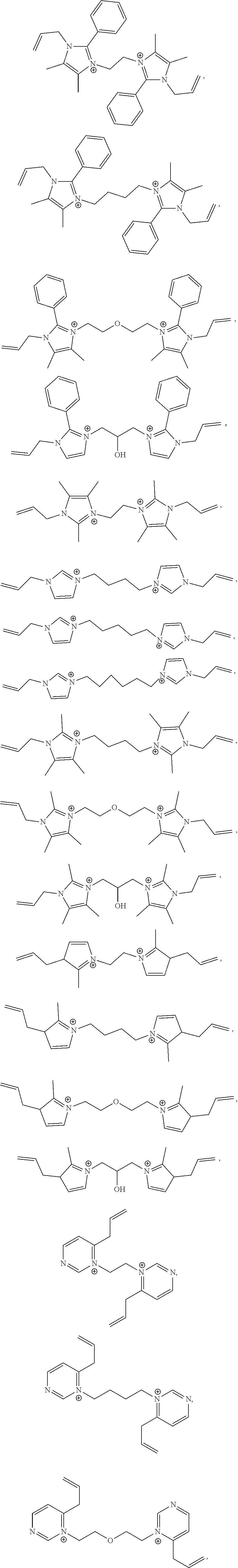

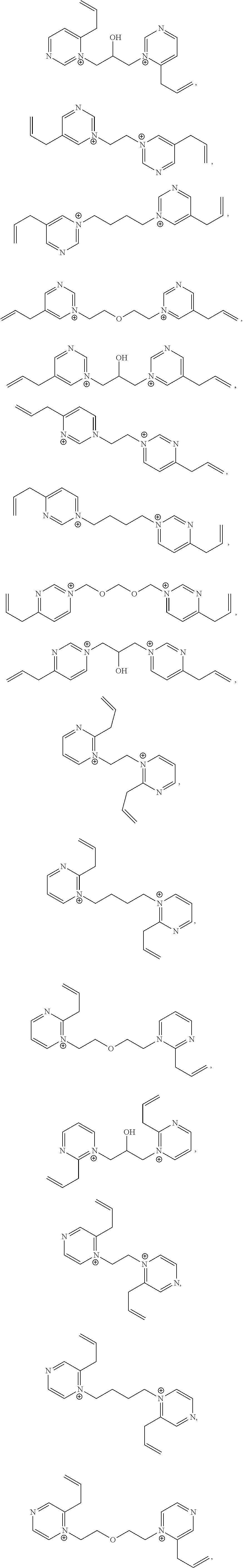

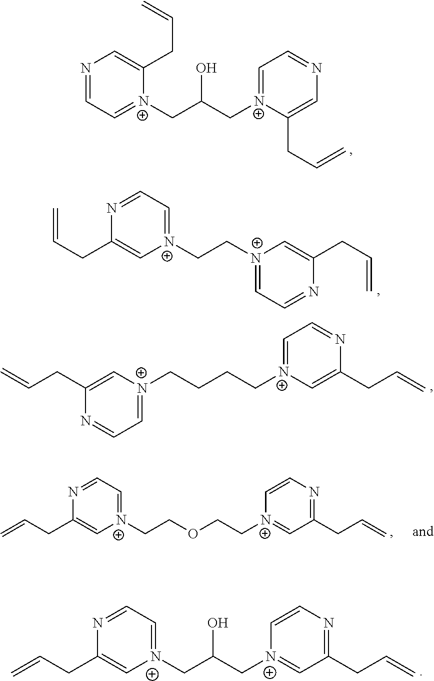

It will be understood that the foregoing monomers include suitable counteranions such that the monomers have electroneutrality.

Examples of monomers having a structure according to Compounds (I)-(VIII) include, but are not limited to:

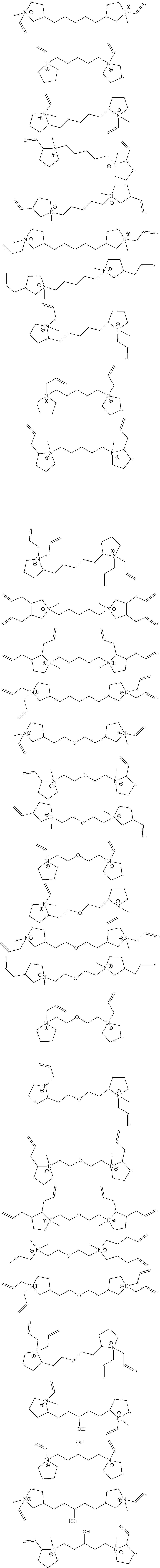

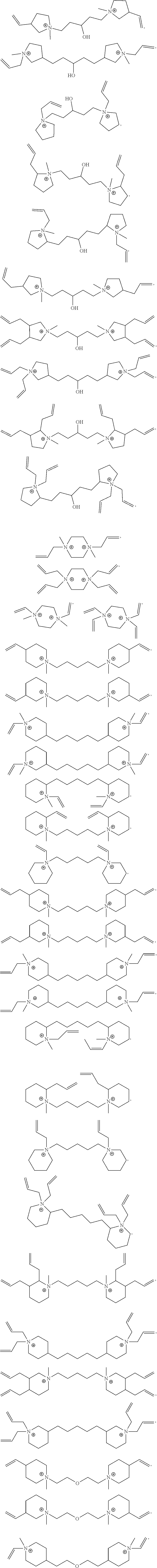

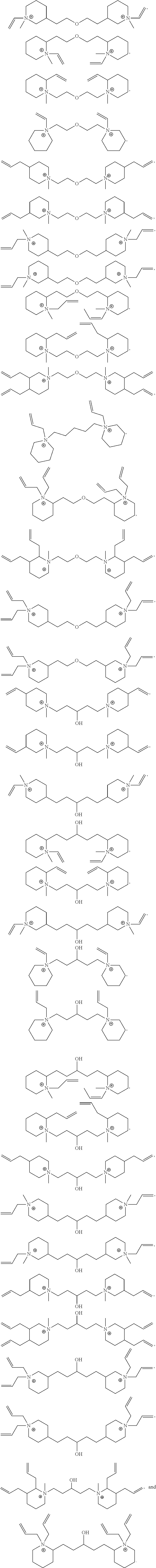

It will be understood that the foregoing monomers include suitable counteranions such that the monomers have electroneutrality.

Examples of monomers having a structure according to Compounds (IX)-(XV) include, but are not limited to:

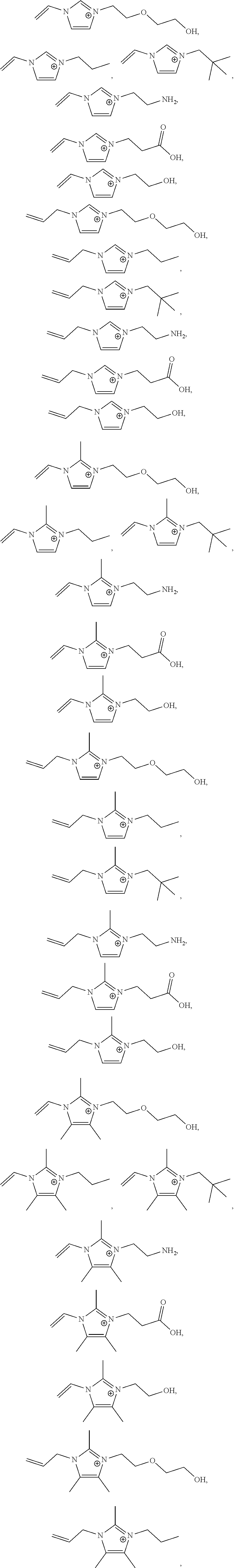

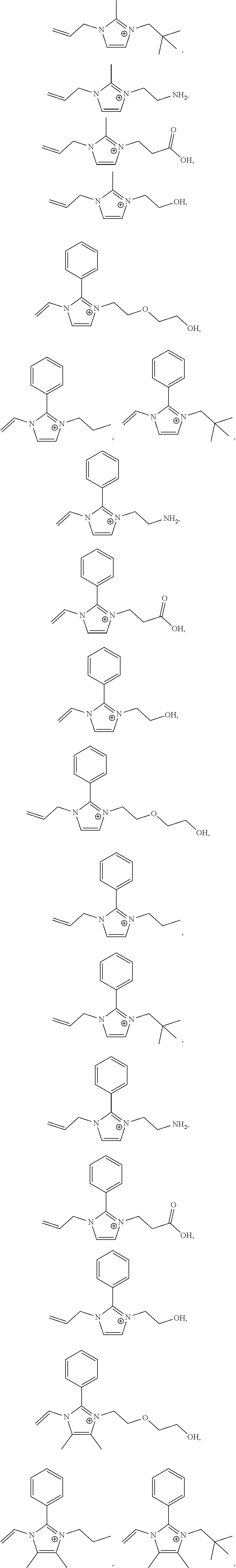

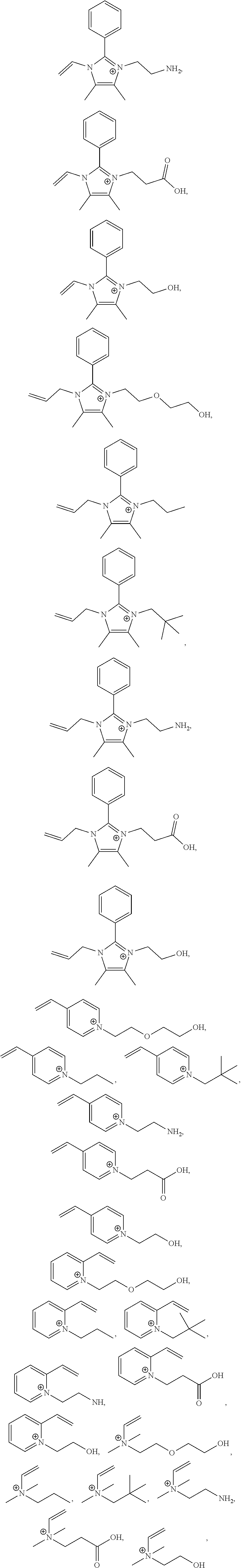

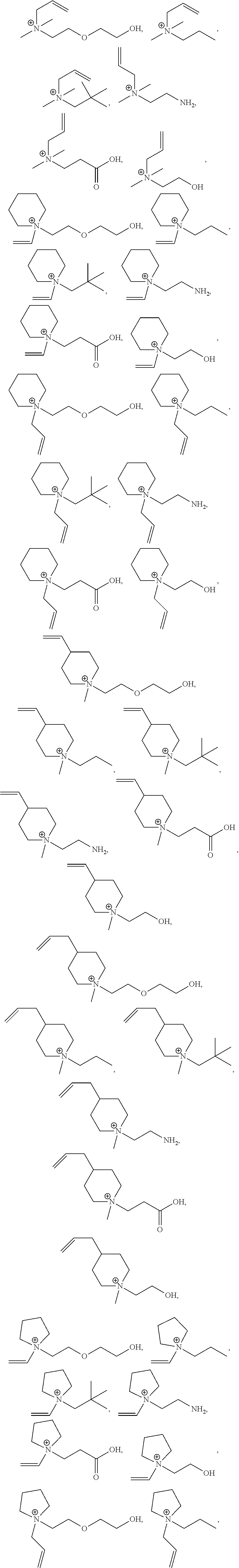

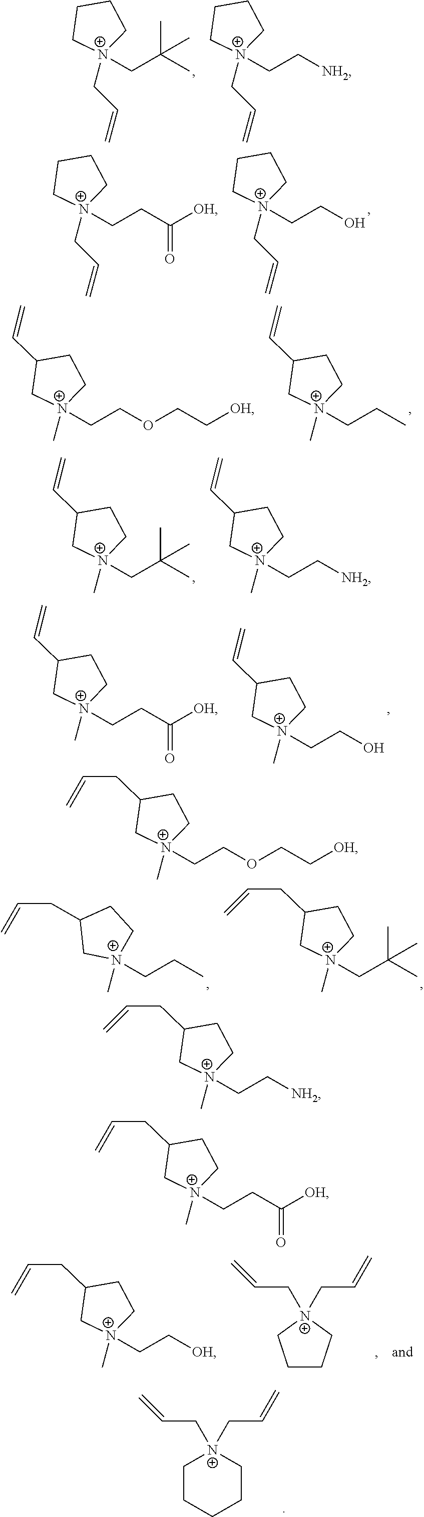

It will be understood that the foregoing monomers include suitable counteranions such that the monomers have electroneutrality.

Also provided herein are ion-exchange polymers having a structure represented by Formulas (I), (II), (III), (IV), (V), (VI), (VII), (VIII), (IX), or (X):

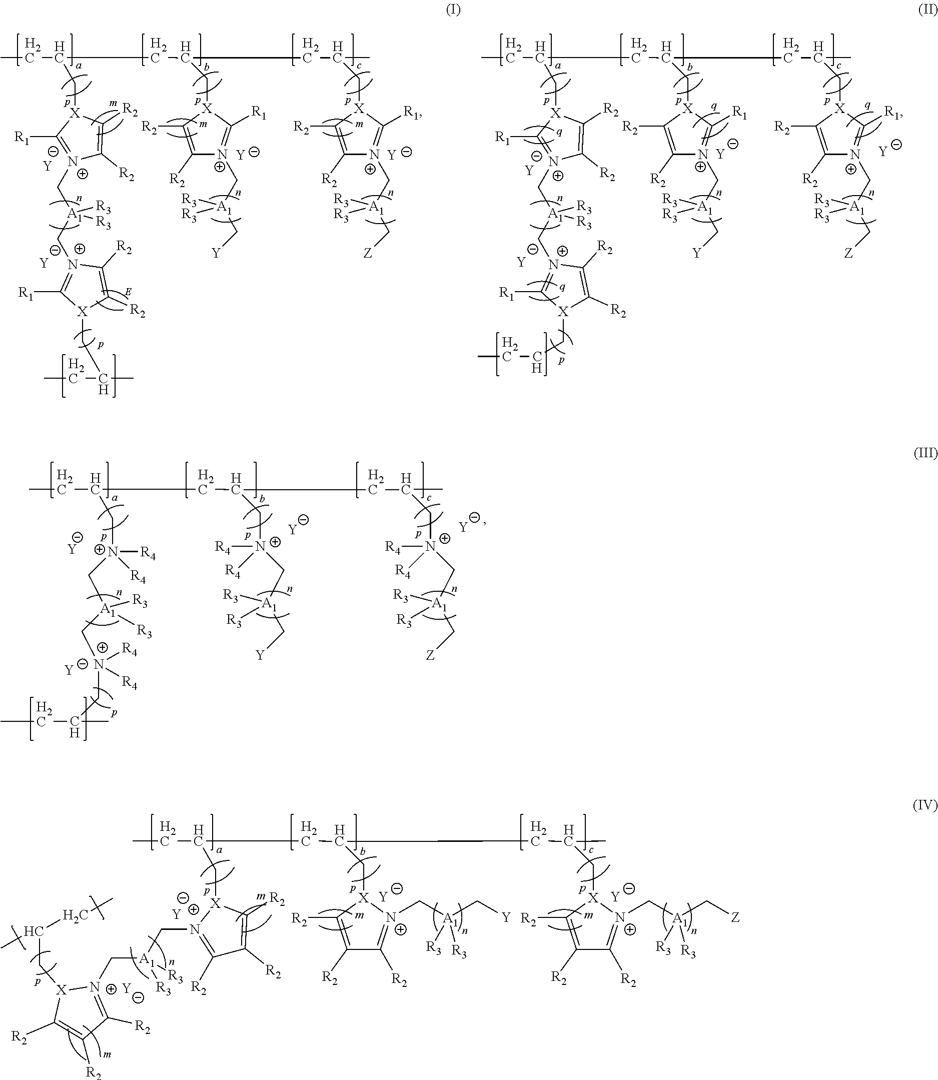

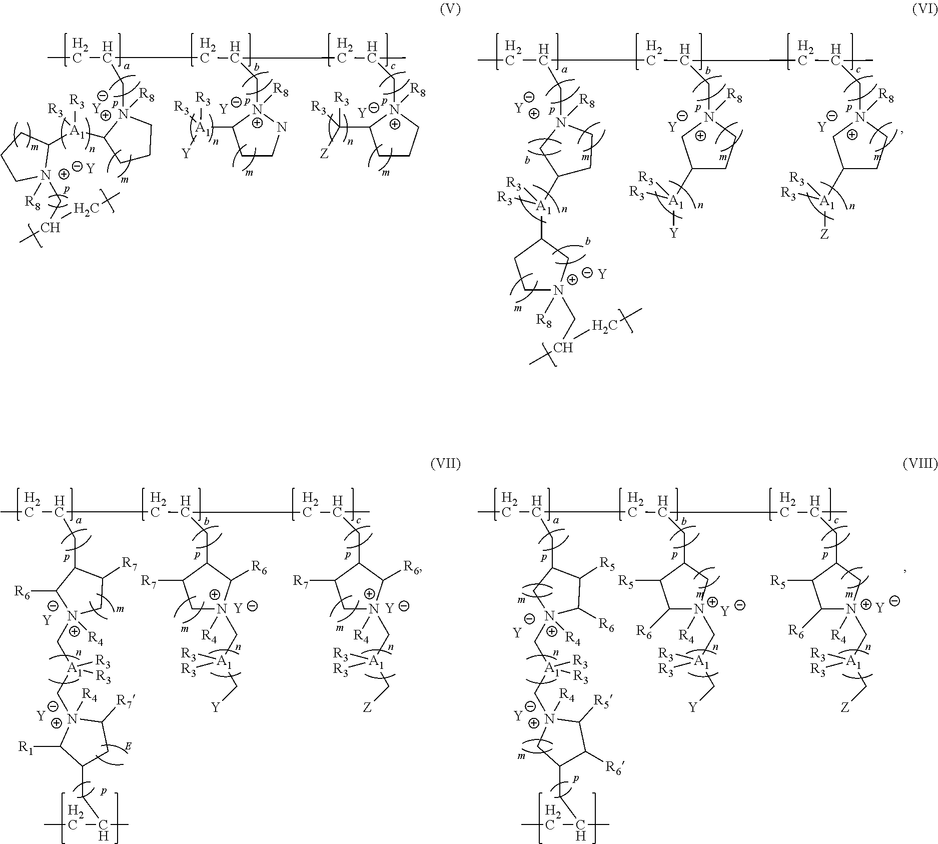

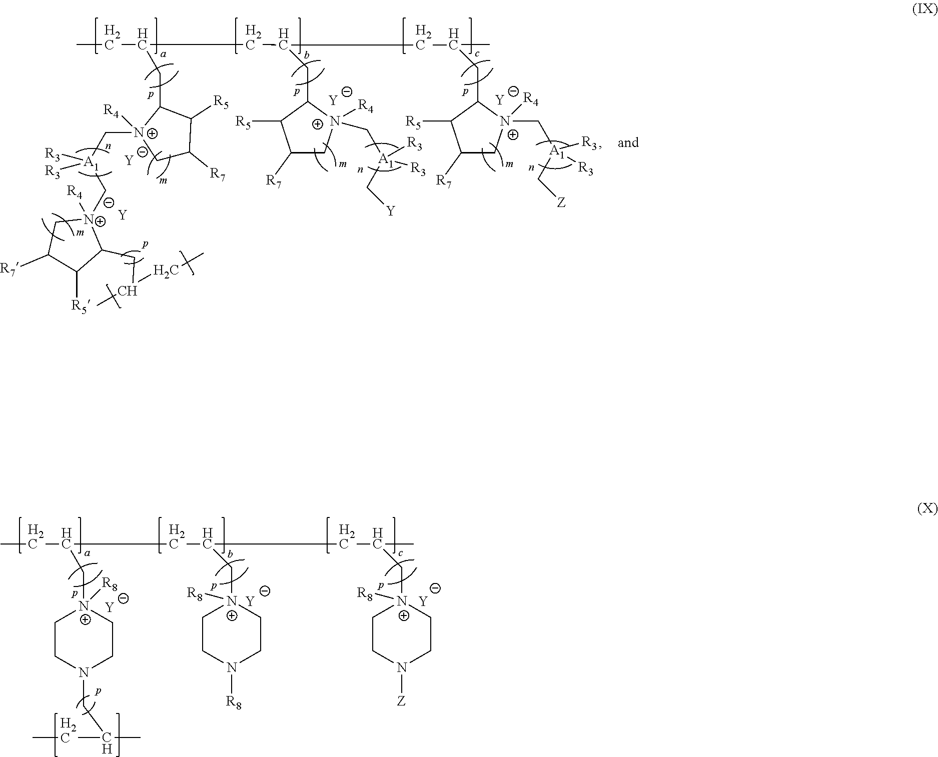

wherein
each x is independently selected from C(H) and N;
each A₁ is independently selected from C, N, and O, wherein when two adjacent A₁ are N, then one R₃ on at least one N is absent;
each n is independently 0, 1, 2, 3, 4, 5, 6, 7, 8, 9, or 10;
each m is independently 1 or 2;
each q is independently 1 or 2;
each p is independently 0 or 1;
each Y is independently an inorganic anion or an organic anion;
each Z can independently be selected from H, OH, NH₂, C(O)OH, C₁-C₆alkyl, C₁-C₆alkyl-OH, C₁-C₆alkyl-C(O)OH, CH═CH₂, and CH₂CH═CH₂;
each R₁ is independently selected from H, OH, C₁-C₆alkyl, O—C₁-C₆alkyl, C₅-C₆cycloalkyl, and substituted or unsubstituted phenyl;
each R₂ is independently selected from H, OH, C₁-C₆alkyl, O—C₁-C₆alkyl, C₅-C₆cycloalkyl, and substituted or unsubstituted phenyl;
each R₃ is independently absent, H, OH, C₁-C₆alkyl, O—C₁-C₆alkyl, C₅-C₆cycloalkyl, or substituted or unsubstituted phenyl;
each R₄ is independently selected from C₁-C₆alkyl, C₅-C₆cycloalkyl, and substituted or unsubstituted phenyl, or two geminal R₄ together with the N atom to which they are attached form a 5- to 8-member heterocycloalkyl;
each of R₅, R₅′, R₆, R₆′, R₇, and R₈ are independently selected from CH═CH₂, CH₂CH═CH₂ and H;
each Rₑ is independently selected from CH═CH₂, CH₂CH═CH₂, C₁-C₆alkyl, C₅-C₆cycloalkyl, and substituted or unsubstituted phenyl;
and wherein 0.75≤a+c≤1, 0<a≤0.75, 0≤b≤0.25, 0≤c<0.75, and a+b+c=1.

The polymers of the disclosure generally can be encompassed by Formula (I), (II), (III), (IV), (V), (VI), (VII), (VIII), (IX), or (X) described herein. In the case wherein a structure shows a central atom having an R group, such as an R₃ group, bound to the central atom, the R group is considered to be “on” the central atom. Thus, in cases wherein “one R₃ on at least one N is absent” the actual compound does not include at least one R₃ group that is depicted in the drawn structure of the corresponding general formula.

In general, in the ion-exchange polymers having a structure according to Formula (I), Formula (II), Formula (III), Formula (IV), Formula (V), Formula (VI), Formula (VII), Formula (VIII), Formula (IX), or Formula (X) the ion-exchange polymer can include two or three structural units, depicted in Formulas (I)-(X) as unit a, unit b, and unit c. Unit a and/or unit b form the bulk of the cross-linked ion-exchange polymer. In embodiments, the ion-exchange polymer consists of unit a. In embodiments, the ion-exchange polymer consists of unit a and unit b. In embodiments, the ratio of unit a and unit b present in the ion-exchange polymer is in the range of 0.75≤a≤1 and 0≤b≤0.25, where a+b=1. In embodiments, the ratio of unit a present in the ion-exchange polymer is in the range of 0.80≤a≤1. In embodiments, the ratio of unit a present in the ion-exchange polymer is in the range of 0.85 Sas 1. In embodiments, the ratio of unit a present in the ion-exchange polymer is in the range of 0.90≤a≤1. In embodiments, the ratio of unit a present in the ion-exchange polymer is in the range of 0.95≤a≤1. In embodiments, the ratio of unit a present in the ion-exchange polymer is in the range of 0.97 s a≤1. In embodiments, the ratio of unit a present in the ion-exchange polymer is in the range of 0.98≤a≤1. In embodiments, the ratio of unit a present in the ion-exchange polymer is in the range of 0.80≤a≤0.999. In embodiments, the ratio of unit a present in the ion-exchange polymer is in the range of 0.85≤a≤0.999. In embodiments, the ratio of unit a present in the ion-exchange polymer is in the range of 0.90≤a≤0.999. In embodiments, the ratio of unit a present in the ion-exchange polymer is in the range of 0.95≤a≤0.999. In embodiments, the ratio of unit a present in the ion-exchange polymer is in the range of 0.97≤a≤0.999. In embodiments, the ratio of unit a present in the ion-exchange polymer is in the range of 0.98≤a≤0.999.

In embodiments, the ion-exchange polymer consists of unit a and unit c. In embodiments, unit a and unit c can be present in the ion-exchange polymer in a ratio in a range of about 99:1 to about 1:99, about 95:5 to about 5:95, about 90:10 to about 10:90, about 80:20 to about 20:80, about 75:25 to about 25:75, about 70:30 to about 30:70, about 60:40 to about 40:60, or about 50:50. In embodiments, the ion-exchange polymer consists of unit a, unit b, and unit c. In embodiments, the ratio of unit a, unit b, or unit c present in the ion-exchange polymer is in the range of 0.75≤a+c≤1, 0<a≤0.75, 0≤b≤0.25, 0≤c<0.75, and a+b+c=1. In embodiments, the ratio of unit a and unit c present in the ion-exchange polymer is in the range of 0.80≤a+c≤1. In embodiments, the ratio of unit a and unit c present in the ion-exchange polymer is in the range of 0.85≤a+c≤1. In embodiments, the ratio of unit a and unit c present in the ion-exchange polymer is in the range of 0.90≤a+c≤1. In embodiments, the ratio of unit a and unit c present in the ion-exchange polymer is in the range of 0.95≤a+c≤1. In embodiments, the ratio of unit a and unit c present in the ion-exchange polymer is in the range of 0.97≤a+c≤1. In embodiments, the ratio of unit a and unit c present in the ion-exchange polymer is in the range of 0.98≤a+c≤1. In embodiments, the ratio of unit a and unit c present in the ion-exchange polymer is in the range of 0.80≤a+c≤0.999. In embodiments, the ratio of unit a and unit c present in the ion-exchange polymer is in the range of 0.85≤a+c≤0.999. In embodiments, the ratio of unit a and unit c present in the ion-exchange polymer is in the range of 0.90≤a+c≤0.999. In embodiments, the ratio of unit a and unit c present in the ion-exchange polymer is in the range of 0.95≤a+c≤0.999. In embodiments, the ratio of unit a and unit c present in the ion-exchange polymer is in the range of 0.97≤a+c≤0.999. In embodiments, the ratio of unit a and unit c present in the ion-exchange polymer is in the range of 0.98≤a+c≤0.999.

In general, in the ion-exchange polymers having a structure according to Formula (I), Formula (II), and Formula (IV), X can be present on unit a, unit b, unit b, or a combination thereof. In embodiments, each X is independently selected from C(H) and N. In embodiments, at least one X of unit a is N. In embodiments, the X of unit b is N. In embodiments, both X of unit a are N. In embodiments, the X of unit c is N.

In general, in the ion-exchange polymers having a structure according to Formula (I), Formula (II), Formula (III), Formula (IV), Formula (V), Formula (VI), Formula (VII), Formula (VIII), and Formula (IX), n is an integer in a range of 0-10, 0-9, 0-8, 0-7, 0-6, 0-5, 0-4, 0-3, 0-2, 0-1, 1-10, 1-9, 1-8, 1-7, 1-6, 1-5, 1-4, 1-3, or 1-2. In embodiments, n can be 0, 1, 2, 3, 4, 5, 6, 7, 8, or 9. In embodiments, n can be 0, 1, 2, 3, 4, 5, 6, or 7. In embodiments, n is 0, 1, 2, or 3. In embodiments, n is 0, 1, or 2. In embodiments, n is 0 or 1. In embodiments, the n of unit a is the same as the n of unit b and the n of unit c. In embodiments, the n of unit a is different from the n of unit b. In embodiments, the n of unit a is different from the n of unit c. In embodiments, the n of unit b is different from the n of unit C.

In general, in the ion-exchange polymers having a structure according to Formula (I), Formula (IV), Formula (V), Formula (VI), Formula (VII), Formula (VIII), and Formula (IX), each m is an integer. In embodiments, each m is independently 1 or 2. In embodiments, at least one m of unit a is 1. In embodiments, the m of unit bis 1. In embodiments, the m of unit c is 1. In embodiments, both m of unit a are 1. In embodiments, at least one m of unit a is 2. In embodiments, the m of unit b is 2. In embodiments, the m of unit c is 2. In embodiments, both m of unit a are 2. In embodiments, all m are 1. In embodiments all m are 2.

In general, in the ion-exchange polymers having a structure according to Formula (II) and Formula (VI), each q is an integer. In embodiments, each q is independently 1 or 2. In embodiments, at least one q of unit a is 1. In embodiments, the q of unit b is 1. In embodiments, the q of unit c is 1. In embodiments, both q of unit a are 1. In embodiments, at least one q of unit a is 2. In embodiments, the q of unit b is 2. In embodiments, the q of unit c is 2. In embodiments, both q of unit a are 2. In embodiments, all q are 1. In embodiments, all q are 2.

In general, in the ion-exchange polymers having a structure according to Formula (I), Formula (II), Formula (III), Formula (IV), Formula (V), Formula (VI), Formula (VII), Formula (VIII), Formula (IX), and Formula (X), each p can be 0 or 1. In embodiments, at least one p of unit a is 0. In embodiments, both p of unit a are 0. In embodiments, the p of unit b is 0. In embodiments, the p of unit c is 0. In embodiments, at least one p of unit a is 1. In embodiments, both p of unit a are 1. In embodiments, the p of unit b is 1. In embodiments, the p of unit c is 1. In embodiments, all p are 0. In embodiments, all p are 1.

In general, in the ion-exchange polymers having a structure according to Formula (I), Formula (II), Formula (III), Formula (IV), Formula (V), Formula (VI), Formula (VII), Formula (VIII), and Formula (IX), A₁ is not particularly limited. In embodiments, each A₁ can be individually selected from C, O, and N. It will be understood that each A₁ and the corresponding R₃ groups are selected to form chemically stable compositions, and a selection of (i) an A₁ and a corresponding R₃ that would not form a chemically stable composition or (ii) a selection of two adjacent A₁ that would not form a chemically stable composition are not encompassed by the present disclosure. For example, when A₁ is O or N, a corresponding R₃ would not be OH or O—C₁-C₆alkyl. As another example, two adjacent A₁ are not both O or are not O and N. In general, each A₁(R₃)₂ segment can be neutral or ionic. In embodiments, each A₁(R₃)₂ segment is neutral. In embodiments, at least one A₁(R₃)₂ segment is cationic. In embodiments, at least two A₁(R₃)₂ segments are ionic, with the proviso that two cationic A₁(R₃)₂ segments are not adjacent.

In embodiments, each A₁ is independently be selected from C, N, and O. In embodiments, when two adjacent A₁ are N, then one R₃ on at least one N is absent. In embodiments, at least one A₁ of unit a is C. In embodiments, at least one A₁ of unit a is O. In embodiments, at least one A₁ of unit a is N. In embodiments, at least one A₁ of unit b is C. In embodiments, at least one A₁ of unit b is O. In embodiments, at least one A₁ of unit b is N. In embodiments, at least one A₁ of unit c is C. In embodiments, at least one A₁ of unit c is O. In embodiments, at least one A₁ of unit c is N.

In general, in the ion-exchange polymers of the disclosure having a structure according to Formula (I), Formula (II), Formula (III), Formula (IV), Formula (V), Formula (VI), Formula (VII), Formula (VIII), and Formula (IX), Y is not particularly limited. In embodiments, each Y can independently be inorganic anion or an organic anion. In embodiments, at least one Y of unit a is an inorganic anion. In embodiments, both Y of unit a are inorganic anions. In embodiments, at least one Y of unit b is an inorganic anion. In embodiments, both Y of unit b are inorganic anions. In embodiments, the Y of unit c is an inorganic anion. In embodiments, the inorganic anion comprises a halogen anion selected from fluoride, chloride, bromide, and iodide anions. In embodiments, the halogen anion comprises a chloride. In embodiments, at least one Y of unit a is an organic anion. In embodiments, both Y of unit a are organic anions. In embodiments, at least one Y of unit b is an organic anion. In embodiments, both Y of unit b are organic anions. In embodiments, the Y of unit c is an organic anion. In embodiments, the organic anion is an organic carboxylate ion or an organic sulfonate ion. In embodiments, the organic anion is an acetate anion or a methanesulfonate anion.

In general, in the ion-exchange polymers having a structure according to Formula (I) and Formula (II), R₁ is not particularly limited. In embodiments, R₁ can be any group that largely resistant to degradation in a caustic environment. In embodiments, R₁ can be any group that has relatively low steric bulk. In embodiments, each R₁ is independently selected from H, OH, C₁-C₆alkyl, O—C₁-C₆alkyl, C₅-C₆cycloalkyl, and substituted or unsubstituted phenyl. In embodiments, at least one R₁ of unit a is H. In embodiments, the R₁ of unit b is H. In embodiments, the R₁ of unit c is H. In embodiments, both R₁ of unit a are H. In embodiments, at least one R₁ of unit a is C₁-C₆alkyl. In embodiments, at least one R₁ of unit bis C₁-C₆alkyl. In embodiments, at least one R₁ of unit c is C₁-C₆alkyl. In embodiments, both R₁ of unit a are C₁-C₆alkyl. In embodiments, at least one R₁ of unit a is C₁alkyl. In embodiments, the R₁ of unit b is C₁alkyl. In embodiments, the R₁ of unit c is C₁alkyl. In embodiments, both R₁ of unit a are C₁alkyl. In embodiments, at least one R₁ of unit a is phenyl. In embodiments, the R₁ of unit b is phenyl. In embodiments, the R₁ of unit c is phenyl. In embodiments, both R₁ of unit a are phenyl. In embodiments, at least one R₁ of unit a is phenyl substituted with at least two methyl. In embodiments, the R₁ of unit b is phenyl substituted with at least two methyl. In embodiments, the R₁ of unit c is phenyl substituted with at least two methyl. In embodiments, both R₁ of unit a are phenyl substituted with at least two methyl.

In general, in the ion-exchange polymers having a structure according to Formula (I), Formula (II), and Formula (IV), R₂ is not particularly limited. In embodiments, R₂ can be any group that largely resistant to degradation in a caustic environment. In embodiments, R₂ can be any group that has relatively low steric bulk. In embodiments, each R₂ is independently selected from H, OH, C₁-C₆alkyl, O—C₁-C₆alkyl, C₅-C₆cycloalkyl, and substituted or unsubstituted phenyl. In embodiments, at least one R₂ of unit a is H. In embodiments, at least two R₂ of unit a are H. In embodiments, at least three R₂ of unit a are H. In embodiments, all R₂ of unit a are H. In embodiments, at least one R₂ of unit b is H. In embodiments, at least two R₂ of unit b are H. In embodiments, at least one R₂ of unit c is H. In embodiments, at least two R₂ of unit c are H. In embodiments, at least one R₂ of unit a is C₁alkyl. In embodiments, at least two R₂ of unit a are C₁alkyl. In embodiments, at least three R₂ of unit a are C₁alkyl. In embodiments, all R₂ of unit a are C₁alkyl. In embodiments, at least one R₂ of unit b is C₁alkyl. In embodiments, at least two R₂ of unit b are C₁alkyl. In embodiments, at least one R₂ of unit c is C₁alkyl. In embodiments, at least two R₂ of unit c are C₁alkyl.

In general, in the ion-exchange polymers having a structure according to Formula (I), Formula (II), Formula (III), Formula (IV), Formula (V), Formula (VI), Formula (VII), Formula (VIII), and Formula (IX). R₃ is not particularly limited. In embodiments, R₃ can be any group that largely resistant to degradation in a caustic environment. In embodiments, R₃ can be any group that has relatively low steric bulk. In embodiments, each R₃ is independently absent, H, OH, C₁-C₆alkyl, O—C₁-C₆alkyl, C₅-C₆cycloalkyl, or substituted or unsubstituted phenyl. In embodiments wherein A₁ is O, both corresponding R₃ are absent. In embodiments wherein A₁ is N, one corresponding R₃ can be absent such that the N is a tertiary amine. In embodiments wherein A₁ is N, both R₃ can be present such that the N is a quaternary amine. Any A₁ present in the form of a quaternary amine also include a suitable counteranion. In embodiments, at least one R₃ of unit a is H. In embodiments, at least one R₃ of unit b is H. In embodiments, at least one R₃ of unit c is H. In embodiments, all R₃ of unit a are H. In embodiments, all R₃ of unit b are H. In embodiments, all R₃ of unit c are H. In embodiments, at least one R₃ of unit a is OH. In embodiments, at least one R₃ of unit b is OH. In embodiments, at least one R₃ of unit c is OH.

In general, in the ion-exchange polymers having a structure according to Formula (III), Formula (VII), Formula (VIII), and Formula (IX), R₄ is not particularly limited. In embodiments, R₄ can be any group that largely resistant to degradation in a caustic environment. In embodiments, R₄ can be any group that has relatively low steric bulk. In embodiments, each R₄ is independently selected from C₁-C₆alkyl, C₅-C₆cycloalkyl, and substituted or unsubstituted phenyl. In embodiments, at least one R₄ of unit a is C₁alkyl. In embodiments, at least two R₄ of unit a are C₁alkyl. In embodiments, at least three R₄ of unit a are C₁alkyl. In embodiments, all R₄ of unit a are C₁alkyl. In embodiments, at least one R₄ of unit b is C₁alkyl. In embodiments, both R₄ of unit b are C₁alkyl. In embodiments, at least one R₄ of unit c is C₁alkyl. In embodiments, both R₄ of unit c are C₁alkyl

In general, in the ion-exchange polymers having a structure according to Formula (VII), Formula (VIII), and Formula (IX), each of R₅, R₆, R₇, R₅′, R₆′, and R₇′ can be selected from the group of H, CH═CH₂, and CH₂CH═CH₂. In embodiments, wherein R₅, R₆, R₇, R₅′, R₆′, or R₇′ are CH═CH₂ or CH₂CH═CH₂, the CH═CH₂ and/or CH₂CH═CH₂ group can be polymerized as part of the polymer network (not shown). In embodiments, all R₅ and R₅′ are CH═CH₂. In embodiments, all R₅ and R₅′ are CH₂CH═CH₂. In embodiments, all R₅ and R₅′ are H. In embodiments, all R₆ and R₆′ are CH═CH₂. In embodiments, all R₆ and R₆′ are CH₂CH═CH₂. In embodiments, all R₆ and R₆′ are H. In embodiments, all R₇ and R₇′ are CH═CH₂. In embodiments, all R₇ and R₇′ are CH₂CH═CH₂. In embodiments, all R₇ and R₇′ are H. In embodiments, all R₅, R₅′, R₆, R₆′ are CH═CH₂. In embodiments, all R₅, R₅′, R₆, R₆′ are CH₂CH═CH₂. In embodiments, all R₅, R₅′, R₅, R₅′ are H. In embodiments, all R₅ and R₅′ are CH═CH₂ and all R₆ and R₆′ are CH₂CH═CH₂. In embodiments, all R₅ and R₅′ are CH₂CH═CH₂ and all R₆ and R₆′ are CH═CH₂. In embodiments, all R₅, R₅′, R₇, R-′ are CH═CH₂. In embodiments, all R₅, R₅′, R₇, R-′ are CH₂CH═CH₂. In embodiments, all R₅, R₅′, R₇, R₇′ are H. In embodiments, all R₅ and R₅′ are CH═CH₂ and all R₇ and R₇′ are CH₂CH═CH₂. In embodiments, all R₅ and R₅′ are CH₂CH═CH₂ and all R₇ and R₇′ are CH═CH₂. In embodiments, all R₇, R₇′, R₆, R₆′ are CH═CH₂. In embodiments, all R₇, R₇′, R₆, R₆′ are CH₂CH═CH₂. In embodiments, all R₇, R₇′, R₆, R₆′ are H. In embodiments, all R₇ and R₇′ are CH═CH₂ and all R₆ and R₆′ are CH₂CH═CH₂. In embodiments, all R₇ and R₇′ are CH₂CH═CH₂ and all R₆ and R₆′ are CH═CH₂.

In general, in the monomers according to Compound (V), Compound (VII), Compound (VIII), and Compound (X) R₈ is not particularly limiting. In embodiments, R₈ can be any group that largely resistant to degradation in a caustic environment. In embodiments, R₈ can be any group that has relatively low steric bulk. In embodiments, each R₈ can independently be CH═CH₂, CH₂CH═CH₂, C₁-C₆alkyl, C₅-C₆cycloalkyl, or substituted or unsubstituted phenyl. In embodiments, each R₈ can independently be CH═CH₂ or CH₂CH═CH₂. In embodiments wherein R₈ is CH═CH₂ or CH₂CH═CH₂, the CH═CH₂ and/or CH₂CH═CH₂ can be polymerized as part of the polymer network (not shown). In embodiments, each R₈ can independently be C₁-C₆alkyl or C₅-C₆cycloalkyl. In embodiments, each R₈ can independently be C₁-C₆alkyl. In embodiments, all R₈ are C₁alkyl (methyl). In embodiments, all R₈ are C₂alkyl.

In embodiments, the ion-exchange polymers having a structure according to Formula (I), Formula (II), Formula (III), or Formula (IV) can be selected from:

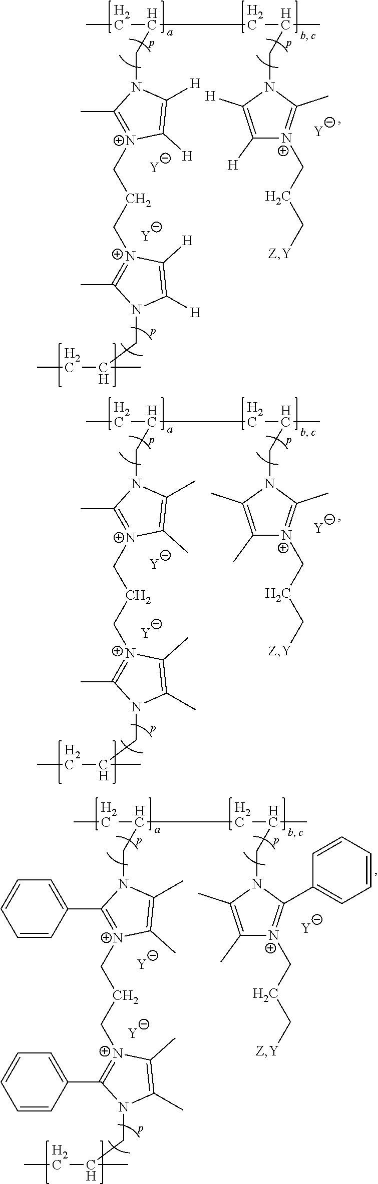

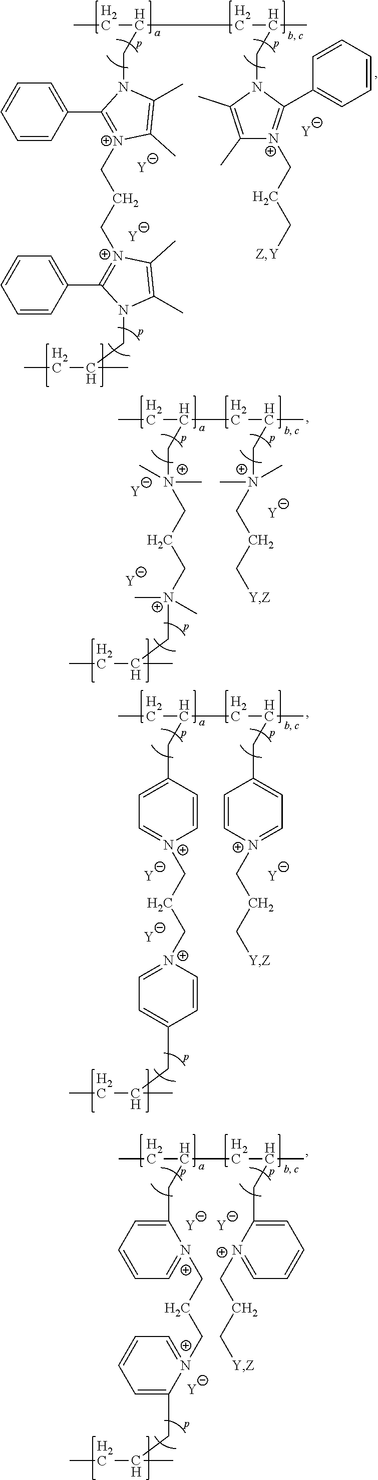

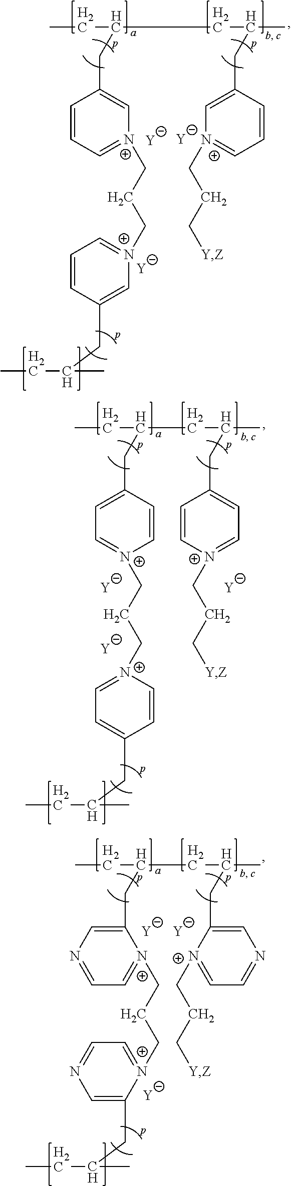

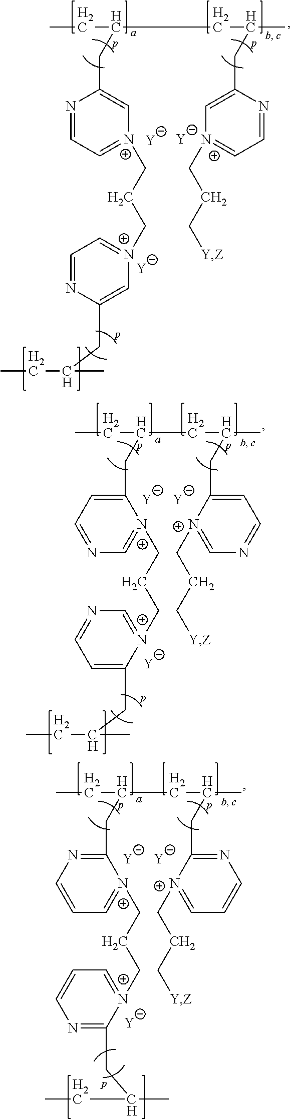

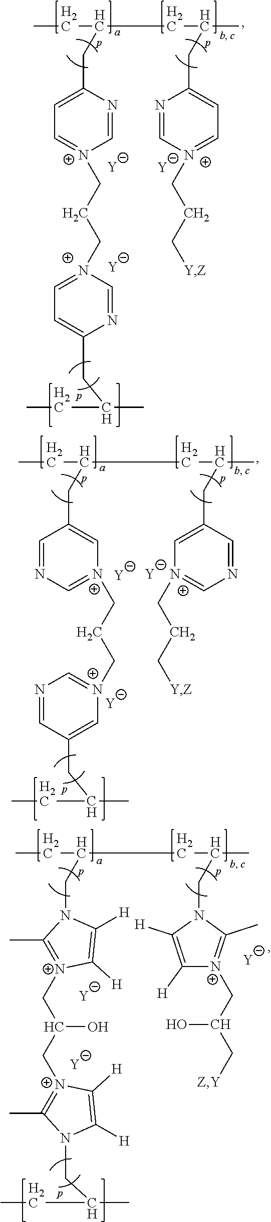

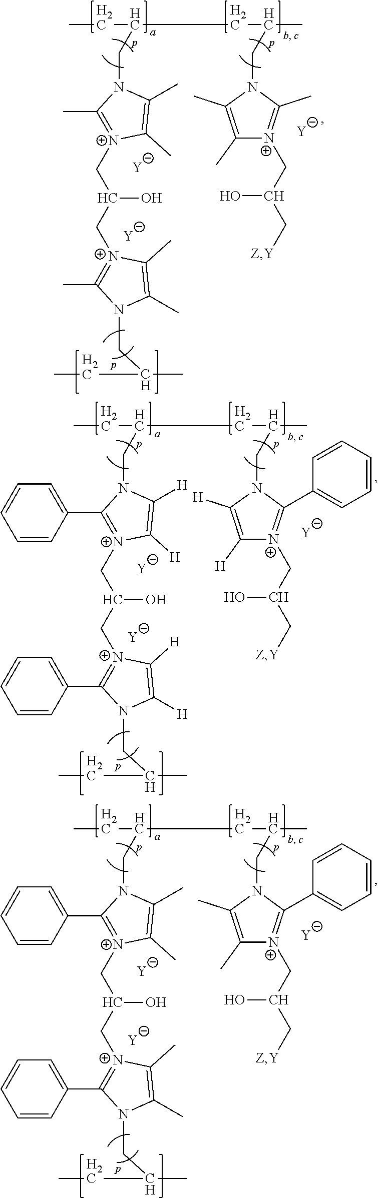

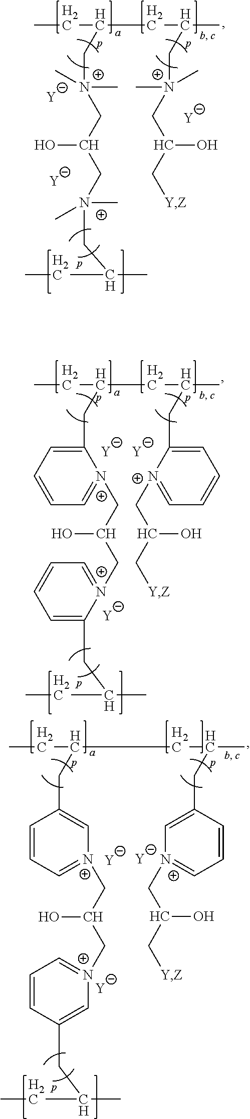

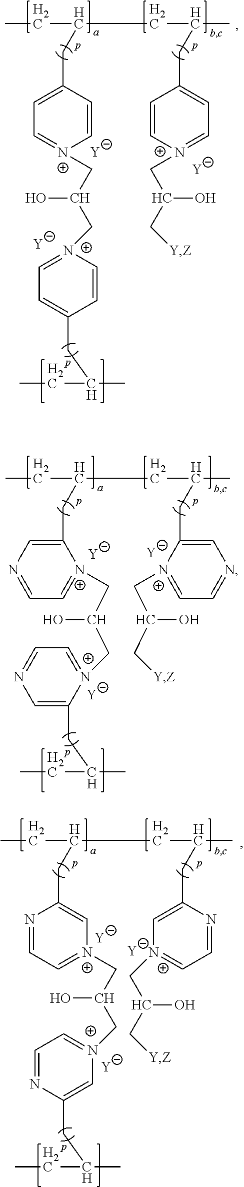

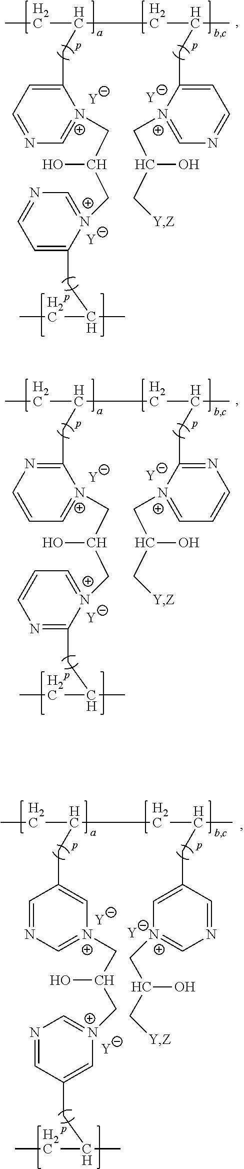

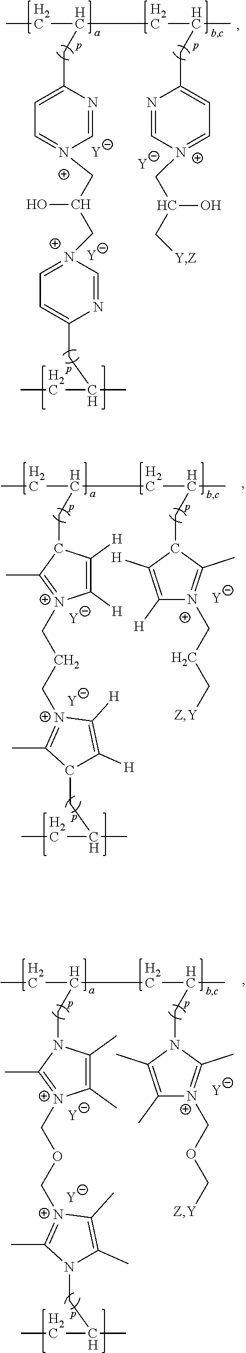

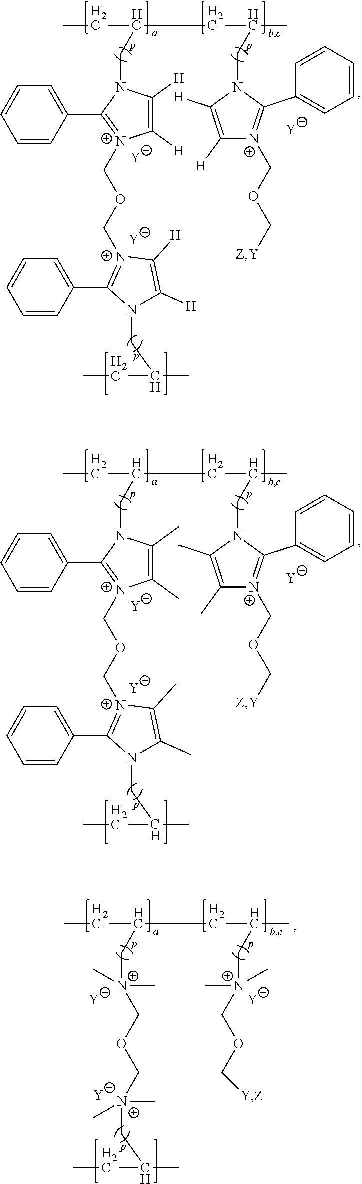

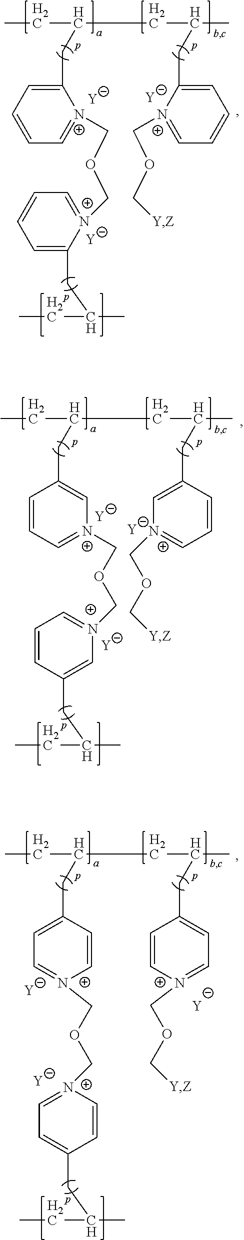

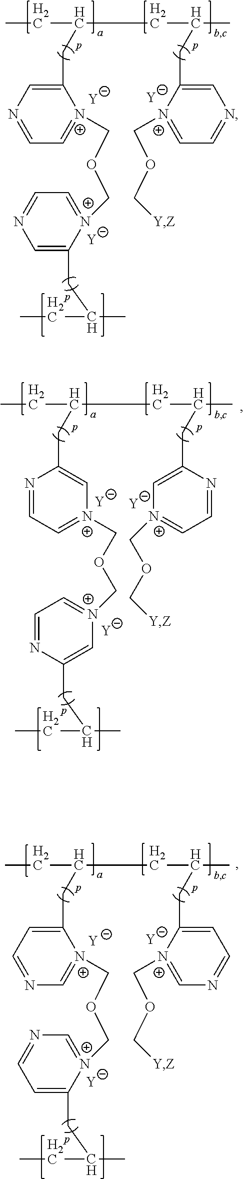

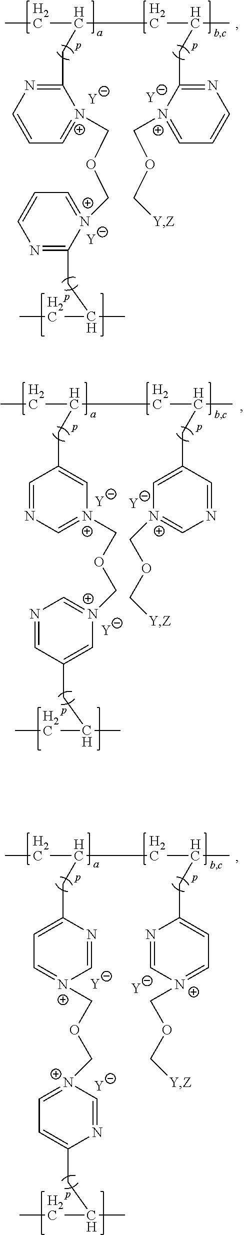

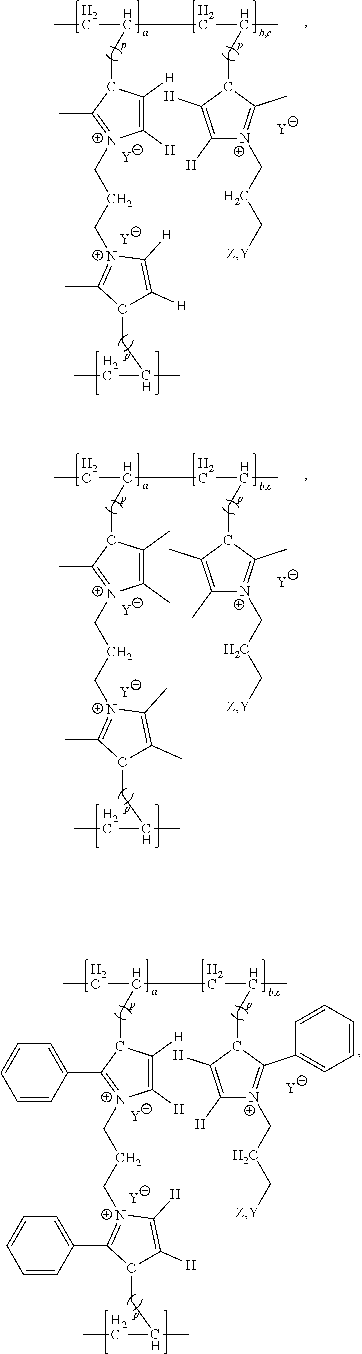

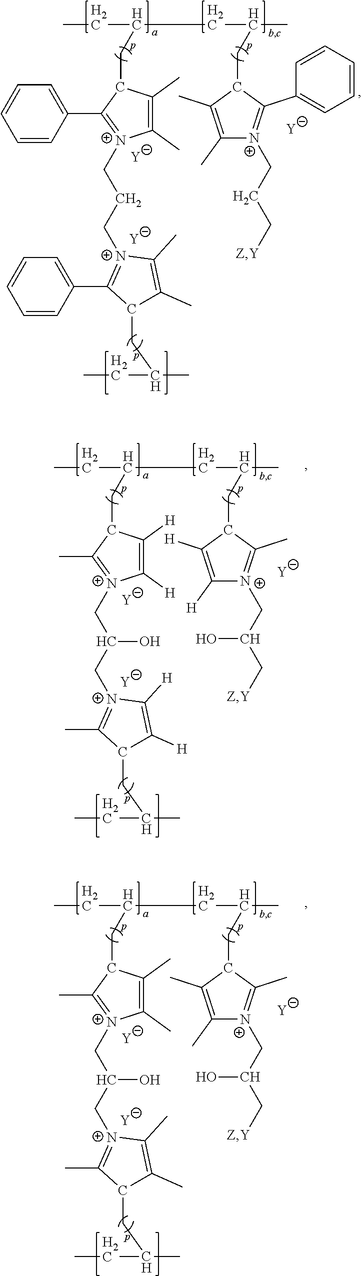

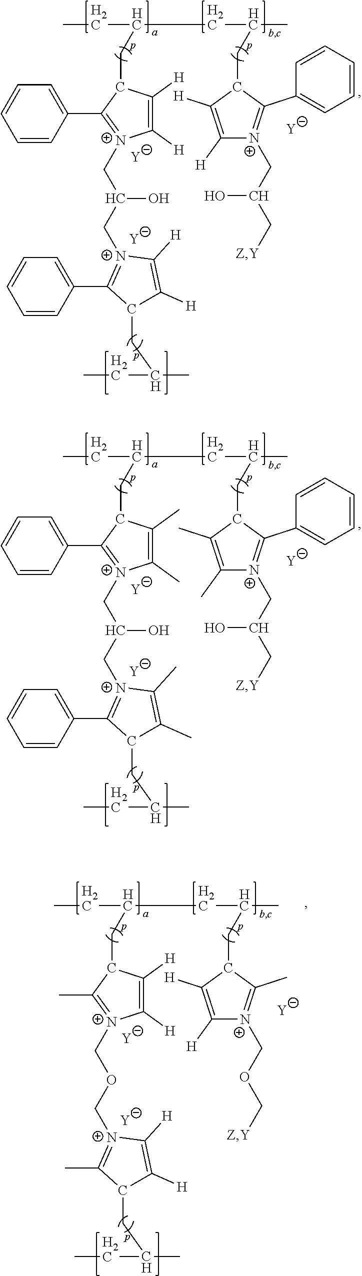

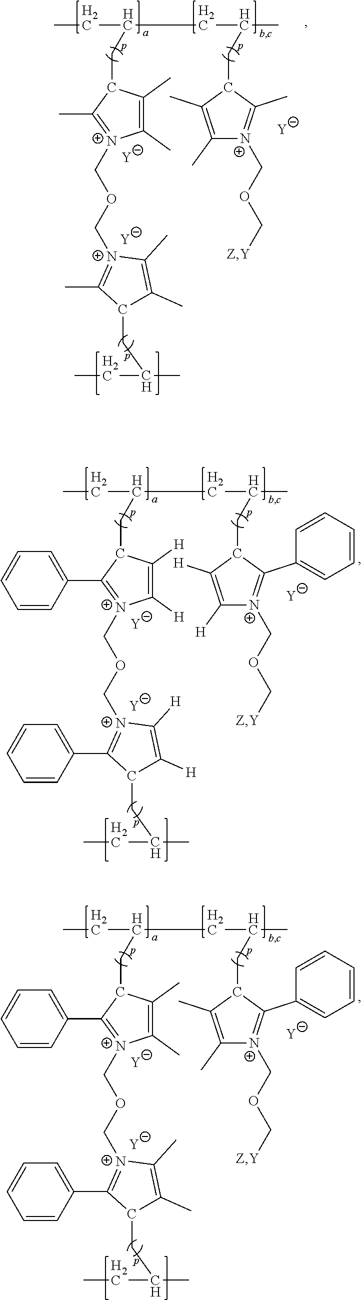

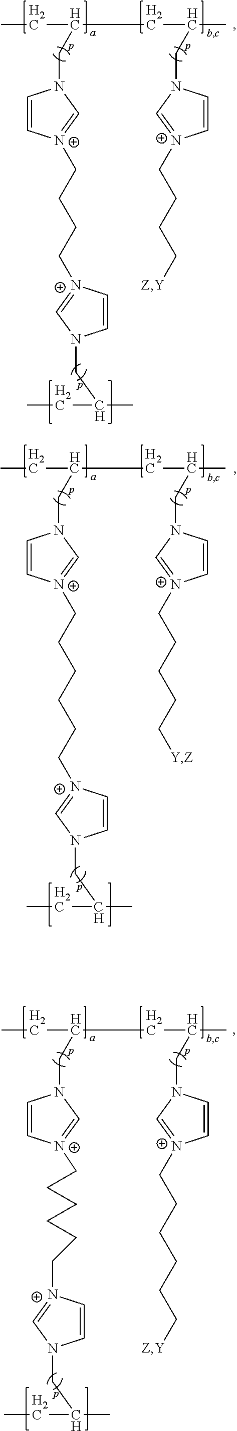

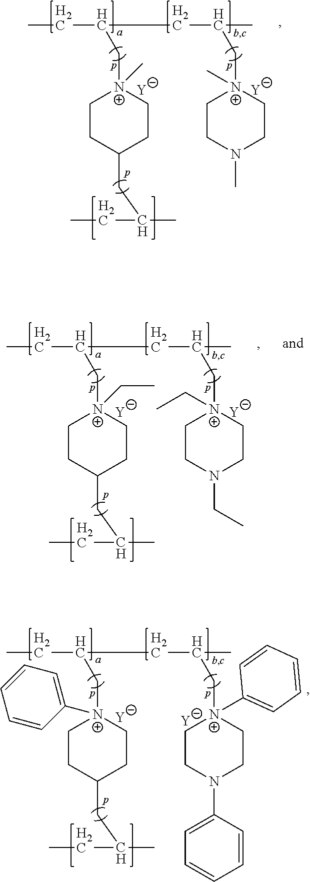

wherein in the structures the designations “b,c” and “Z,Y” (or “Y,Z”) means that the polymer can contain “b” monomer units with substitutent Y and/or “c” monomer units with substituent Z.

In general, the ion-exchange polymers of the disclosure can exhibit high (e.g., at least 3 mol/L or greater) charge density. As used herein, the “charge density” of an ion-exchange polymer/membrane refers to the moles of charge per liter of hydrated polymer/membrane and, in particular, polymers/membranes that have been equilibrated in water. Dry membranes/polymers can also be characterized for charge density. The charge density of a dry membrane/polymer will be higher than the charge density of a hydrated membrane/polymer. A reference to “maximum charge density” is to the charge density of a dry membrane/polymer. Charge density can be determined according to the procedures described herein. In embodiments, the ion-exchange polymers of the disclosure can be characterized by a charge density of at least about 1 mol/L, at least about 3 mol/L hydrated polymer, at least about 3.5 mol/L, at least about 4 mol/L, at least about 4.5 mol/L, or at least about 5 mol/L, for example in a range of about 3 mol/L to about 10 mol/L, about 3.5 mol/L to about 9 mol/L, about 4 mol/L to about 8 mol/L, about 4.5 mol/L to about 7 mol/L, or about 5 to about 6 mol/L, for example, about 3, about 3.5, about 4, about 4.5, about 5, about 5.5, about 6, about 6.5, about 7, about 7.5, about 8, about 8.5, about 9, about 9.5, or about 10 mol/L hydrated polymer. In embodiments, the ion-exchange polymers of the disclosure can be characterized by a charge density at a given water volume fraction of the hydrated polymer. Thus, in embodiments, the ion-exchange polymers of the disclosure characterized by a water volume fraction of 40% or more can have a charge density of at least about 3 mol/L hydrated polymer, at least about 3.5 mol/L, at least about 4 mol/L, at least about 4.5 mol/L, or at least about 5 mol/L, for example in a range of about 3 mol/L to about 10 mol/L, about 3.5 mol/L to about 9 mol/L, about 4 mol/L to about 8 mol/L, about 4.5 mol/L to about 7 mol/L, or about 5 to about 6 mol/L, for example, about 3, about 3.5, about 4, about 4.5, about 5, about 5.5, about 6, about 6.5, about 7, about 7.5, about 8, about 8.5, about 9, about 9.5, or about 10 mol/L hydrated polymer.

The ion-exchange polymers of the disclosure can further be characterized by a selectivity, ag/c, of at least about 7, at least about 10, at least about 20, or at least about 30 for solutions of 1 molal NaCl (mol/kg water). Selectivity provides the ratio of current carried by counter-ions (desirable ions, denoted g) to current carried by co-ions (undesirable ions, denoted c). Selectivity is a unitless ratio. In embodiments, the ion-exchange polymer can be characterized by a 1 molal NaCl selectivity in a range of about 7 to about 1500, about 10 to about 1500, about 20 to about 1500, about 30 to about 1500, about 50 to about 1400, about 100 to about 1300, about 200 to about 1250, about 500 to about 1200, or at least about 150, at least about 500, or at least about 800. In embodiments, the ion-exchange polymer can be characterized by a combination of selectivity and throughput. Throughput refers to the rate that the counter-ions (desirable ions) cross the membrane. Throughput can be divided by the thickness of the membrane to provide the flux of ions crossing the membrane. Thus in embodiments, the ion-exchange polymer can be characterized by a 1 molal NaCl selectivity of at least about 7 to about 1500, at least about 30 to about 1500, at least about 80 to about 1500, or at least about 200 and up to about 1500 and a 1 molal NaCl throughput of at least 4×10⁻⁹ mol ion/cm polymer (membrane)/s, at least 6×10⁻⁹ mol/cm/s, at least 6.5×10⁻⁹ mol/cm/s, at least 1×10⁻⁸ mol/cm/s, or at least 2×10⁻⁸ mol/cm/s.

In embodiments, the ion-exchange polymers of the disclosure can further be characterized by a salt permeability. For 1 molal NaCl at 22±1° C., the salt permeability can be in a range of about 5×10⁻¹⁰ to about 3×10⁻⁶ cm² membrane/s, about 5×10⁻¹⁰ to about 5×10⁻⁷ cm² membrane/s, about 1×10⁻⁹ to about 5×10⁻⁷ cm² membrane/s, or about 3×10⁻⁹ to about 5×10⁻⁷ cm² membrane/s. In embodiments, the ion-exchange polymer can have a chloride-form total ionic conductivity at 22±1° C. in a range of about 10 to about 90 mS/cm, about 10 to about 85 mS/cm, about 10 to about 70 mS/cm, or about 15 to about 70 mS/cm. In embodiments, the ion-exchange polymers of the disclosure are stable in a caustic environment, such as a 1 M KOH or 4 M KOH solution at 80° C. for at least one hour. An ion-exchange polymer is considered stable under a caustic environment if, after one hour, the polymer maintains at least 80% of its pre-caustic treatment conductivity.

As described in the examples, below, the cross-linkable monomers can advantageously be designed to tune the charge density and throughput of the resulting polymer/membrane. In general, as the length of the monomer increases, the charge density of the resulting polymer typically decreases and the throughput of the resulting polymer typically decreases, when the polymers are prepared from monomer solutions having substantially the same monomer concentrations (e.g., ±5%).

In some embodiments, the ion-exchange polymer can be a free standing film. In other embodiments, the ion-exchange polymer can be adhered or bound to a solid substrate material, for example, to form a backed membrane article. The article can be formed by polymerizing the monomer solution (described below) in the presence of a solid support material. The solid support material is not particularly limited and can be selected to impart additional structural integrity to the ion-exchange polymer. Examples of suitable solid support material include a membrane backing cloth, such as acrylic, polyester, or polypropylene material. The corresponding article is suitable for use as an ion-exchange membrane. In some embodiments, the support can be a continuous layer separate or distinct from the ion-exchange polymer layer. In other embodiments, the support structure can have a mesh-like structure or otherwise include openings (e.g., a solid mesh defining square, rectangular, etc. openings) that is embedded with the ion-exchange polymer as a reinforcement such as in a composite structure. A suitable range of thickness values for the support material is 50 μm to 600 μm. For example, the support material can have a thickness of at least 50, 75, 100, 125, 150, or 200 μm and/or up to 80, 100, 120, 160, 200, 300, 400, 500, or 600 μm. In embodiments where the support material is embedded within the ion-exchange polymer layer, the corresponding article can have likewise have a net thickness in a range of 50 μm to 600 μm, for example at least 50, 75, 100, 125, 150, or 200 μm and/or up to 80, 100, 120, 160, 200, 300, 400, 500, or 600μ m.

In some embodiments, the ion-exchange polymer can be incorporated into a composite membrane such as a composite ion-exchange membrane (IEM). Commercial IEMs commonly feature a composite structure. One example is a pore-filled IEM, which is fabricated by polymerizing the ion-exchange polymer within the pores of mechanically strong porous membranes such as microporous membranes. The reason for implementing this composite architecture is twofold. First, the mechanical properties of the membranes can be significantly enhanced relative to those of homogenous membranes, rendering the IEMs suitable for implementation in large scale systems. Second, the swelling of the ion-exchange polymer phase can be physically restricted by the microporous supporting membrane, which can yield composite membranes with fixed charge concentrations that are higher than the homogeneous counterparts. Higher fixed charge concentrations at controlled swelling degrees will yield IEMs with improved selectivity and throughput. Such pore-filled IEMs can be synthesized by polymerizing the cross-linkable monomers within the pores of a microporous membrane. Microporous membranes can be selected to have a desired pore size, porosity, thickness, and/or chemistry depending on the final application. The microporous membranes can be soaked in the reaction solution to allow the reaction solution to fully penetrate the pores of the microporous membranes. After the pore-filling process is complete, the monomer-soaked microporous membranes can be placed on a glass plate or other surface. Excess reaction solution can be gently removed prior to covering the membrane with a second glass plate or other surface. The plates can be placed inside of a forced convection oven or otherwise exposed to sufficient heat to initiate the reaction. The microporous membranes can be microfiltration membranes (e.g., thicknesses of about 100 μm) or battery separator membranes (e.g., thicknesses as low as about 5 μm). A significant advantage of using battery separator membranes is the low membrane thickness, which leads to low electrical resistances of the composite membranes.

Examples of suitable microporous membranes (or porous membranes more generally) include those with a porosity in a range of 30% to 70%, such as at least 30, 40, 50, or 60% and/or up to 40, 50, 60, or 70%. Alternatively or additionally, the microporous or porous membrane can have a pore size in a range of 0.001 μm to 1 μm, for example at least 0.001, 0.003, 0.01, 0.03, 0.05, 0.07, 0.1, 0.15, 0.2, 0.3, 0.4, or 0.5 μm and/or 0.1, 0.2, 0.3, 0.5, 0.7, or 1 μm. The foregoing pore sizes can represent an average pore size or diameter and/or a range for pore size or diameter distribution (e.g., upper and lower bounds of a cumulative size distribution such as a 1/99%, 5/95%, or 10/90% cut). The material for the membrane is not particularly limited, but examples of suitable membrane materials include polymer materials such as polypropylene, polyethylene, or polytetrafluoroethylene. A suitable range of thickness values for the microporous membrane is 2 μm to 600 μm, such as 2 μm to 20 μm (e.g., for a battery separator) or 50 μm to 200 μm (e.g., for a microfiltration membrane). For example, the porous substrate 162 can have a thickness of at least 2, 5, 10, 15, 20, 30, 50, 75, 100, 125, 150, or 200 μm and/or up to 20, 40, 60, 80, 100, 120, 160, 200, 300, 400, 500, or 600 μm. Similarly, the corresponding article 202 can have likewise have a net thickness of at least 2, 5, 10, 15, 20, 30, 50, 75, 100, 125, 150, or 200 μm and/or up to 20, 40, 60, 80, 100, 120, 160, 200, 300, 400, 500, or 600 μm.

The ion-exchange polymers of the disclosure can be prepared according to the methods disclosed herein.

### Methods of the Disclosure

The disclosure further provides methods for preparing the ion-exchange polymers of the disclosure. In general, the methods of the disclosure include admixing a polymerization initiator and a monomer solution comprising an optional solvent and a plurality of cross-linkable monomers according to the disclosure and polymerizing the monomer solution to form the ion-exchange polymer. In embodiments, the monomer solution further comprises imperfect monomers as disclosed herein. In embodiments, the monomer solution further comprises monofunctional monomers as disclosed herein. In embodiments, the monomer solution consists of the optional solvent and the plurality of cross-linkable monomers according to the disclosure, and optionally minor amounts of imperfect monomers. In embodiments, the monomer solution consists of the optional solvent and a plurality of monomers, the plurality of monomers consisting of monomers selected from the group of monomers according to Compound (I), Compound (II), Compound (III), Compound (IV), Compound (V), Compound (VII), Compound (VIII), and a combination thereof and, optionally, monomers selected from the group of monomers according to Compound (IX), Compound (X), Compound (XI), Compound (XII), Compound (XIII), Compound (XIV), Compound (XV), Compound (Ia), Compound (IIa), Compound (IIIa), Compound (IVa), Compound (Va), Compound (VIa), Compound (VIIa), and a combination thereof: In embodiments, the plurality of monomers include at least one monomer selected from the group of to Compound (I), Compound (II), Compound (III), Compound (IV), Compound (V), Compound (VI), Compound (VII), Compound (VIII), or a combination thereof. In embodiments, the plurality of monomers includes at least one monomer selected from the group of to Compound (I), Compound (II), Compound (III), Compound (IV), Compound (V), Compound (VI), Compound (VII), Compound (VIII), or a combination thereof and at least one monomer selected from the group of the group of to Compound (IX), Compound (X), Compound (XI), Compound (XII), Compound (XIII), Compound (XIV), Compound (XV), or a combination thereof.

In general, the polymerization initiator can be any suitable initiator for polymerizing vinyl monomers. In embodiments, the polymerization initiator can comprise a thermal initiator or a UV initiator (photopolymerization initiator). An example of a suitable thermal initiator is 2,2′-azobis(2-methylpropionamidine) dihydrochloride. Examples of suitable photopolymerization initiators include, but are not limited to, aromatic ketones such as 1-hydroxycyclohexyl phenyl ketone and 2,2-dimethoxy-2-phenylacetophenone, acylphosphines, aromatic onium salts, organic peroxides, thio compounds, hexaarylbiimidazoles, ketoxime esters, borates, azinium compounds, metallocenes, active esters, compounds having a halogen bond, and alkyl amines. Other suitable thermal and photo initiators are commercially available from the FUJIFILM Wako Pure Chemical Corporation. In embodiments, the polymerization initiator is water-soluble. As used herein, a polymerization initiator is water-soluble if 0.1% by mass or greater of the polymerization initiator dissolves in distilled water at 25° C. In embodiments, 1% by mass or more of the polymerization initiator dissolves in distilled water at 25° C. In embodiments, 3% by mass or more of the polymerization initiator dissolved in distilled water at 25° C.

In embodiments wherein the cross-linkable monomers are in liquid form, the monomer solution can be free of a solvent and the monomers provided neat. In embodiments, the monomers (whether liquid or otherwise) can be dissolved in a solvent. In embodiments, the monomer solution can include about 50 wt. % to about 100 wt. % monomers, with the balance of the monomer solution being a solvent that dissolves the monomers. In embodiments, the monomer solution can include about 60 wt. % to about 95 wt. %, or about 70 wt. % to about 90 wt. %, based on the total weight of the monomer solution. In embodiments, the monomer solution is a saturated monomer solution. It will be appreciated that because different monomers have different solubilities, the actual amount of monomer dissolved in a saturated monomer solution will vary by monomer and solvent. As demonstrated in the examples below, a saturated monomer solution can provide an ion-exchange polymer having a high selectivity and charge density, relative to an ion-exchange polymer prepared from the same monomer at a more dilute concentration.

In general, the solvent can be any solvent that dissolves the cross-linkable monomer. In embodiments, the solvent comprises a polar solvent. In embodiments, the solvent comprises water, dimethylsulfoxide (DMSO), N-methyl-2-pyrrolidone (NMP), methanol, ethanol, 1-propanol, acetonitrile, formamide, dimethylformamide (DMF), acetone, or a combination thereof. In embodiments, the solvent comprises water.

In embodiments, the polymerizing comprises exposing the monomer solution to conditions sufficient to initiate polymerization. In embodiments, conditions sufficient to initiate polymerization comprises heating the monomer solution, applying a UV light, or a combination thereof.

In embodiments, the polymerization initiator comprises a thermal initiator and the conditions sufficient to initiate polymerization comprise heating the monomer solution. In embodiments, the monomer solution can be heated to any temperature sufficient to activate the thermal initiator. In embodiments, the monomer solution will not be heated above the boiling point of any solvent present in the monomer solution or above the degradation temperature of the cross-linkable monomer. In embodiments, the monomer solution can be heated to a temperature in a range of about 50° C. to less than 100° C., about 50° C. to about 98° C., about 60° C. to about 97° C., about 70° C. to about 96° C., about 75° C. to about 95° C., about 80° C. to about 90° C., or about 60° C., about 65° C., about 70° C., about 75° C., about 80° C., about 85° C., about 90° C., or about 95° C. In embodiments, the monomer solution can be heated for any suitable time to prepare a polymer. It will be understood that as the amount of time the monomer solution is heated increases, more monomers in the solution will be consumed. Thus, the monomer solution can be heated for a time sufficient to consume significantly all of the monomers in solution. In embodiments, the monomer solution can be heated for a time in a range of about 30 seconds to about 48 hours, about 1 minute to about 42 hours, about 2 minutes to about 36 hours, about 5 minutes to about 30 hours, about 10 minutes to about 24 hours, about 15 minutes to about 18 hours, about 20 minutes to about 12 hours, about 25 minutes to about 6 hours, about 30 minutes to about 1 hour, or about 35 minutes to about 45 minutes, for example, about 15 minutes, about 30 minutes, about 40 minutes, about 50 minutes, about 1 hour, about 3 hours, about 5 hours, about 6 hours, or about 12 hours.

In embodiments, the polymerization initiator comprises a UV initiator and the conditions sufficient to initiate polymerization comprise applying a UV light. In embodiments, the UV light has a wavelength in a range of about 100 nm to about 400 nm, about 100 nm to about 280 nm, about 280 nm to about 315 nm, about 315 nm to about 400 nm, or about 365 nm. In embodiments, the monomer solution can be irradiated with the UV light for any suitable time to prepare a polymer. It will be understood that as the amount of time the monomer solution is irradiated increases, more monomers in the solution will be consumed. Thus, the monomer solution can be irradiated for a time sufficient to consume significantly all of the monomers in solution. In embodiments, the monomer solution can be irradiated for a time in a range of about 30 seconds to about 48 hours, about 1 minute to about 42 hours, about 2 minutes to about 36 hours, about 5 minutes to about 30 hours, about 10 minutes to about 24 hours, about 15 minutes to about 18 hours, about 20 minutes to about 12 hours, about 25 minutes to about 6 hours, about 30 minutes to about 1 hour, or about 35 minutes to about 45 minutes, for example, about 15 minutes, about 30 minutes, about 40 minutes, about 50 minutes, about 1 hour, about 3 hours, about 5 hours, about 6 hours, or about 12 hours.

As described in the examples, below, the preparation conditions for the ion-exchange polymers of the disclosure can advantageously be controlled to tune the water volume fraction, charge density, and selectivity of the resulting polymer/membrane. In general, as the mass fraction of water in the monomer solution increases, the water volume fraction of the resulting polymer increases, and the charge density and selectivity decrease.

In embodiments, the methods of preparing the ion-exchange polymers further comprise admixing the plurality of monomers with the optional solvent to form the monomer solution. The monomer solution can be stirred with heat prior to adding the polymerization initiator and initiating polymerization. The monomer solution can be heated to any temperature suitable to dissolve the monomers and the polymerization initiator, for example, in a range of about 30° C. to about 45° C.

In embodiments, the methods further comprise casting the monomer solution on a substrate prior to initiating polymerization. The substrate is not particularly limited and can be any substrate suitable for heating and/or irradiating the monomer solution, without degrading the monomers and/or resulting polymers. In embodiments, the monomer solution is cast between two plates (e.g., silanized glass) such that the monomer solution polymerizes to form a polymer in the shape of a membrane.

In embodiments, the methods further comprise washing the ion-exchange polymer in deionized water. The washing can include placing the polymer in deionized water and periodically changing out the water for fresh deionized water periodically over 24 hours to remove any unreacted monomers.

In embodiments, the methods further comprises exchanging the anions, Y, of the ion-exchange polymer. The exchanging of the anions can include soaking the polymer in a salt solution, wherein the salt solution has a different anion than the as-prepared ion-exchange polymer. Methods of exchanging anions on ion-exchange polymers are known in the art. For example, the polymer can be soaked in the salt solution, and the salt solution can be replaced, e.g., at least 6 times per day, over 4 days. Then, excess salt can be removed from the polymers/membranes using deionized water, with at least 6 water changes over a period of 24 hours.

### Test Methods

### Charge Density

Determination of the fixed charge density of the membrane

$$( {C}_{A}^{m , t} )$$

requires measurements of dry polymer density (ρₚ), water uptake (WU), water volume fraction (φ_{w}), ion-exchange capacity (IEC), and fixed charge concentration

$$( {C}_{A}^{m , w} )$$

Determination of Density (ρₚ), Water Uptake (WU), and Water Volume Fraction (φ_{w})

Samples were converted into the Cl⁻ form using 1 m NaCl. The salt solution was replaced at least 6 times per day, over 4 days. Then, excess salt was removed from the membranes using DI water, with at least 6 changes over a period of 24 hours. Samples were removed from the water, and the thickness, l, of each sample was determined using a micrometer. An image of each sample was analyzed via ImageJ software to obtain the surface area (SA). The sample was then rehydrated with DI water for 1 minute, quickly blotted dry, and weighed to produce the wet mass, m_{wet}.

Samples were then placed in a vacuum oven heated to 110° C. Samples were briefly removed to measure the remaining mass of the sample, until the mass ceased to decline and the sample was dry, this mass was recorded as the dry mass, m_{dry}. Fully dried samples were also weighed while immersed (mₕₑₚₜ) in a non-solvent, n-heptane (with density ρₕₑₚₜ), which provided the density of the dry polymer. Samples were allowed to dry overnight to allow complete removal of the n-heptane from the sample surface.

### Determination of Fixed Charge Density

$$( {C}_{A}^{m , t} ) ,$$

Ion-Exchange Capacity (IEC) and, Fixed Charge Concentration

$$( {C}_{A}^{m , w} )$$

Mobile counter-ions in the sample were removed via the following multi-stage desorption protocol. Dry samples were placed in a small jar with a solution of ˜40 mL 0.03 m sodium iodide (NaI). After 24 hours, the solution was poured into a separate collection jar, and the small jar still containing the polymer was replenished with an additional volume of ˜40 mL NaI. This process was repeated five times. The collection jar, containing ˜200 mL of the desorption solutions, was then fixed to a volume of 250 mL (Va) using DI water. This solution was then diluted and the chloride concentration (Ca) was quantified via ion chromatography. The relevant membrane properties were calculated using the following equations:

$${ρ}_{p} = \frac{{m}_{d r y} * {ρ}_{hept}}{{m}_{a r y} - {m}_{hept}} \\ WU = \frac{{m}_{w e t} - {m}_{dry}}{{m}_{dry}} \\ {ϕ}_{w} = \frac{\frac{{m}_{wet} - {m}_{d r y}}{{ρ}_{w}}}{S A * l} \\ IEC = \frac{{C}_{a} * {V}_{a}}{{m}_{dry}} \\ {C}_{A}^{m , w} = \frac{IEC}{W U} \\ {C}_{A}^{m , t} = {C}_{A}^{m , w} * {ϕ}_{w}$$

### Selectivity and Throughput

The selectivity and throughput of membranes were calculated from salt permeability (Pₛ), ionic conductivity (κ), co-ion sorption

$$( {C}_{c}^{m , t} ) ,$$

and counter-ion sorption

$$( {C}_{g}^{m , t} ) ,$$

as described in Kamcev, J. Poly Sci. 2021, 59, 21, 2510-2520. Selectivity, α_{g/c}, and the throughput,

$${z}_{g}^{2} {C}_{g}^{m , t} {D}_{g}^{m} ,$$

are calculated from the following equations:

$${P}_{s} = \frac{{C}_{s}^{m , t}}{{C}_{s}^{s}} \frac{{D}_{g}^{m} {D}_{c}^{m} ( {z}_{g}^{2} {C}_{g}^{m , t} + {z}_{c}^{2} {C}_{c}^{m , t} )}{{z}_{g}^{2} {C}_{g}^{m , t} {D}_{g}^{m} + {z}_{c}^{2} {C}_{c}^{m , t} {D}_{c}^{m}} \\ κ = \frac{{F}^{2}}{RT} ( {z}_{g}^{2} {C}_{g}^{m , t} {D}_{g}^{m} + {z}_{c}^{2} {C}_{c}^{m , t} {D}_{c}^{m} ) \\ {α}_{g / c} = \frac{{z}_{g}^{2} {C}_{g}^{m , t} {D}_{g}^{m}}{{z}_{c}^{2} {C}_{c}^{m , t} {D}_{c}^{m}}$$

where, zᵢ is the valence of ion i,

$${D}_{i}^{m}$$

is the diffusivity of ion i in the membrane,

$${C}_{s}^{m}$$

is the salt concentration in the membrane, and Cₛ^{s} is the salt concentration in the upstream solution.

### Salt Permeability (Pₛ)

Salt permeability measurements were performed in custom 34 ml jacketed diffusion cells. Water was circulated through the jackets of the cells to maintain a constant temperature of 22° C. during measurement. The membrane was placed between two cells, held in place by butyl rubber gaskets, completely covering a 1.5 cm diameter circular opening connecting the two cells. A donor solution of salt (C_{d}) was added to one side, while a receiver solution of DI water was added to the other, both at 34 mL volume and both with stirring. A conductivity probe was inserted into the receiver solution to track the solution conductivity, which was correlated to the concentration of salt passing via a calibration curve. The concentration of the receiving end, Cᵣ, was monitored as a function of time, and once steady state transport had set in, the permeability was calculated from the slope of the concentration.

$${P}_{s} = \frac{\partial }{\partial t} ln ( ( 1 - \frac{2 {C}_{r}}{{C}_{d}} ) * ( \frac{Vl}{2 A} ) )$$

where, V represents the volume of each chamber, A represents the exposed area for transport through the membrane, t represents the time of the measurement, and l represents the in-situ membrane thickness, which was measured by quickly disassembling the permeability experiment and immediately measuring the thickness of the membrane area exposed to salt transport.

### Measuring Ionic Conductivity (κ)

Ionic conductivity measurements were performed via a stacking method as described in Díaz, Kitto, and Kamcev, J. Membr. Sci., 2023, 669, 121304.

2.4 cm diameter circular membranes equilibrated with the appropriate salt solution were clamped between two 1.27 cm diameter circular electrodes. An oscillating voltage of 100 mV was applied across the system, over a frequency range of 3 MHz to 100 Hz. The in-phase impedance response (Z_{Re}) was recorded as the total cell resistance. Based on the electrode area Aₑₗ, the areal resistance (AR) of the membrane (or stack of membranes) was calculated as:

$$A R = {Z}_{R e} * {A}_{e l}$$

The membrane ionic conductivity was isolated from external cell resistances by testing at multiple thicknesses, l, and the linear relationship between the areal resistance and the path length between electrodes:

$$κ = \frac{\partial l}{\partial AR}$$

### Measuring Ionic Concentration

$${C}_{c}^{m , t} , {C}_{g}^{m , t}$$

Ion concentrations were measured in a manner similar to the charge contents of the membranes, as described in Example 6, except that prior to characterizing the samples, the samples were equilibrated with the salt solution, rather than DI water.

Co-ion concentration samples were immediately placed into 100 ml DI water, where mobile salt was allowed to desorb over 24 hours. These solutions were diluted and the sodium concentration was then measured via a microwave plasma atomic emission spectrometer.

$${C}_{c}^{m , t} = \frac{{V}_{a} * {C}_{a}}{S A * l}$$

Counter-ion concentration samples were still dried in the vacuum oven as before, although dry density experiments were not performed. These samples were subjected to a multi-stage desorption process in 0.03 m NaI, and the chloride concentration of the resultant solution was measured via an ion chromatograph.

$${C}_{g}^{m , t} = \frac{{V}_{a} * {C}_{a}}{S A * l}$$

Examples of particularly contemplated aspects (A1, A2, etc.) of the films and methods described herein are provided below.

A1. An ion-exchange polymer, comprising:
a structure represented by Formula (I), Formula (II), Formula (III), or Formula (IV):

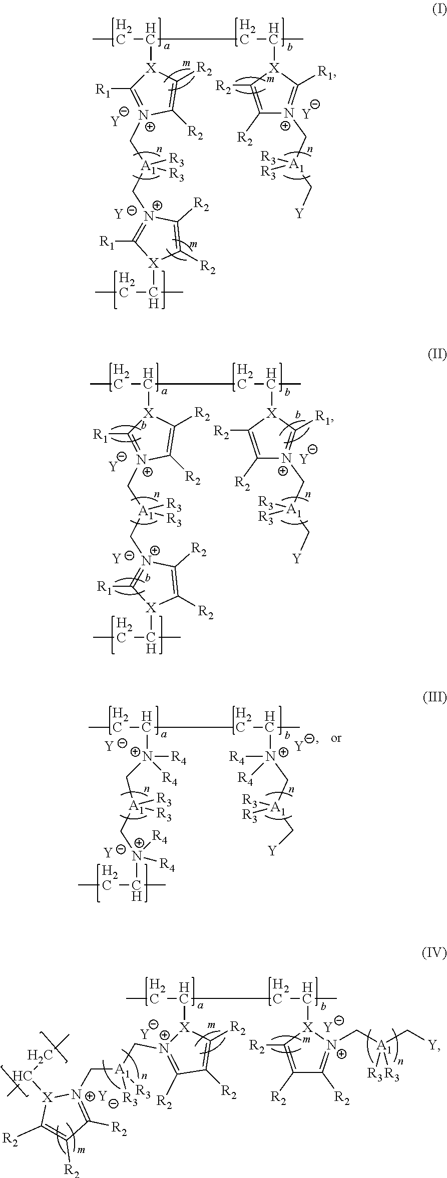

wherein each x is independently selected from C(H) and N; each A₁ is independently selected from C, N, and O, wherein when two adjacent A₁ are N, then one R₃ on at least one N is absent; n is 0, 1, 2, 3, 4, or 5; each m is independently 1 or 2; each q is independently 1 or 2; each Y is independently an inorganic anion or an organic anion; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl; and wherein 0.75≤a≤1, 0≤b≤0.25, and a+b=1.

A2. The ion-exchange polymer according to A1, wherein in Formula (I), Formula (II), or Formula (IV) at least one X of unit a is N.

A3. The ion-exchange polymer according to A1 or A2, wherein in Formula (I), Formula (II), or Formula (IV) both X of unit a are N.

A4. The ion-exchange polymer according to any one of A1-A3, wherein in Formula (I), Formula (II), or Formula (IV) the X of unit b is N.

A5. The ion-exchange polymer according to any one of A1-A4, wherein in Formula (I), Formula (II), Formula (III), or Formula (IV) n is 0, 1, or 2.

6A. The ion-exchange polymer according to A₅, wherein n is 0 or 1.

A7. The ion-exchange polymer according to any one of A1-A6, wherein in Formula (I) or Formula (IV) at least one m of unit a is 1.

A8. The ion-exchange polymer according to any one of A1-A7, wherein in Formula (I) or Formula (IV) both m of unit a are 1.

A9. The ion-exchange polymer according to any one of A1-A8, wherein in Formula (I) or Formula (IV) the m of unit b is 1.

A10. The ion-exchange polymer according to any one of A1-A6, wherein in Formula (I) or Formula (IV) at least one m of unit a is 2.

A11. The ion-exchange polymer according to any one of A1-A6 or A10, wherein in Formula (I) or Formula (IV) both m of unit a are 2.

A12. The ion-exchange polymer according to any one of A1-A6, A10, or A11, wherein in Formula (I) or Formula (IV) the m of unit b is 2.

A13. The ion-exchange polymer according to any one of A1-A12, wherein in Formula (II) at least one q of unit a is 1.

A14. The ion-exchange polymer according to any one of A1-A13, wherein in Formula (II) both q of unit a are 1.

A15. The ion-exchange polymer according to any one of A1-A14, wherein in Formula (II) the q of unit b is 1.

A16. The ion-exchange polymer according to any one of A1-A12, wherein in Formula (II) at least one q of unit a is 2.

A17. The ion-exchange polymer according to any one of A1-A12 or A16, wherein in Formula (II) both q of unit a are 2.

A18. The ion-exchange polymer according to any one of A1-A12, A16, or A17, wherein in Formula (II) the q of unit b is 2.

A19. The ion-exchange polymer according to any one of A1-A18, wherein in Formula (I), Formula (II), Formula (III), or Formula (IV), at least one A₁ of unit a is C.

A20. The ion-exchange polymer according to any one of A1-A19, wherein in Formula (I), Formula (II), Formula (III), or Formula (IV), at least one A₁ of unit a is O.

A21. The ion-exchange polymer according to any one of A1-A20, wherein in Formula (I), Formula (II), Formula (III), or Formula (IV), at least one A₁ of unit a is N.

A22. The ion-exchange polymer according to any one of A1-A21, wherein in Formula (I), Formula (II), Formula (III), or Formula (IV), at least one A₁ of unit b is C.

A23. The ion-exchange polymer according to any one of A1-A22, wherein in Formula (I), Formula (II), Formula (III), or Formula (IV), at least one A₁ of unit b is O.

A24. The ion-exchange polymer according to any one of A1-A23, wherein in Formula (I), Formula (II), Formula (III), or Formula (IV), at least one A₁ of unit b is N.

A25. The ion-exchange polymer according to any one of A1-A24, wherein in Formula (I), Formula (II), Formula (III), or Formula (IV), at least one Y of unit a is an inorganic anion.

A26. The ion-exchange polymer according to any one of A1-A25, wherein in Formula (I), Formula (II), Formula (III), or Formula (IV), both Y of unit a are inorganic anions.

A27. The ion-exchange polymer according to any one of A1-A26, wherein in Formula (I), Formula (II), Formula (III), or Formula (IV), at least one Y of unit b is an inorganic anion.

A28. The ion-exchange polymer according to any one of A25-A28, the inorganic anion comprises a halogen anion.

A29. The ion-exchange polymer according to A28, wherein the halogen anion comprises a chloride anion.

A30. The ion-exchange polymer according to any one of A1-A24, wherein in Formula (I), Formula (II), Formula (III), or Formula (IV) at least one Y of unit a is an organic anion.

A₃₁. The ion-exchange polymer according to any one of A1-A24 or A30, wherein in Formula (I), Formula (II), Formula (III), or Formula (IV), both Y of unit a are organic anions.

A32. The ion-exchange polymer according to any one of A1-A24, wherein in Formula (I), Formula (II), Formula (III), or Formula (IV), at least one Y of unit b is an organic anion.

A33. The ion-exchange polymer according to any one of A30-A32, wherein the organic anion comprises an organic carboxylate ion or an organic sulfonate ion.

A34. The ion-exchange polymer according to A33, wherein the organic anion comprises an acetate anion or a methanesulfonate anion.

A35. The ion-exchange polymer according to any one of A1-A34, wherein in Formula (I) or Formula (II), at least one R₁ of unit a comprises H.

A36. The ion-exchange polymer according to any one of claims 1-35, wherein in Formula (I) or Formula (II), both R₁ of unit a are H.

A37. The ion-exchange polymer according to any one of A1-A36, wherein in Formula (I) or Formula (II), the R₁ of unit b comprises H.

A38. The ion-exchange polymer according to any one of A1-A34, wherein in Formula (I) or Formula (II), at least one R₁ of unit a comprises C₁-alkyl.

A39. The ion-exchange polymer according to any one of A1-A34 or A38, wherein in Formula (I) or Formula (II), both R₁ of unit a are C₁-alkyl.

A40. The ion-exchange polymer according to any one of A1-A34, A38, or A39, wherein in Formula (I) or Formula (II), the R₁ of unit b comprises C₁-alkyl.

A41. The ion-exchange polymer according to any one of A1-A34, wherein in Formula (I) or Formula (II), at least one R₁ of unit a comprises phenyl.

42. The ion-exchange polymer according to any one of A1-A34 or A41, wherein in Formula (I) or Formula (II), both R₁ of unit a are phenyl.

A43. The ion-exchange polymer according to any one of A1-A34, A41, or A42, wherein in Formula (I) or Formula (II), the R₁ of unit b comprises phenyl.

A44. The ion-exchange polymer according to any one of A1-A43, wherein in Formula (I), Formula (II), or Formula (IV), at least one R₂ of unit a comprises H.

A45. The ion-exchange polymer according to any one of A1-A44, wherein in Formula (I), Formula (II), or Formula (IV), at least two R₂ of unit a are H.

A46. The ion-exchange polymer according to any one of A1-A45, wherein in Formula (I), Formula (II), or Formula (IV), at least three R₂ of unit a are H.

A47. The ion-exchange polymer according to any one of A1-A46, wherein in Formula (I), Formula (II), or Formula (IV), all R₂ of unit a are H.

A48. The ion-exchange polymer according to any one of A1-A47, wherein in Formula (I), Formula (II), or Formula (IV), at least one R₂ of unit b comprises H.

A49. The ion-exchange polymer according to any one of A1-A48, wherein in Formula (I), Formula (II), or Formula (IV), at least two R₂ of unit b are H.

A50. The ion-exchange polymer according to any one of A1-A43, wherein in Formula (I), Formula (II), or Formula (IV), at least one R₂ of unit a comprises C₁-alkyl.

A51. The ion-exchange polymer according to any one of A1-A43 or A50, wherein in Formula (I), Formula (II), or Formula (IV), at least two R₂ of unit a are C₁-alkyl.

A52. The ion-exchange polymer according to any one of A1-A43, A50, or A51, wherein in Formula (I), Formula (II), or Formula (IV), at least three R₂ of unit a are C₁-alkyl.

A53. The ion-exchange polymer according to any one of A1-A43 or A50-A52, wherein in Formula (I), Formula (II), or Formula (IV), all R₂ of unit a are C₁-alkyl.

A54. The ion-exchange polymer according to any one of A1-A43 or A50-A53, wherein in Formula (I), Formula (II), or Formula (IV), at least one R₂ of unit b comprises H.

A55. The ion-exchange polymer according to any one of A1-A43 or A50-A54, wherein in Formula (I), Formula (II), or Formula (IV), at least two R₂ of unit b are C₁-alkyl.

A56. The ion-exchange polymer according to any one of A1-A55, wherein in Formula (I), Formula (II), Formula (III), at least one R₃ of unit a comprises H.

A57. The ion-exchange polymer according to any one of A1-A56, wherein in Formula (I), Formula (II), Formula (III), or Formula (IV), all R₃ of unit a are H.

A58. The ion-exchange polymer according to any one of A1-A57, wherein in Formula (I), Formula (II), Formula (III), or Formula (IV), at least one R₃ of unit b comprises H.

A59. The ion-exchange polymer according to any one of A1-A58, wherein in Formula (I), Formula (II), Formula (III), or Formula (IV), all R₃ of unit b are H.

A60. The ion-exchange polymer according to any one of A1-A55, wherein in Formula (I), Formula (II), Formula (III), or Formula (IV), at least one R₃ of unit a is OH.

A61. The ion-exchange polymer according to any one of A1-A55, or A60, wherein in Formula (I), Formula (II), Formula (III), or Formula (IV), at least one R₃ of unit b is OH.

A62. The ion-exchange polymer according to any one of A1-A61, wherein in Formula (III) at least one R₄ of unit a is C₁-alkyl.

A63. The ion-exchange polymer according to any one of A1-A62, wherein in Formula (III) at least two R₄ of unit a is C₁-alkyl.

A64. The ion-exchange polymer according to any one of A1-A63, wherein in Formula (III) at least three R₄ of unit a is C₁-alkyl.

A65. The ion-exchange polymer according to any one of A1-A64, wherein in Formula (III) all R₄ of unit a are C₁-alkyl.

A66. The ion-exchange polymer according to any one of A1-A65, wherein in Formula (III) at least one R₄ of unit b is C₁-alkyl.

A67. The ion-exchange polymer according to any one of A1-A66, wherein in Formula (III) both R₄ of unit b are C₁-alkyl.

A68. The ion-exchange polymer according to any one of A1-A67, wherein 0.80 s a≤1, 0.85≤a≤1, 0.90≤a≤1, 0.95≤a≤1, 0.97≤a≤1, 0.98≤a≤1, 0.80≤a≤0.999, 0.85≤a≤0.999, 0.90≤a≤0.999, 0.95≤a≤0.999, 0.97≤a≤0.999, or 0.98≤a≤0.999.

A69. The ion-exchange polymer according to any one of A1-A68, selected from the group of:

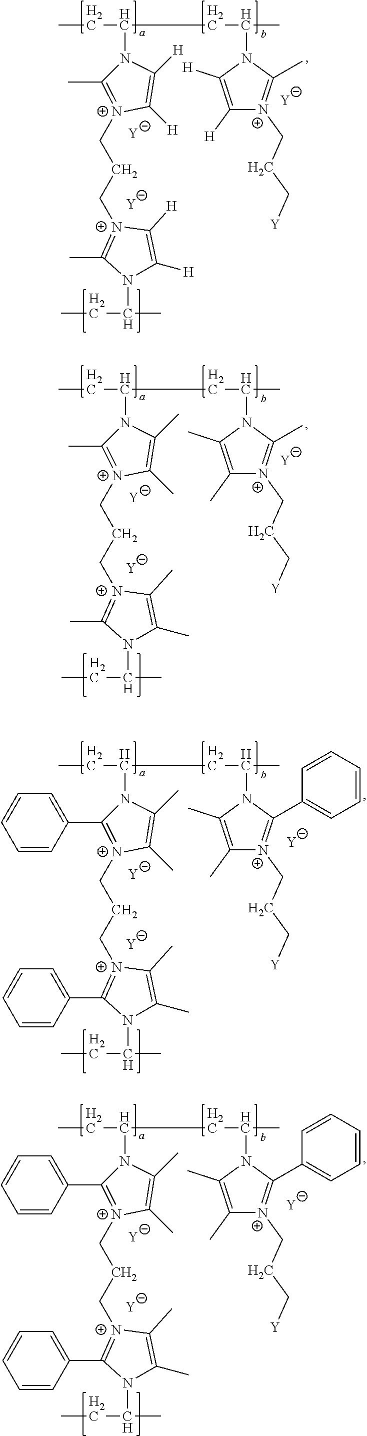

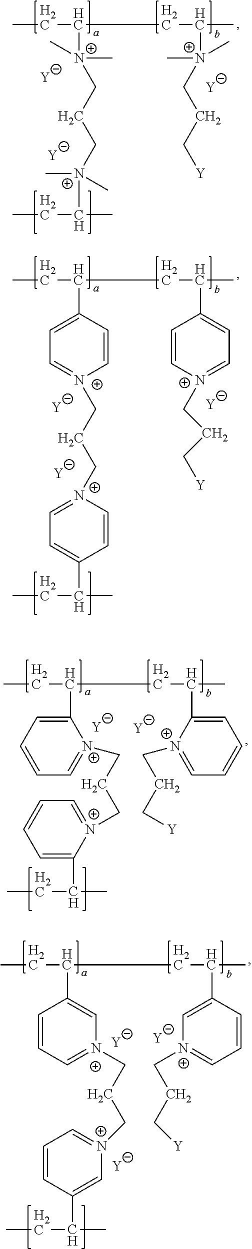

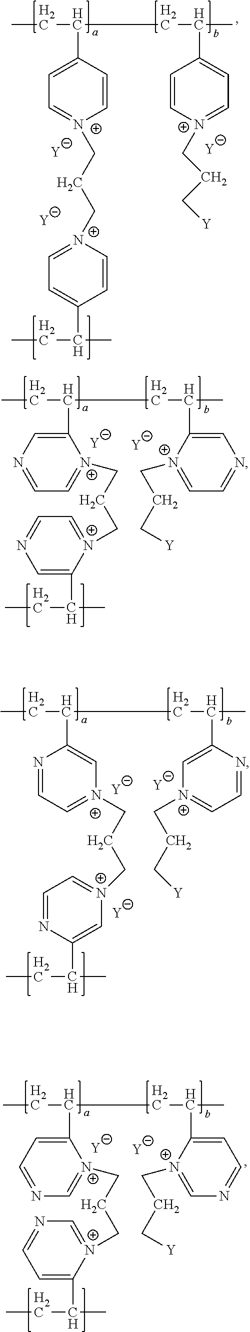

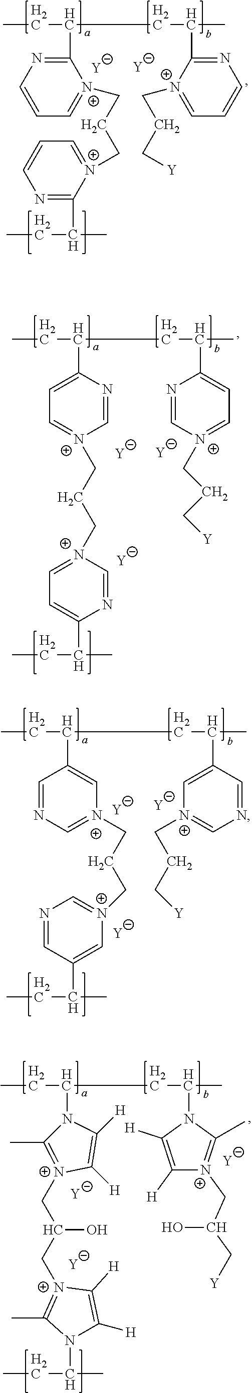

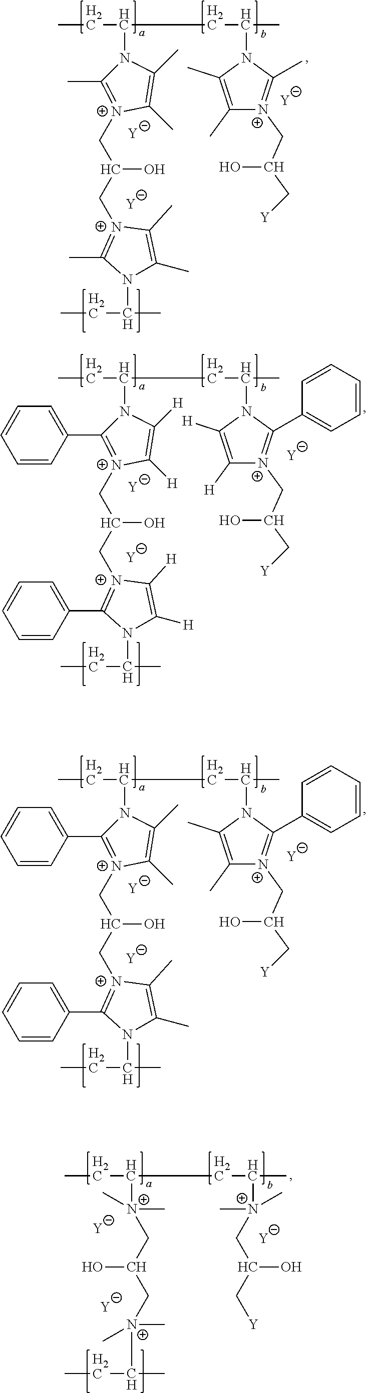

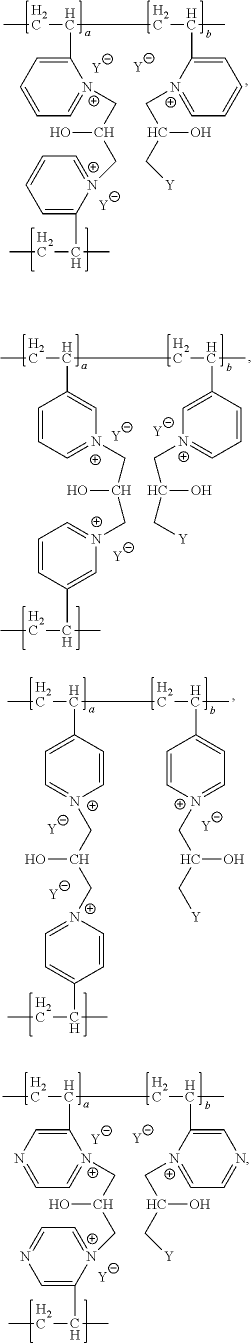

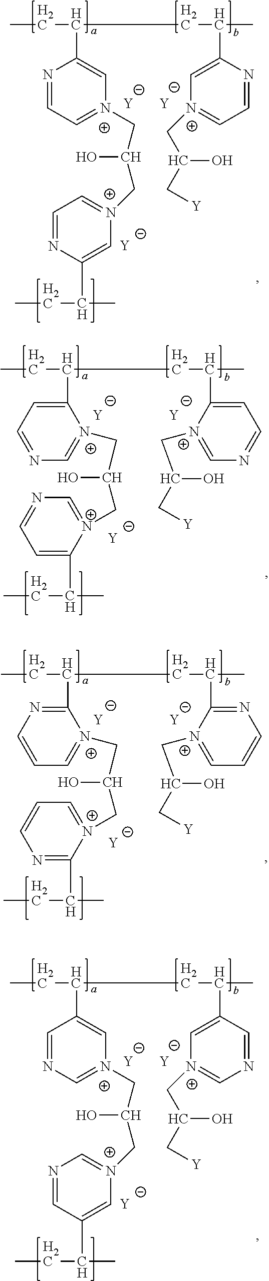

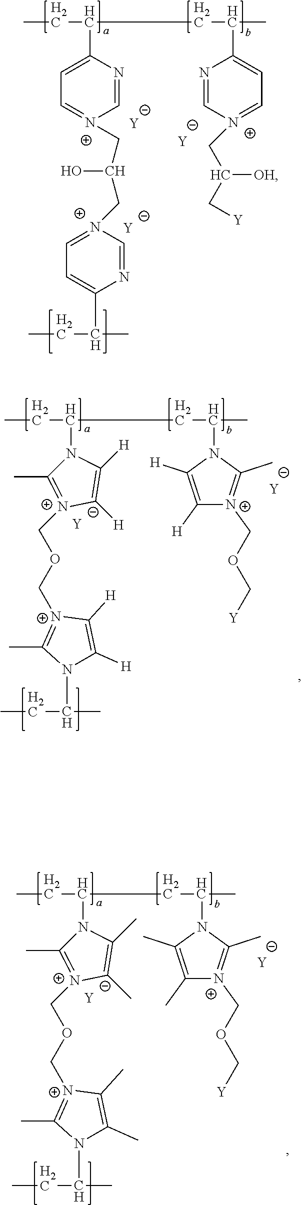

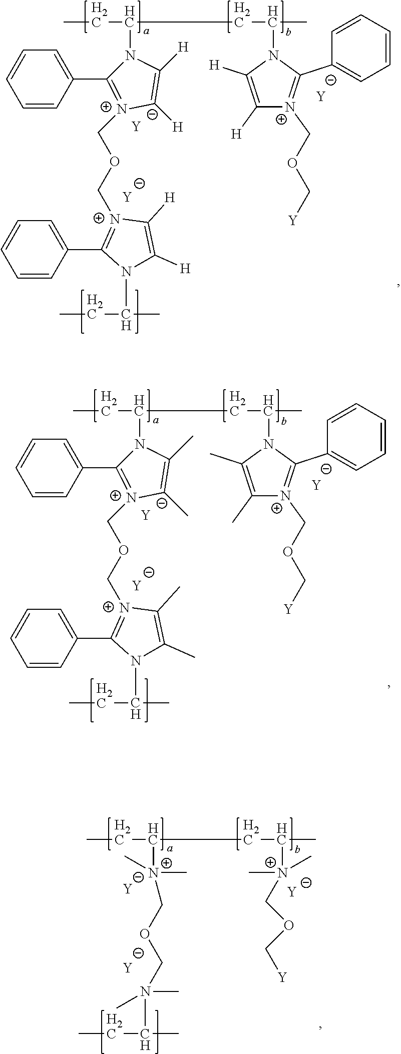

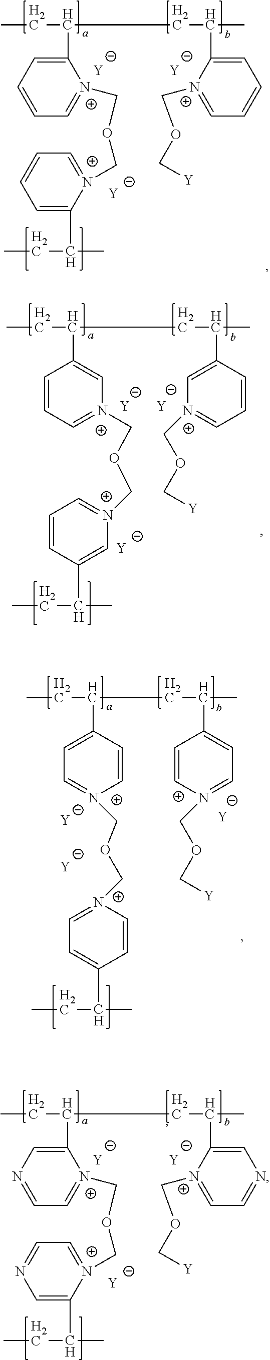

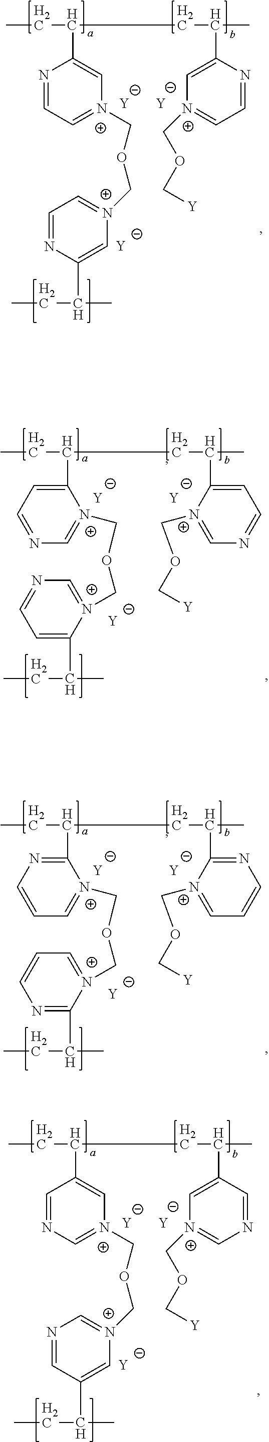

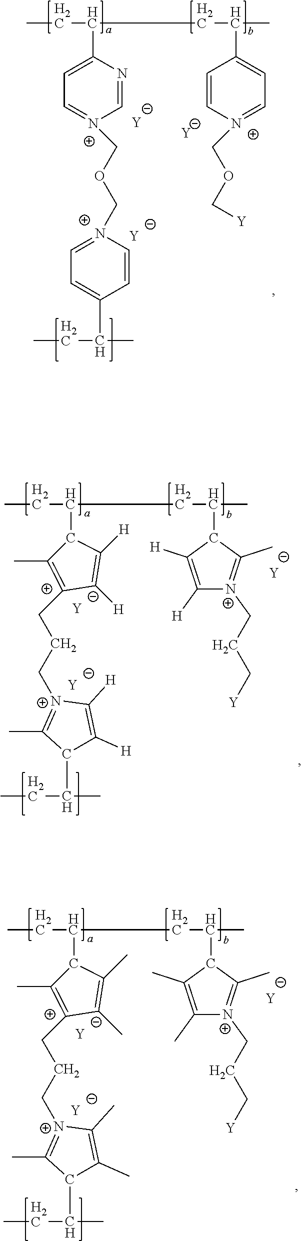

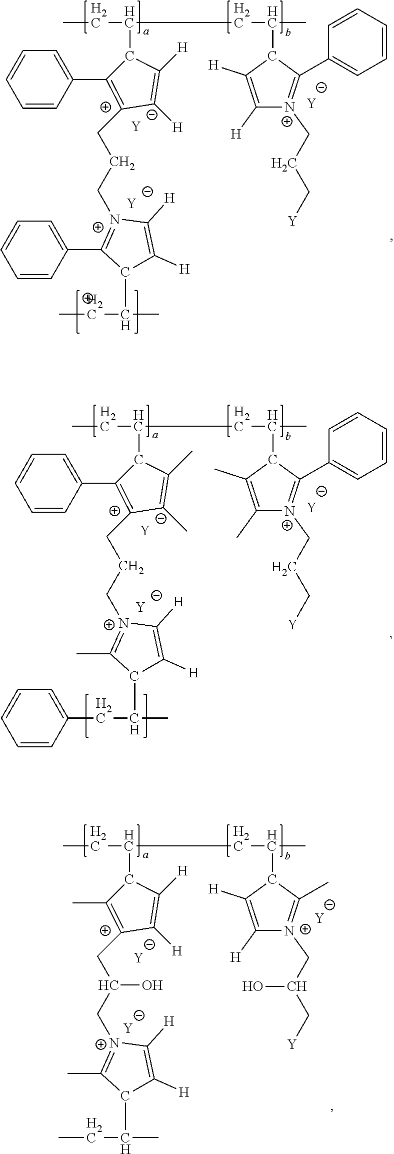

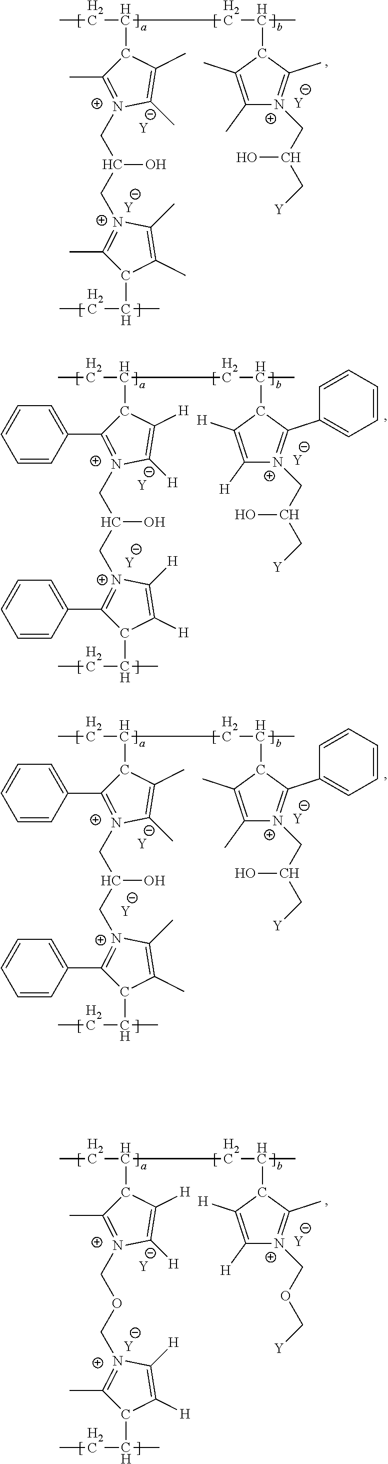

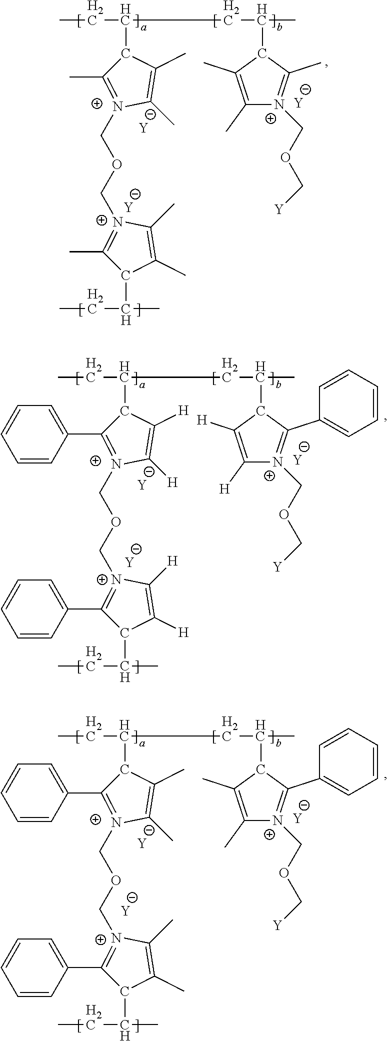

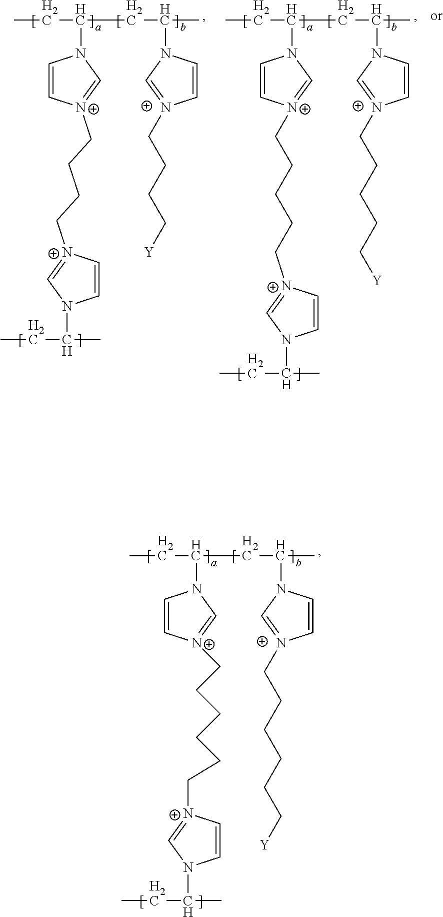

wherein each Y is independently an inorganic anion or an organic anion; 0.75≤a≤1, 0≤b≤0.25, and a+b=1.

A₇₀. The ion-exchange polymer according to any one of A₁-A₆₉, prepared from polymerizing a plurality of monomers selected from the group of Compound (I), Compound (II), Compound (III), Compound (IV), and a combination thereof:

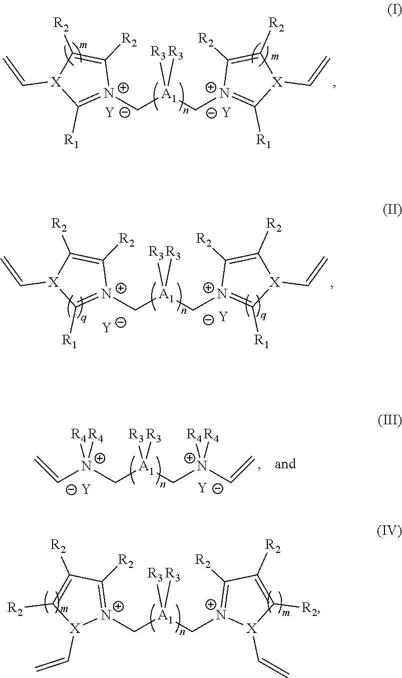

wherein each x is independently selected from C(H) and N; each A₁ is independently selected from C, N, and O, wherein when two adjacent A₁ are N, then one R₃ on at least one N is absent; n is 0, 1, 2, 3, 4, or 5; each m is independently 1 or 2; each q is independently 1 or 2; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl; and each Y is independently an inorganic anion or an organic anion.

A71. An ion-exchange polymer, comprising the product of polymerizing a plurality of monomers selected from the group of Compound (I), Compound (II), Compound (III), Compound (IV), combinations thereof:

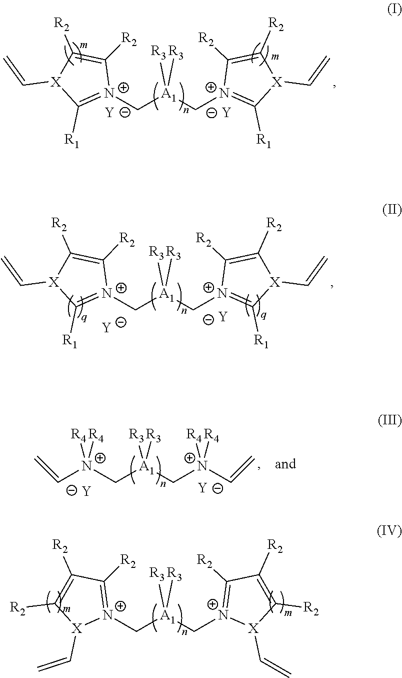

wherein each x is independently selected from C(H) and N; each A₁ is independently selected from C, N, and O, wherein when two adjacent A₁ are N, then one R₃ on at least one N is absent; n is 0, 1, 2, 3, 4, or 5; each m is independently 1 or 2; each q is independently 1 or 2; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; each R₄ is independently selected from C₁-C₆alkyl, C₅-C₆cycloalkyl, and substituted or unsubstituted phenyl; and each Y is independently an inorganic anion or an organic anion.

A72. The ion-exchange polymer according to A71, wherein in Compound (I), Compound (II), or Compound (IV), at least one X is N.

A73. The ion-exchange polymer according to A71 or A72, wherein in Compound (I), Compound (II), or Compound (IV), both X are N.

A74. The ion-exchange polymer according to A71, wherein in Compound (I), Compound (II), or Compound (IV), at least one X is C(H).

A75. The ion-exchange polymer according to A71 or A72, wherein in Compound (I), Compound (II), or Compound (IV), both X are C(H).

A76. The ion-exchange polymer according to any one of A71 to A75, wherein in Compound (I), Compound (II), Compound (III), or Compound (IV), n is 0, 1, 2, or 3.

A77. The ion-exchange polymer according to any one of A71 to A76, wherein in Compound (I), Compound (II), Compound (III), or Compound (IV), n is 0, 1, or 2.

A78. The ion-exchange polymer according to any one of A71 to A77, wherein in Compound (I), Compound (II), Compound (III), or Compound (IV), n is 0 or 1.

A79. The ion-exchange polymer according to any one of A71-A78, wherein in Compound (I) or Compound (IV), at least one m is 0.

A80. The ion-exchange polymer according to any one of A71-A79, wherein in Compound (I) or Compound (IV), both m are 0.

A81. The ion-exchange polymer according to any one of A71-A78, wherein in Compound (I) or Compound (IV), at least one m is 1.

A82. The ion-exchange polymer according to any one of A71-A78 or A81, wherein in Compound (I) or Compound (IV), both m are 1.

A83. The ion-exchange polymer according to any one of A71-A82, wherein in Compound (II), at least one q is 0.

A84. The ion-exchange polymer according to any one of A71-A83, wherein in Compound (II), both q are 0.

A85. The ion-exchange polymer according to any one of A71-A82, wherein in Compound (II), at least one q is 1.

A86. The ion-exchange polymer according to any one of A71-A82 or A85, wherein in Compound (II), both q are 1.

A87. The ion-exchange polymer according to any one of A71-A86, wherein in Compound (I), Compound (II), Compound (III), or Compound (IV), at least one A₁ is C.

A88. The ion-exchange polymer according to any one of A71-A87, wherein in Compound (I), Compound (II), Compound (III), or Compound (IV), all A₁ are C.

A89. The ion-exchange polymer according to any one of A71-A86, wherein in Compound (I), Compound (II), Compound (III), or Compound (IV), at least one A₁ is O.

A90. The ion-exchange polymer according to any one of A71-A86 and 89, wherein in Compound (I), Compound (II), Compound (III), or Compound (IV), at least two A₁ are O, provided that the two A₁ are not adjacent.

A91. The ion-exchange polymer according to any one of A71-A86, wherein in Compound (I), Compound (II), Compound (III), or Compound (IV), at least one A₁ is N.

A92. The ion-exchange polymer according to any one of A71-A86 or A91, wherein in Compound (I), Compound (II), Compound (III), or Compound (IV), at least two A₁ are N, provided that when two adjacent A₁ are N, then one R₃ on at least one N is absent.

A93. The ion-exchange polymer according to any one of A71-A92, wherein in Compound (I), Compound (II), Compound (III), or Compound (IV), at least one Y is the inorganic anion.

A94. The ion-exchange polymer according to any one of A71-A93, wherein in Compound (I), Compound (II), Compound (III), or Compound (IV), both Y are inorganic anions.

A95. The ion-exchange polymer according to any one of A71-A94, wherein in Compound (I), Compound (II), Compound (III), or Compound (IV), at least one Y is chloride.

A96. The ion-exchange polymer according to any one of A71-A95, wherein in Compound (I), Compound (II), Compound (III), or Compound (IV), both Y are chloride.

A97. The ion-exchange polymer according to any one of A71-A92, wherein in Compound (I), Compound (II), Compound (III), or Compound (IV), at least one Y is an organic anion.

A98. The ion-exchange polymer according to any one of A71-A92 or A97, wherein in Compound (I), Compound (II), Compound (III), or Compound (IV), both Y are organic anions.

A99. The ion-exchange polymer according to any one of A71-A98, wherein in Compound (I) or Compound (II), at least one R₁ is H.

A100. The ion-exchange polymer according to any one of A71-A99, wherein in Compound (I) or Compound (II), both R₁ are H.

A101. The ion-exchange polymer according to any one of A71-A98, wherein in Compound (I) or Compound (II), at least one R₁ is C₁alkyl.

A102. The ion-exchange polymer according to any one of A71-A98 or A101, wherein in Compound (I) or Compound (II), both R₁ are C₁alkyl.

A103. The ion-exchange polymer according to any one of A71-A98, wherein in Compound (I) or Compound (II), at least one R₁ is phenyl.

A104. The ion-exchange polymer according to any one of A71-A98 or A103, wherein in Compound (I) or Compound (II), both R₁ are phenyl.

A105. The ion-exchange polymer according to any one of A71-A104, wherein in Compound (I), Compound (II), or Compound (IV), at least one R₂ is H.

A106. The ion-exchange polymer according to any one of A71-A105, wherein in Compound (I), Compound (II), or Compound (IV), at least two R₂ are H.

A107. The ion-exchange polymer according to any one of A71-A106, wherein in Compound (I), Compound (II), or Compound (IV), at least three R₂ are H.

A108. The ion-exchange polymer according to any one of A71-A107, wherein in Compound (I), Compound (II), or Compound (IV), all R₂ are H.

A109. The ion-exchange polymer according to any one of A71-A104, wherein in Compound (I), Compound (II), or Compound (IV), at least one R₂ is C₁alkyl.

A110. The ion-exchange polymer according to any one of A71-A104 or A109, wherein in Compound (I), Compound (II), or Compound (IV), at least two R₂ are C₁alkyl.

A111. The ion-exchange polymer according to any one of A71-A104, A109, or A110, wherein in Compound (I), Compound (II), or Compound (IV), at least three R₂ are C₁alkyl.

A112. The ion-exchange polymer according to any one of A71-A104, or A109-A111 wherein in Compound (I), Compound (II), or Compound (IV), all R₂ are C₁alkyl.

A113. The ion-exchange polymer according to any one of A71-A104, wherein in Compound (I), Compound (II), or Compound (IV), at least one R₂ is phenyl.

A114. The ion-exchange polymer according to any one of A71-A104 or A113, wherein in Compound (I), Compound (II), or Compound (IV), at least two R₂ are phenyl.

A115. The ion-exchange polymer according to any one of A71-A104, A113, or A114, wherein in Compound (I), Compound (II), or Compound (IV), at least three R₂ are phenyl.

A116. The ion-exchange polymer according to any one of A71-A104, or A113-A115 wherein in Compound (I), Compound (II), or Compound (IV), all R₂ are phenyl.

A117. The ion-exchange polymer according to any one of A71-A116, wherein in Compound (I), Compound (II), Compounds (III), or Compound (IV), at least one R₃ is H.

A118. The ion-exchange polymer according to any one of A71-A117, wherein in Compound (I), Compound (II), Compounds (III), or Compound (IV), at least two R₃ are H.

A119. The ion-exchange polymer according to any one of A71-A118, wherein in Compound (I), Compound (II), Compounds (III), or Compound (IV), all R₃ are H.

A120. The ion-exchange polymer according to any one of A71-A116, wherein in Compound (I), Compound (II), Compounds (III), or Compound (IV), at least one R₃ is OH.

A121. The ion-exchange polymer according to any one of A71-A116 or A120, wherein in Compound (I), Compound (II), Compounds (III), or Compound (IV), at least two R₃ are OH.

A122. The ion-exchange polymer according to any one of A71-A121, wherein in Compound (III), at least one R₄ is C₁alkyl.

A123. The ion-exchange polymer according to any one of A71-A122, wherein in Compound (III), at least two R₄ are C₁alkyl.

A124. The ion-exchange polymer according to any one of A71-A123, wherein in Compound (III), at least three R₄ are C₁alkyl.

A125. The ion-exchange polymer according to any one of A71-A124, wherein in Compound (III), all R₄ are C₁alkyl.

A126. The ion-exchange polymer according to any one of A71-A125, wherein Compound (I), Compound (II), Compound (III), or Compound (IV) is symmetrical.

A127. The ion-exchange polymer according to any one of A71-A126, wherein monomers are selected from one or more of the group of:

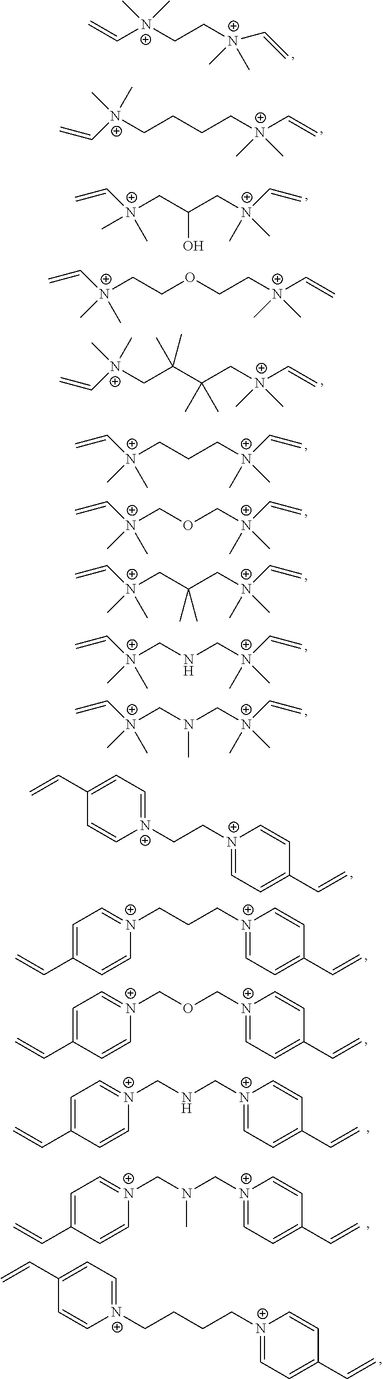

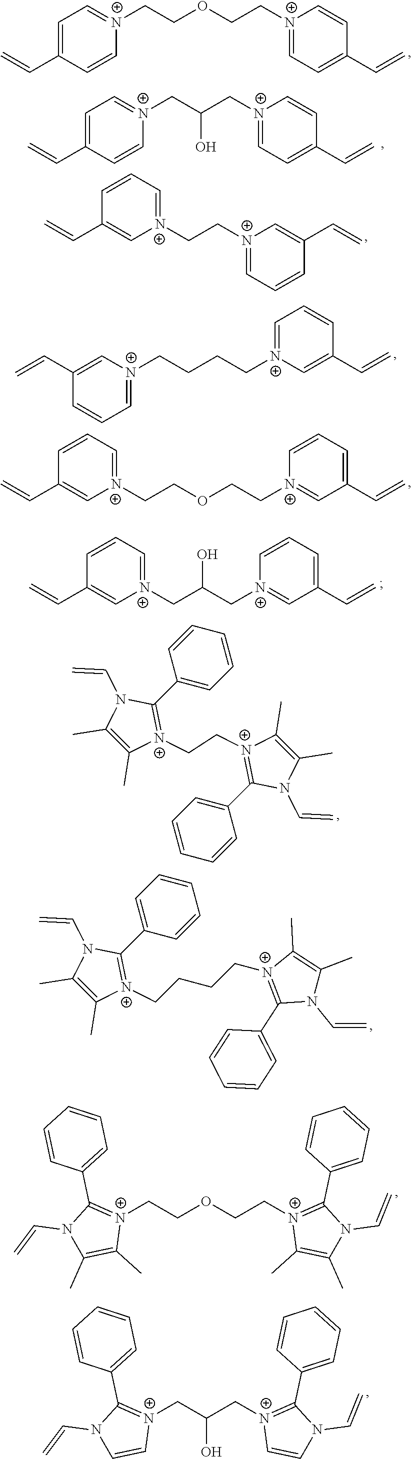

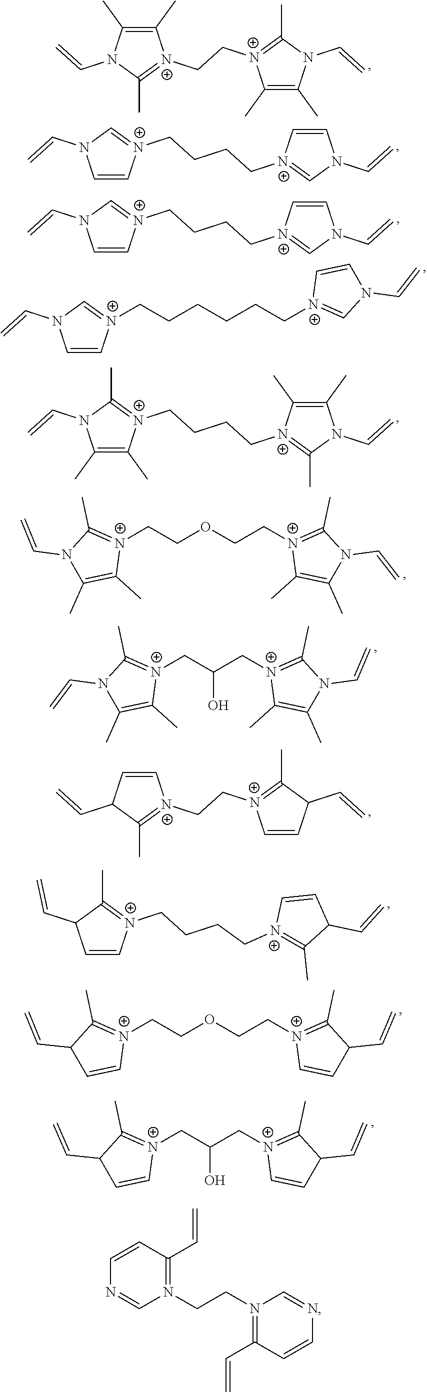

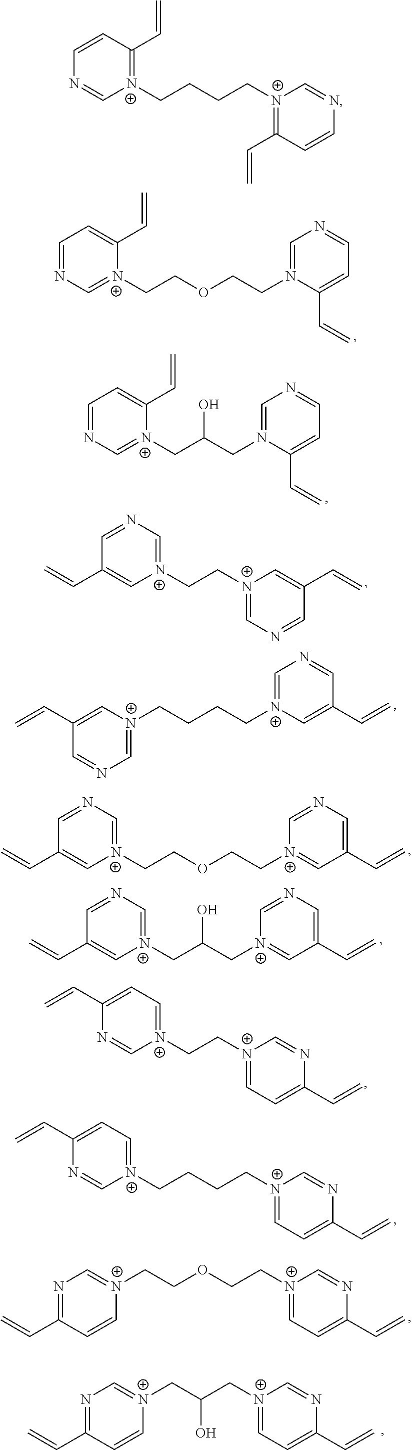

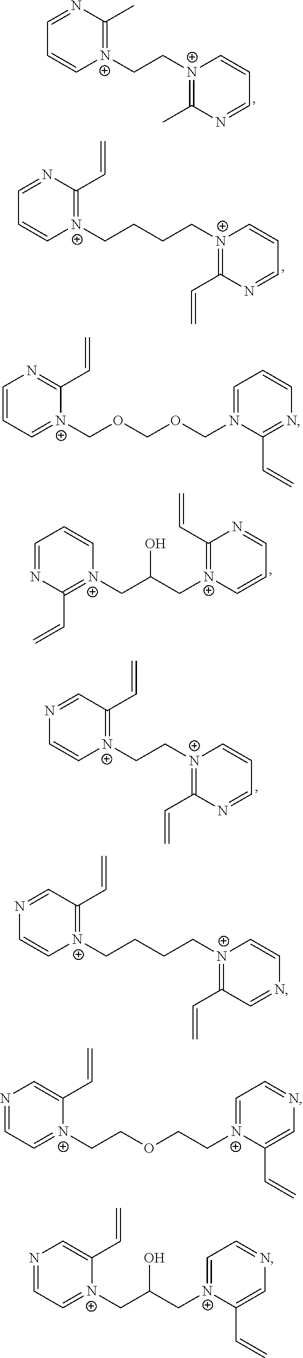

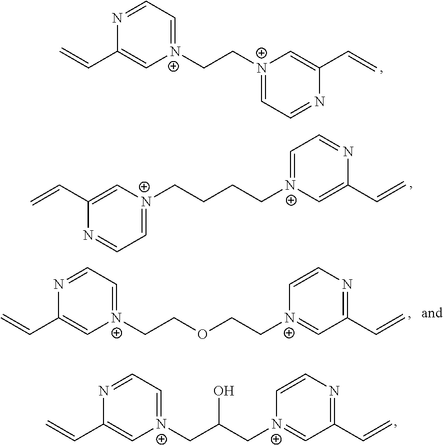

wherein the monomers further include counteranions such that the monomers have electroneutrality.

A128. The ion-exchange polymer according to any one of A1-A127, wherein the ion-exchange polymer has a charge density of at least 3 mol/L of hydrated polymer, at least about 3.5 mol/L of hydrated polymer, at least about 4 mol/L of hydrated polymer, at least about 4.5 mol/L of hydrated polymer, or at least about 5 mol/L of hydrated polymer.

A129. The ion-exchange polymer according to any one of A1-A128, wherein the ion-exchange polymer has a charge density in a range of about 3 to about 10 mol/L hydrated polymer at a water volume fraction of 40% or more, about 3.5 to about 9 mol/L hydrated polymer, about 4 to about 8 mol/L hydrated polymer, about 4.5 to about 7 mol/L hydrated polymer, or about 5 to about 6 mol/L hydrated polymer.

A130. The ion-exchange polymer according to any one of A1-A129, wherein the ion-exchange polymer has a selectivity of at least about 30 for solutions of 1 molal NaCl (1 mol/kg water), at least about 80, or at least about 200 and a 1 molal NaCl throughput of at least 4×10⁻⁹ mol/cm/s, at least 5×10⁻⁹ mol/cm/s, at least 6×10⁻⁹ mol/cm/s, or at least 6.5×10⁻⁹ mol/cm/s.

A131. The ion-exchange polymer according to any one of A1-A130, wherein the ion-exchange polymer has a 1 molal NaCl selectivity in a range of about 30 to about 1500, about 50 to about 1400, about 100 to about 1300, about 200 to about 1250, about 500 to about 1200, at least about 500, or at least about 800.

A132. The ion-exchange polymer according to any one of A1-A131, wherein the ion-exchange polymer has a salt permeability in a range of about 5×10⁻¹⁰ to about 5×10⁻⁷ cm²/s, about 1×10⁻⁹ to about 5×10⁻⁷ cm²/s, or about 3×10⁻⁹ to about 5×10⁻⁷ cm²/s for a 1 molal NaCl solution at 22±1° C.

A133. The ion-exchange polymer according to any one of A1-A132, wherein the ion-exchange polymer has a chloride ion conductivity at 22±1° C. in a range of about 10 to about 70 mS/cm or about 15 to about 70 mS/cm.

A134. A method of preparing an ion-exchange polymer, the method comprising:
a) admixing a polymerization initiator; and a monomer solution consisting of an optional solvent and a plurality of monomers selected from the group of monomers according to Compound (I), Compound (II), Compound (III), Compound (IV), and a combination thereof:

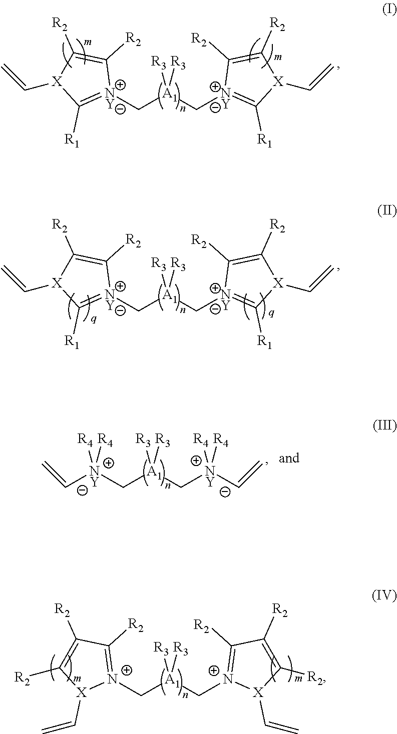

wherein each x is independently selected from C(H) and N; each A₁ is independently selected from C, N, and O, wherein when two adjacent A₁ are N, then one R₃ on at least one N is absent; n is 0, 1, 2, 3, 4, or 5; each m is independently 1 or 2; each q is independently 1 or 2; each R₁ is independently selected from H, OH, C₁-C₆alkyl, O—C₁-C₆alkyl, C₅-C₆cycloalkyl, and substituted or unsubstituted phenyl; each R₂ is independently selected from H, OH, C₁-C₆alkyl, O—C₁-C₆alkyl, C₅-C₆cycloalkyl, and substituted or unsubstituted phenyl; each R₃ is independently absent, H, OH, C₁-C₆alkyl, O—C₁-C₆alkyl, C₅-C₆cycloalkyl, or substituted or unsubstituted phenyl; and each R₄ is independently selected from C₁-C₆alkyl, C₅-C₆cycloalkyl, and substituted or unsubstituted phenyl; and each Y is independently an inorganic anion or an organic anion; and b) polymerizing the monomer solution to form the ion-exchange polymer.

A135. The method according to A134, wherein the polymerization initiator comprises a thermal initiator or a UV initiator.

A136. The method according to any one of A134 or A135, wherein the monomer solution is a saturated monomer solution.

A137 The method according to any one of A134-A136, wherein the monomer solution comprises about 50 wt. % to about 100 wt. % monomers, about 60 wt. % to about 95 wt. %, or about 70 wt. % to about 90 wt. %, based on the total weight of the monomer solution.

A138. The method according to any one of A134-A137, wherein the monomer solution does not include a solvent.

A139. The method according to any one of A134-A137, wherein the monomer solution comprises a polar solvent.

A140. The method according to A139, wherein the polar solvent comprises water, DMSO, NMP, methanol, ethanol, 1-propanol, acetonitrile, formamide, dimethylformamide, acetone, or a combination thereof.

A141. The method according to any one of A134-A140, wherein the polymerizing comprises exposing the monomer solution to conditions sufficient to initiate polymerization.

A142. The method according to A141, wherein the conditions sufficient to initiate polymerization comprise heating the monomer solution, applying a UV light, or a combination thereof.

A143. The method according to A142, wherein the monomer solution is heated at a temperature less than the boiling point of the solvent for a time in a range of about 30 seconds to about 48 hours, for example, about 40 minutes.

A144. The method according to A143, wherein the temperature less than the boiling point of the solvent is a temperature in a range of about 50° C. to about 98° C., or about 85° C.

A145. The method according to A142, wherein the UV light is applied for a time in a range of about 30 seconds to about 48 hours, for example, about 40 minutes.

A146. The method according to A142 or A145, wherein the UV light has a wavelength in a range of 100 to 400 nm, 100-280 nm, 280-315 nm, 315-400 nm, or about 365 nm.

A147. The method according to any one of A₁₃₄-A₁₄₆, further comprising casting the monomer solution on a substrate prior to polymerizing the monomer solution.

### EXAMPLES

### Monomer Synthesis

### Example 1—Dibromobutane Monomer—C₄VI₂

In a reaction vessel, 1,4-dibromobutane (15 mL) was reacted with 1-vinylimidazole (25 mL) and 4-methoxyphenol (1.5 g) in 210 mL of acetonitrile. The mixture was stirred and heated to 60° C. for 3 days. The solvent was removed via rotary evaporation, the residual solids were washed with diethyl ether (˜300 mL), and the product was dried to form a solid (C4VI2).

### Example 2—Dibromoethane Monomer—C₂VI₂

In a reaction vessel, 1,2-dibromoethane (10.8 mL) was reacted with 1-vinylimidazole (45.2 mL) and 4-methoxyphenol (1.5 g) in 190 mL of acetonitrile. The mixture was stirred and heated to 60° C. for 3 days. The solvent was removed via rotary evaporation, the residual solids were washed with diethyl ether (˜300 mL), and the product was dried to form a solid (C₂VI2).

### Membrane Synthesis

### Example 3—Thermal Polymerization—C₄VI₂ Thermal

In a 20 mL vial equipped with a stir bar, 1.4 g water and C₄VI2 monomer (4 g, 2% wt water), as prepared in Example 1 were added, forming a 27% wt water solution. This solution was stirred for approximately 15 min at 45° C. To this mixture, 2,2′-Azobis (2-methylpropionamidine) dihydrochloride (V-50) thermal initiator (40 mg), was added and dissolved at 45° C. The solution was attached to a Schlenk line and degassed under high vacuum while stirring for ˜10 minutes. This mixture was stirred at 45° C. for 5 minutes, and cast between two silanized glass plates separated by 330 μm metal spacers. The cast solution and plates were then placed in a convection oven at 85° C., heating the solution for a total of 40 min. The plates were then removed from the oven and quenched into a bath of DI water. While submerged, the plates were then separated, and the membrane was collected into a smaller container of DI water, where the solution was changed periodically for 24 hours to remove any unreacted monomer.

### Example 4—UV Polymerization—C₃VI₂ UV

In a 20 mL vial equipped with a stir bar, 0.82 g water and C₃VI2 monomer (4 g, 2 wt % water) as prepared in Example 2 were added, forming a 19 wt % water solution. This solution was stirred for approximately 15 min at 45° C. to achieve a homogeneous, saturated solution. To this mixture, 1-hydroxycyclohexyl phenyl ketone (HCPK) photo initiator (12 mg) was added and dissolved at 45° C. This mixture was cast between two quartz plates separated by 300 μm metal spacers. The cast solution and plates were then placed in a UV oven with 365 nm bulbs, exposing the solution for a total of 40 min. The plates were then separated, the membrane was placed into DI water, and the solution was changed periodically for 24 hours to remove any unreacted monomer.

### Membrane Characterization

### Example 5—Characterization

Membranes were prepared in accordance with the methods of Example 3 and Example 4 with various monomers and water mass fractions according to Table 1, below. The prepared membranes and some exemplary commercial membranes were tested for water volume fraction, charge density, chloride ion conductivity, salt permeability, throughput and selectivity and the results are provided in Table 2, below. All tests were conducted with a 1 molal NaCl solution at 22±1° C., unless described otherwise.

TABLE 1

| | | Monomer | |
|---|---|---|---|
| | | Solution Water | |
| Membrane | | Mass Fraction | Polymerization |
| # | Monomer | (%) | method |
| 1 (C₂Vl₂) | 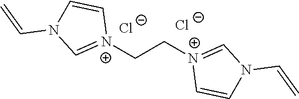 [SMILES: C=Cn1cc[n+](CC[n+]2ccn(C=C)c2)c1 ; [Cl-] ; [Cl-]] | 47 | Photopolymer |
| 2 (C₃Vl₂) | 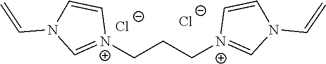 [SMILES: C=Cn1cc[n+](CCC[n+]2ccn(C=C)c2)c1 ; [Cl-] ; [Cl-]] | 19 | Photopolymer |
| 3 (C₄Vl₂) | 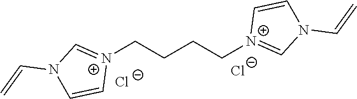 [SMILES: C=Cn1cc[n+](CCCC[n+]2ccn(C=C)c2)c1 ; [Cl-] ; [Cl-]] | 27 | Photopolymer |
| 4 (C₅Vl₂) | 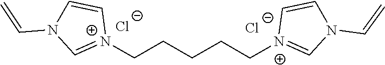 [SMILES: C=Cn1cc[n+](CCCCC[n+]2ccn(C=C)c2)c1 ; [Cl-] ; [Cl-]] | 15 | Photopolymer |
| 5 (C₆Vl₂) | 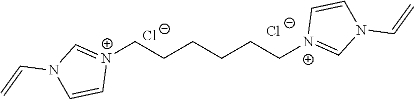 [SMILES: C=Cn1cc[n+](CCCCCC[n+]2ccn(C=C)c2)c1 ; [Cl-] ; [Cl-]] | 21 | Photopolymer |
| 10 (C₇Vl₂) | 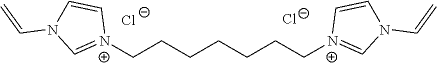 [SMILES: C=Cn1cc[n+](CCCCCCC[n+]2ccn(C=C)c2)c1 ; [Cl-] ; [Cl-]] | 16 | Photopolymer |
| 6 (C₄Vl₂) | 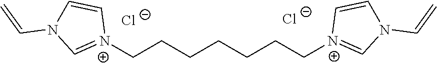 [SMILES: C=Cn1cc[n+](CCCCCCC[n+]2ccn(C=C)c2)c1 ; [Cl-] ; [Cl-]] | 27 | Thermal |
| 7(C₄Vl₂) | 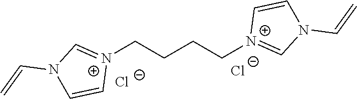 [SMILES: C=Cn1cc[n+](CCCC[n+]2ccn(C=C)c2)c1 ; [Cl-] ; [Cl-]] | 33 | Thermal |
| 8 (C₄Vl₂) | 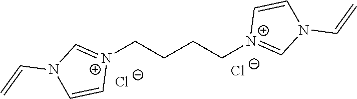 [SMILES: C=Cn1cc[n+](CCCC[n+]2ccn(C=C)c2)c1 ; [Cl-] ; [Cl-]] | 40 | Thermal |
| 9 (C₄Vl₂) | 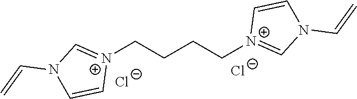 [SMILES: C=Cn1cc[n+](CCCC[n+]2ccn(C=C)c2)c1 ; [Cl-] ; [Cl-]] | 50 | Thermal |
| 11 (C₄Vl₂) | 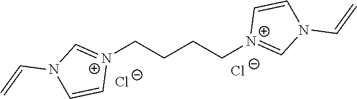 [SMILES: C=Cn1cc[n+](CCCC[n+]2ccn(C=C)c2)c1 ; [Cl-] ; [Cl-]] | 62.5 | Thermal |
| 12 (C₄Vl₂) | 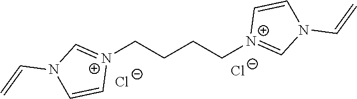 [SMILES: C=Cn1cc[n+](CCCC[n+]2ccn(C=C)c2)c1 ; [Cl-] ; [Cl-]] | 65 | Thermal |
| 13 (C₄Vl₂) | 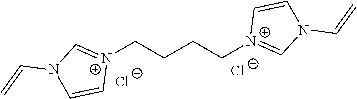 [SMILES: C=Cn1cc[n+](CCCC[n+]2ccn(C=C)c2)c1 ; [Cl-] ; [Cl-]] | 70 | Thermal |
| 14 (C₄Vl₂) | 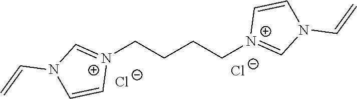 [SMILES: C=Cn1cc[n+](CCCC[n+]2ccn(C=C)c2)c1 ; [Cl-] ; [Cl-]] | 75 | Thermal |

TABLE 2

| | | | Cl⁻ | Ionic | Salt | | |
|---|---|---|---|---|---|---|---|
| | Water | Charge | Conductivity | Conductivity | Permeability | Throughput | Selectivity |
| | Volume | Density | DI Water | 1m NaCl | 1m NaCl | 1m NaCl | 1m NaCl |
| Membrane | Fraction | (M) | (mS/cm) | (mS/cm) | (cm²/s) | (mol/cm/s) | (g/c) |
| 1 | 0.596 | 3.635 | 30.50 | 51.95 | 2.42e−7 | 8.88e−9 | 38.29 |
| 2 | 0.412 | 5.257 | 20.17 | 23.06 | 6.24 × 10⁻⁰⁹ | 6.07 × 10⁻⁰⁹ | 998.89 |
| 3 | 0.440 | 4.970 | 20.41 | 22.01 | 7.31 × 10⁻⁰⁹ | 5.79 × 10⁻⁰⁹ | 813.63 |
| 4 | 0.409 | 4.367 | 16.43 | 18.15 | 3.54 × 10⁻⁰⁹ | 4.78 × 10⁻⁰⁹ | 1383.10 |
| 5 | 0.411 | 4.245 | 15.86 | 17.19 | 5.45 × 10⁻⁰⁹ | 4.53 × 10⁻⁰⁹ | 851.62 |
| 10 | 0.425 | 4.017 | 17.22 | 15.30 | 5.56e−9 | 4.03e−9 | 742.6 |
| 6 | 0.438 | 4.907 | 20.75 | 25.55 | 5.89 × 10⁻⁰⁹ | 6.73 × 10⁻⁰⁹ | 1173.13 |
| 7 | 0.503 | 4.144 | 29.91 | 38.42 | 4.27 × 10⁻⁰⁸ | 1.01 × 10⁻⁰⁸ | 246.06 |
| 8 | 0.574 | 3.849 | 28.62 | 37.98 | 1.23 × 10⁻⁰⁷ | 9.90 × 10⁻⁰⁹ | 85.71 |
| 9 | 0.637 | 2.971 | 27.79 | 54.25 | 4.48 × 10⁻⁰⁷ | 1.39 × 10⁻⁰⁸ | 33.84 |
| 11 | 0.721 | 2.085 | 22.22 | 65.09 | 1.62e−6 | 1.57e−8 | 10.88 |
| 12 | 0.761 | 1.969 | 19.56 | 62.76 | 1.85e−6 | 1.49e−8 | 9.038 |
| 13 | 0.803 | 1.771 | 16.00 | 71.39 | 2.45e−6 | 1.67e−8 | 7.899 |
| 14 | 0.848 | 1.400 | 14.66 | 86.5 | 2.92e−6 | 2.04e−8 | 8.531 |

The data from Table 2 is provided in graphical form in FIG. 1, FIG. 2, and FIG. 3, along with the data for commercially available membranes tested in the same way as the membranes of the disclosure. Data were collected for membranes equilibrated with DI water and in FIG. 1, points in black (squares, triangles, open circles) represent membranes in the Na⁺ or Cl⁻ form, while points in gray represent membranes in a variety of counter-ion forms including mostly H⁺, Na⁺, OH⁻, and Cl⁻. FIG. 1 is a plot of charge density (mol/L membrane) versus water volume fraction in the membrane for ion-exchange polymers of the disclosure (including membranes 1-5 and 10 identified as “UV-Var. Monomer” and membranes 6-9 and 11-14 identified as “Thermal—Var. Conc.”) and prior art membranes. The data points in FIG. 1 identified as “literature” represent data surveyed from the literature. Black circles represent data measured for commercialized ion exchange membranes. FIG. 2 is a plot of selectivity versus throughput (mol/cm/s) for ion-exchange polymers of the disclosure (including membranes 1-5 and 10 identified as “UV-Var. Monomer” and membranes 6-9 and 11-14 identified as “Thermal—Var. Conc.”) and commercially available prior art membranes. FIG. 3 is a plot of counter-ion conductivity plotted against water volume fraction for membranes in the Cl⁻ form contacting DI water. Gray circles represent data surveyed from the literature. Black squares and triangles represent membranes of the disclosure (including membranes 1-5 and 10 identified as “UV-Var. Monomer” and membranes 6-9 and 11-14 identified as ‘Thermal—Var. Conc.”).

As can be seen from FIGS. 1, 2, and 3, the membranes of the disclosure demonstrated comparable if not significantly greater charge densities than the largest charge densities for commercially available membranes, higher fixed charge densities than other membranes for a given water volume fraction, significantly higher charge densities at greater water volume fractions than commercially available membranes. The combination of large charge densities at high water contents is advantageous and directly results in high selectivity and throughput. The membranes of the disclosure also achieved a given counter-ion/co-ion selectivity at a high throughput than current membranes (and vice versa), and are amongst the most conductive membranes reporting Cl⁻ conductivities. Thus, membranes of the disclosure are well suited for applications that require counter-ion/co-ion selectivity such as electrodialysis, bipolar membrane electrodialysis, membrane capacitive deionization, and vanadium redox flow batteries. Further, as can be seen from FIG. 2, the membranes of the disclosure can be tuned to provide higher selectivity than commercially available membranes. Advantageously, the membranes of the disclosure can provide a combination of higher selectivity in combination with higher throughput than commercially available membranes. Such a combination of features advantageously provide membranes which require less energy to perform the ion-exchange process due to the higher throughput as well as increased efficiency of the system due to the higher selectivity.

Further, the data from Table 2 demonstrates that, in general, when polymers are prepared from saturated monomer solutions, as the length of the monomer increases, the charge density of the resulting polymer increases (compare membranes 2-5). Further, the data from Table 2 demonstrates that, in general, for a given monomer, as the water mass fraction of the monomer solution increases, the charge density decreases and the selectivity decreases (compare membranes 6-9). Further still, the data from Table 2 demonstrates that the selectivity is effected by the polymerization method (compare membranes 3 and 6).

Thus, Example 5 demonstrates that the ion-exchange polymers of the disclosure generally outperform commercially available ion-exchange membranes. Further, the monomers, water mass fraction of the monomer solution, and polymerization method can each be selected to tune the ion-exchange polymers of the disclosure to have performance properties suitable for a chosen application.

### Example 6—Characterization

Membranes were prepared in accordance with the methods of Example 3 and Example 4 with monomer 3 (C₄VI₂) as shown in Table 1 and a monofunctional unit, EtVI:

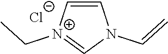

with various water contents and mass fractions of monomer 3 according to Table 3, below. Because a pair of monofunctional EtVI and a single C₄VI₂ monomer have essentially the same molecular structure:

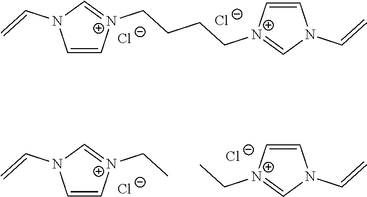

the mass-solubility of their mixtures remains constant. The prepared membranes and some exemplary commercial membranes were tested for water volume fraction, charge density, chloride ion conductivity, salt permeability, throughput and selectivity and the results are provided in Tables 4, below. All tests were conducted with a 1 molal NaCl solution at 22±1° C., unless described otherwise.

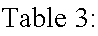

| | Monomer | Monomer | |
|---|---|---|---|
| | Cross-linker | Solution | |
| | Mass | Water Mass | Polymerization |
| Membrane # | Fraction (%) | Fraction (%) | Method |
| 15 (C₄Vl₂-co-EtVl) | 75 | 26 | Photo |
| 16 (C₄Vl₂-co-EtVl) | 50 | 26 | Photo |
| 17 (C₄Vl₂-co-EtVl) | 25 | 26 | Photo |
| 18 (C₄Vl₂-co-EtVl) | 20 | 26 | Photo |
| 19 (C₄Vl₂-co-EtVl) | 15 | 26 | Photo |
| 20 (C₄Vl₂-co-EtVl) | 10 | 26 | Photo |
| 21 (C₄Vl₂-co-EtVl) | 5 | 26 | Photo |
| 22 (C₄Vl₂-co-EtVl) | 75 | 26 | Thermal |
| 23 (C₄Vl₂-co-EtVl) | 50 | 26 | Thermal |
| 24 (C₄Vl₂-co-EtVl) | 25 | 26 | Thermal |
| 25 (C₄Vl₂-co-EtVl) | 20 | 26 | Thermal |
| 26 (C₄Vl₂-co-EtVl) | 15 | 26 | Thermal |
| 27 (C₄Vl₂-co-EtVl) | 10 | 26 | Thermal |
| 28 (C₄Vl₂-co-EtVl) | 5 | 26 | Thermal |
| 29 (C₄Vl₂-co-EtVl) | 75 | 40 | Thermal |
| 30 (C₄Vl₂-co-EtVl) | 75 | 65 | Thermal |
| 31 (C₄Vl₂-co-EtVl) | 75 | 73 | Thermal |
| 32 (C₄Vl₂-co-EtVl) | 50 | 40 | Thermal |
| 33 (C₄Vl₂-co-EtVl) | 50 | 61 | Thermal |
| 34 (C₄Vl₂-co-EtVl) | 50 | 69 | Thermal |
| 35 (C₄Vl₂-co-EtVl) | 25 | 40 | Thermal |
| 36 (C₄Vl₂-co-EtVl) | 25 | 58 | Thermal |
| 37 (C₄Vl₂-co-EtVl) | 25 | 69 | Thermal |

TABLE 4

| | | | Cl⁻ | Ionic | Salt | | |
|---|---|---|---|---|---|---|---|
| | Water | Charge | Conductivity, | Conductivity, | Permeability, | Throughput, | Selectivity, |
| | Volume | Density | DI Water | 1m NaCl | 1m NaCl | 1m NaCl | 1m NaCl |
| Membrane | Fraction | (M) | (mS/cm) | (mS/cm) | (cm²/s) | (mol/cm/s) | (g/c) |
| 15 | 0.440 | 3.999 | 24.41 | N/A* | N/A | N/A | N/A |
| 16 | 0.469 | 3.834 | 24.39 | 27.53 | 2.10e−8 | 7.24e−9 | 356.1 |
| 17 | 0.551 | 3.460 | 36.61 | 36.19 | 1.16e−7 | 9.43e−9 | 84.19 |
| 18 | 0.593 | 3.062 | 41.28 | 39.63 | 1.80e−7 | 1.03e−8 | 59.73 |
| 19 | 0.652 | 2.663 | 44.77 | 44.1 | 3.57e−7 | 1.13e−8 | 33.17 |
| 20 | 0.679 | 2.083 | 41.67 | 51.55 | 7.10e−7 | 1.29e−8 | 19.36 |
| 21 | 0.810 | 1.470 | 38.35 | 61.42 | 2.16e−6 | 1.41e−8 | 6.842 |
| 22 | 0.447 | 4.793 | 23.76 | N/A | N/A | N/A | N/A |
| 23 | 0.477 | 4.341 | 28.83 | N/A | N/A | N/A | N/A |
| 24 | 0.582 | 3.658 | 42.27 | N/A | N/A | N/A | N/A |
| 25 | 0.611 | 3.069 | 42.12 | N/A | N/A | N/A | N/A |
| 26 | 0.660 | 2.578 | 44.25 | N/A | N/A | N/A | N/A |
| 27 | 0.732 | 2.101 | 45.07 | N/A | N/A | N/A | N/A |
| 28 | 0.860 | 1.436 | 36.43 | N/A | N/A | N/A | N/A |
| 29 | 0.564 | 3.642 | 29.42 | N/A | N/A | N/A | N/A |
| 30 | 0.756 | 1.812 | 17.88 | N/A | N/A | N/A | N/A |
| 31 | 0.871 | 1.312 | 14.56 | N/A | N/A | N/A | N/A |
| 32 | 0.594 | 3.601 | 34.24 | N/A | N/A | N/A | N/A |
| 33 | 0.755 | 2.04 | 26.19 | N/A | N/A | N/A | N/A |
| 34 | 0.833 | 1.489 | 20.53 | N/A | N/A | N/A | N/A |
| 35 | 0.663 | 2.796 | 48.56 | N/A | N/A | N/A | N/A |
| 36 | 0.737 | 1.848 | 35.84 | N/A | N/A | N/A | N/A |
| 37 | 0.883 | 1.115 | 26.13 | N/A | N/A | N/A | N/A |

*N/A indicates data was not collected.

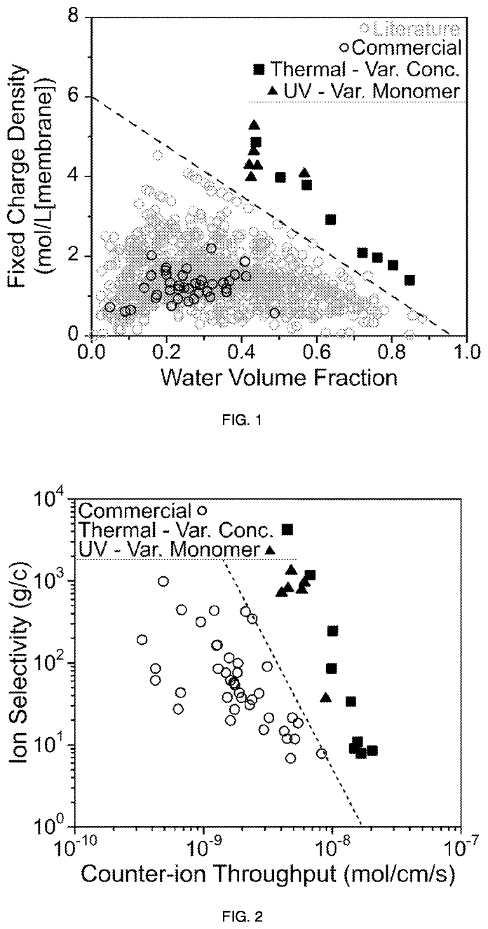

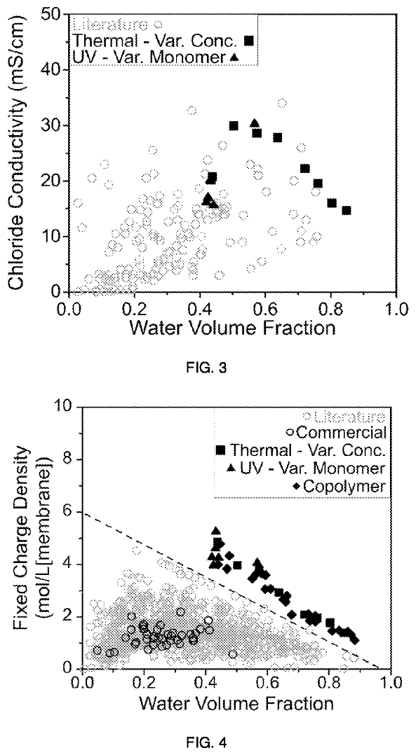

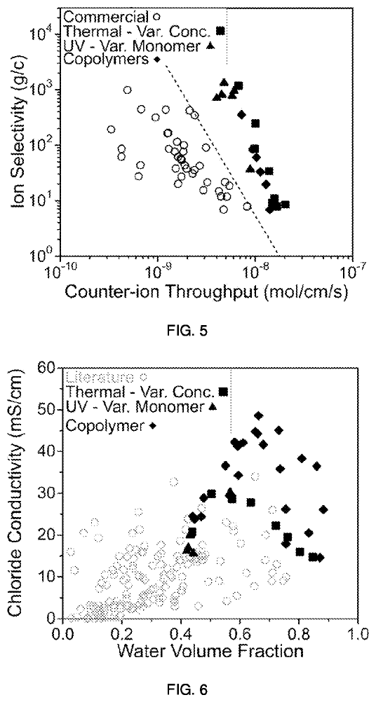

The data from Table 4 is provided in graphical form in FIG. 4, FIG. 5, and FIG. 6, along with the data for commercially available membranes tested in the same way as the membranes of the disclosure. Data were collected for membranes equilibrated with DI water and in FIG. 4, points in black (squares, triangles, open circles) represent membranes in the Na⁺ or Cl⁻ form, while points in gray represent membranes in a variety of counter-ion forms including mostly H⁺, Na⁺, OH⁻, and Cl⁻. FIG. 4 is a plot of fixed charge density (mol/L membrane) versus water volume fraction in the membrane for ion-exchange polymers of the disclosure (including membranes 1-5 and 10 identified as “UV-Var. Monomer,” membranes 6-9 and 11-14 identified as “Thermal—Var. Conc.,” and membranes 15-37, identified as “Copoly.”) and prior art membranes. The data points in FIG. 4 identified as “literature” represent data surveyed from the literature. Black circles represent data measured for commercialized ion exchange membranes. FIG. 5 is a plot of selectivity versus throughput (mol/cm/s) for ion-exchange polymers of the disclosure (including membranes 1-5 and 10 identified as “UV-Var. Monomer,” membranes 6-9 and 11-14 identified as “Thermal—Var. Conc.,” and membranes 15-37 identified as “Copoly”) and commercially available prior art membranes. The data points in FIG. 5 identified as “commercial” represent commercially available prior art membranes. FIG. 6 is a plot of counter-ion conductivity plotted against water volume fraction for membranes in the Cl⁻ form contacting DI water. Gray circles represent data surveyed from the literature. Black squares and triangles represent membranes of the disclosure (including membranes 1-5 and 10 identified as “UV-Var. Monomer,” membranes 6-9 and 11-14 identified as ‘Thermal—Var. Conc.,” and membranes 15-37 identified as “Copoly”).

As can be seen from FIGS. 4, 5, and 6, the membranes of the disclosure demonstrated comparable if not significantly greater charge densities than the largest charge densities for commercially available membranes, higher fixed charge densities than other membranes for a given water volume fraction, significantly higher charge densities at greater water volume fractions than commercially available membranes. The combination of large charge densities at high water contents is advantageous and directly results in high selectivity and throughput. The membranes of the disclosure also achieved a given counter-ion/co-ion selectivity at a high throughput than current membranes (and vice versa), and are amongst the most conductive membranes reporting Cl⁻ conductivities. Thus, membranes of the disclosure are well suited for applications that require counter-ion/co-ion selectivity such as electrodialysis, bipolar membrane electrodialysis, membrane capacitive deionization, and vanadium redox flow batteries. Further, as can be seen from FIG. 5, the membranes of the disclosure can be tuned to provide higher selectivity than commercially available membranes. Advantageously, the membranes of the disclosure can provide a combination of higher selectivity in combination with higher throughput than commercially available membranes. Such a combination of features advantageously provide membranes which require less energy to perform the ion-exchange process due to the higher throughput as well as increased efficiency of the system due to the higher selectivity.

Further, as shown in FIG. 6, for applications using low concentrations of ions in the solutions contacting the membrane, the conductivity of the copolymers outpaces that of the homopolymers. In contrast, for high concentration applications, requiring selectivity as shown in FIG. 5, the homopolymers remain dominant. Thus, the monomers for the membranes can be selected based on end use applications to provide superior conductivity or selectivity, relative to commercially available polymers.

Thus, Example 6 demonstrates that the ion-exchange polymers of the disclosure generally outperform commercially available ion-exchange membranes. Further, the monomers, water mass fraction of the monomer solution, and polymerization method can each be selected to tune the ion-exchange polymers of the disclosure to have performance properties suitable for a chosen application.

1. An ion exchange polymer, comprising the product of polymerizing a plurality of monomers, wherein the plurality of monomers comprises monomers of Compound (I), Compound (II), Compound (III), Compound (IV), Compound (V), Compound (VI), Compound (VII), Compound (VIII), or a combination thereof: 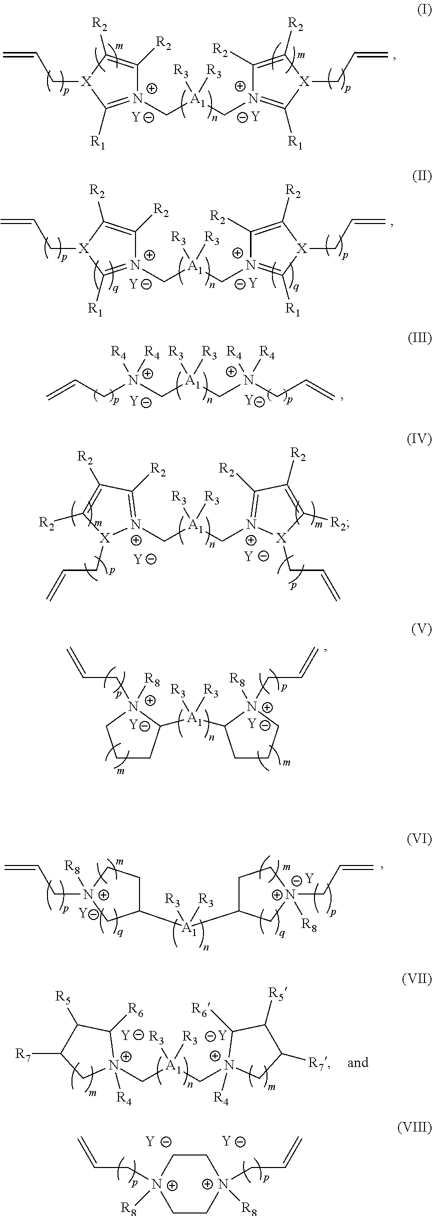
wherein
each X is independently selected from C(H) and N;
each A₁ is independently selected from C, N, and O, wherein when two adjacent A₁ are N, then one R₃ on at least one N is absent;
n is 0, 1, 2, 3, 4, or 5;
each m is independently 1 or 2;
each q is independently 1 or 2;
each p is 0 or 1;
each R₁ is independently selected from H, OH, C₁-C₆alkyl, O—C₁-C₆alkyl, C₅-C₆cycloalkyl, and substituted or unsubstituted phenyl;
each R₂ is independently selected from H, OH, C₁-C₆alkyl, O—C₁-C₆alkyl, C₅-C₆cycloalkyl, and substituted or unsubstituted phenyl;
each R₃ is independently absent, H, OH, C₁-C₆alkyl, O—C₁-C₆alkyl, C₅-C₆cycloalkyl, or substituted or unsubstituted phenyl;
each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl,
each of R₅, R₅′, R₅, R₅′, R₇, and R₇′ are selected from CH═CH₂, CH₂CH═CH₂ and H, wherein at least one of R₅, R₅, and R₇ is CH═CH₂ or CH₂CH═CH₂ and at least one of R₅′, R₅′, and R₇′ is CH═CH₂ or CH₂CH═CH₂;
each R₈ is independently selected from CH═CH₂, CH₂CH═CH₂, C₁-C₆alkyl, C₅-C₆cycloalkyl, and substituted or unsubstituted phenyl; and
each Y is independently an inorganic anion or an organic anion.

2. The ion-exchange polymer according to claim 1, wherein the plurality of monomers further comprises monomers of Compound (IX), Compound (X), Compound (XI), Compound (XII), Compound X (III), Compound (XIV), Compound (XV), Compound (XVI), or a combination thereof, 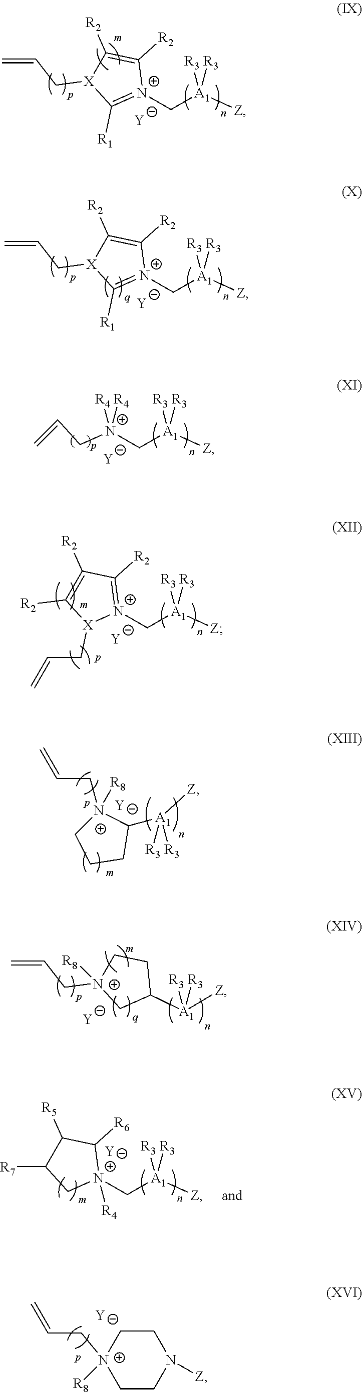
wherein
each X is independently selected from C(H) and N;
each A₁ is independently selected from C, N, and O, wherein when two adjacent A₁ are N, then one R₃ on at least one N is absent;
each n is independently 0, 1, 2, 3, 4, 5, 6, 7, 8, 9, or 10;
each m is independently 1 or 2;
each q is independently 1 or 2;
each p is 0 or 1;
each Y is independently an inorganic anion or an organic anion;
each R₁ is independently selected from H, OH, C₁-C₆alkyl, O—C₁-C₆alkyl, C₅-C₆cycloalkyl, and substituted or unsubstituted phenyl;
each R₂ is independently selected from H, OH, C₁-C₆alkyl, O—C₁-C₆alkyl, C₅-C₆cycloalkyl, and substituted or unsubstituted phenyl;
each R₃ is independently absent, H, OH, C₁-C₆alkyl, O—C₁-C₆alkyl, C₅-C₆cycloalkyl, or substituted or unsubstituted phenyl;
each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl,
each of R₅, R₅′, R₆, R₆′, R₇, and R₇′ are selected from CH═CH₂, CH₂CH═CH₂ and H, wherein at least one of R₅, R₆, and R₇ is CH═CH₂ or CH₂CH═CH₂ and at least one of R₅′, R₆′, and R₇′ is CH═CH₂ or CH₂CH═CH₂;
each R₈ is independently selected from CH═CH₂, CH₂CH═CH₂, C₁-C₆alkyl, C₅-C₆cycloalkyl, and substituted or unsubstituted phenyl; and
each Z is independently selected from H, OH, NH₂, C(O)OH, C₁-C₆alkyl, C₁-C₆alkyl-OH, C₁-C₆alkyl-C(O)OH, CH═CH₂, and CH₂CH═CH₂.

3. The ion-exchange polymer according to claim 1, wherein in Compound (I), Compound (II), Compound (IV), both X are N, or in Compound (IX), compound (X), or Compound (XII), X is N.

4. The ion-exchange polymer according to claim 1, wherein in Compound (I), Compound (II), Compound (III), Compound (IV), Compound (V), Compound (VI), Compound (VII), Compound (IX), Compound (X), Compound (XI), Compound (XII), Compound (XIII), Compound (XIV), or Compound (XV), n is 0, 1, 2, or 3.

5. The ion-exchange polymer according to claim 1, wherein in Compound (I), Compound (IV), Compound (V), Compound (VI), and Compound (VII), both m are 0 or both m are 1, or wherein in Compound (IX), Compound (XII), Compound (XIII), Compound (XIV), Compound (XV), m is 0 or 1.

6. The ion-exchange polymer according to claim 1, wherein in Compound (II) or Compound (VI), both q are 0, both q are 1, or both q are 2, or wherein in Compound (X) or Compound (XIV) q is 0, 1, or 2.

7. The ion-exchange polymer according to claim 1, wherein in Compound (I), Compound (II), Compound (III), Compound (IV), Compound (V), Compound (VI), Compound (VII), Compound (IX), Compound (X), Compound (XI), Compound (XII), Compound (XIII), Compound (XIV), or Compound (XV), at least one A₁ is C, at least one A₁ is O, or at least one A₁ is N.

8. The ion-exchange polymer according to claim 1, wherein in Compound (I), Compound (II), Compound (III), Compound (IV), Compound (V), Compound (VI), Compound (VII), Compound (VIII), Compound (V), Compound (VI), or Compound (VII), Compound (IX), Compound (X), Compound (XI), Compound (XII), Compound (XIII), Compound (XIV), or Compound (XV), at least one Y is an inorganic anion.

9. (canceled)

10. The ion-exchange polymer according to claim 1, wherein in Compound (I), Compound (II), Compound (III), Compound (IV), Compound (V), Compound (VI), Compound (VII), Compound (VIII), Compound (V), Compound (VI), or Compound (VII), Compound (IX), Compound (X), Compound (XI), Compound (XII), Compound (XIII), Compound (XIV), or Compound (XV), at least one Y is an organic anion.

11. (canceled)

12. The ion-exchange polymer according to claim 1, wherein in Compound (I) or Compound (II), both R₁ are H, both R₁ are C₁alkyl, or both R₁ are phenyl, or wherein in Compound (IX) or Compound (X), R₁ is H, C₁alkyl, or phenyl.

13. The ion-exchange polymer according to claim 1, wherein in Compound (I), Compound (II), Compound (IV), Compound (IX), Compound (X), or Compound (XII), at least one R₂ is H, C₁alkyl, or phenyl.

14. The ion-exchange polymer according to claim 1, wherein in Compound (I), Compound (II), Compounds (III), Compound (IV), Compound (V), Compound (VI), Compound (VII), Compound (V), Compound (VI), or Compound (VII), Compound (IX), Compound (X), Compound (XI), Compound (XII), Compound (XIII), Compound (XIV), or Compound (XV), all R₃ are H or at least one R₃ is OH.

15. The ion-exchange polymer according to claim 1, wherein in Compound (III), Compound (VII), Compound (XI), or Compound (XV), all R₄ are C₁alkyl.

16. The ion-exchange polymer according to claim 1, wherein in Compound (III) or Compound (XI), two geminal R₄ together with the N atom to which they are attached form a 5- or 6-member heterocycloalkyl.

17. The ion-exchange polymer according to claim 1, wherein in Compound (VIII), R₅ and R₅′, R₆ and R₆′, or R₇ and R₇′ are CH═CH₂, or R₅ and R₅′, R₆ and R₆′, or R₇ and R₇′ are CH₂CH═CH₂, or wherein in Compound (XV), R₅, R₆, or R₇ is CH═CH₂ or CH₂CH═CH₂.

18. The ion-exchange polymer according to claim 1, wherein in Compound (V), Compound (VII), Compound (VIII), Compound (XIII), Compound (XIV), or Compound (XVI), each R₈ is C₁alkyl or C₂alkyl.

19. (canceled)

20. The ion-exchange polymer according to claim 1, wherein the monomers comprise one or more of: 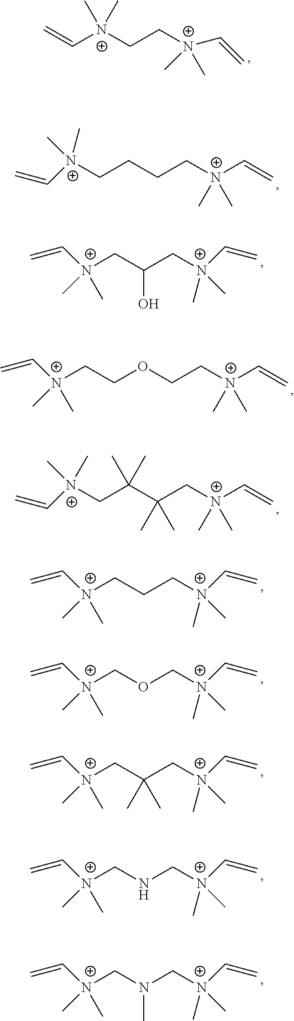 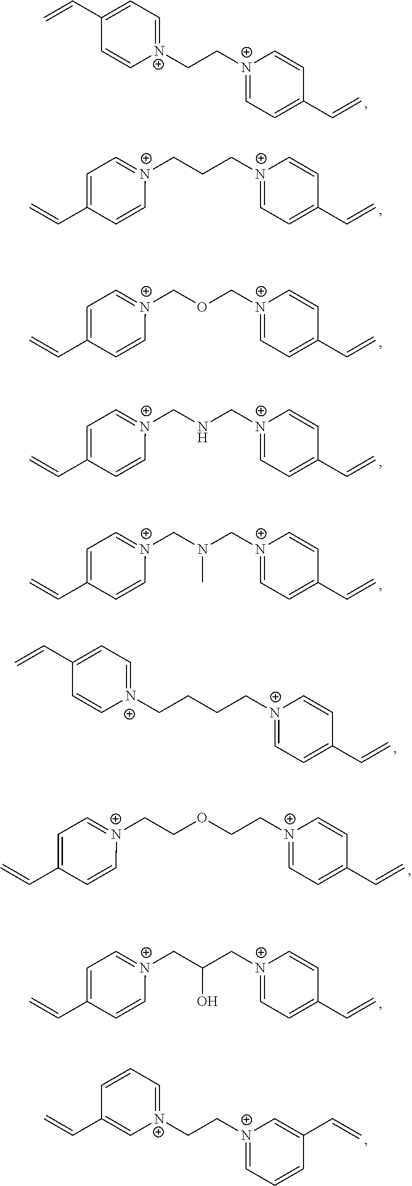 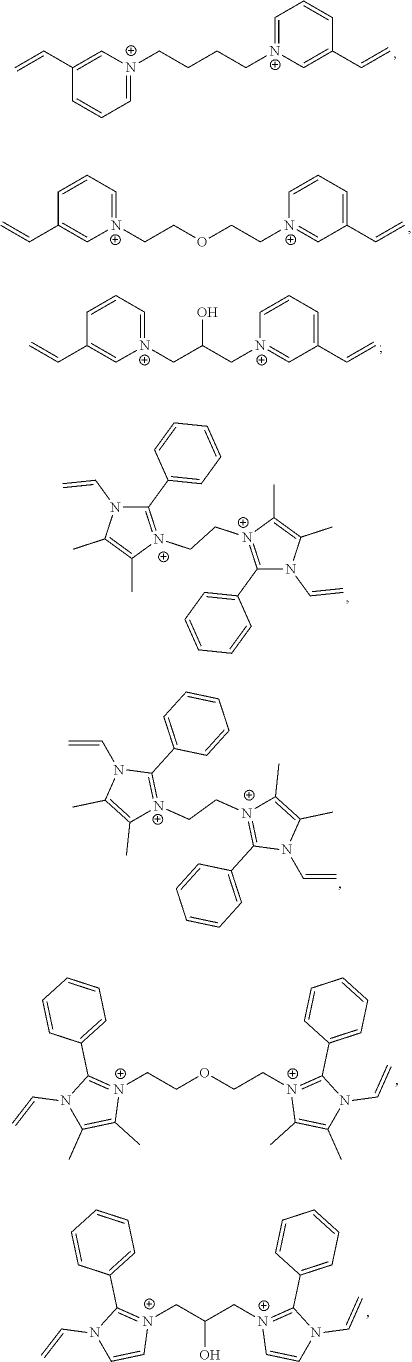 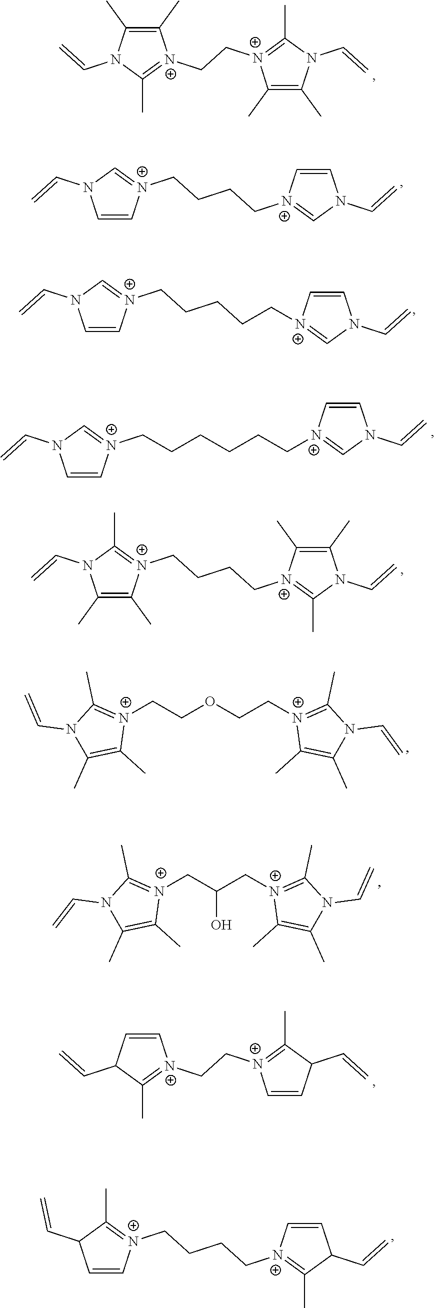 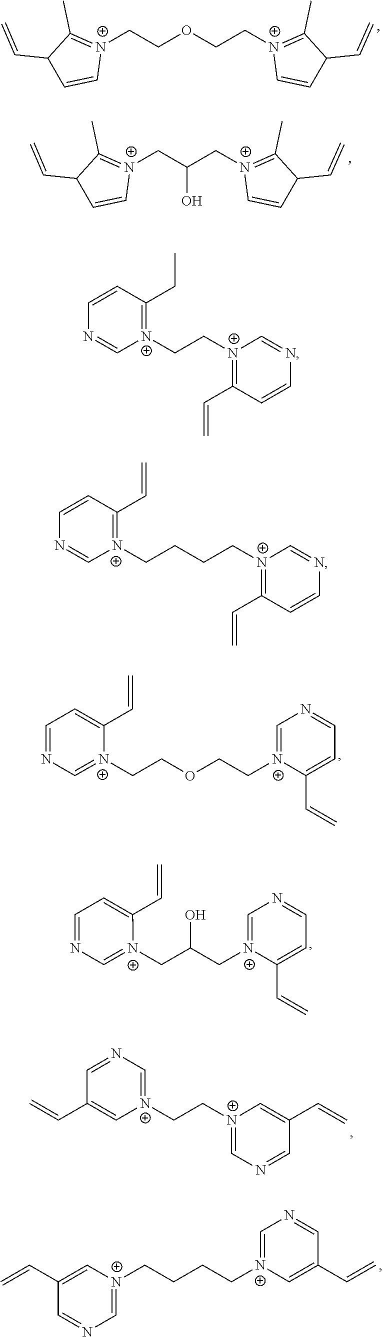 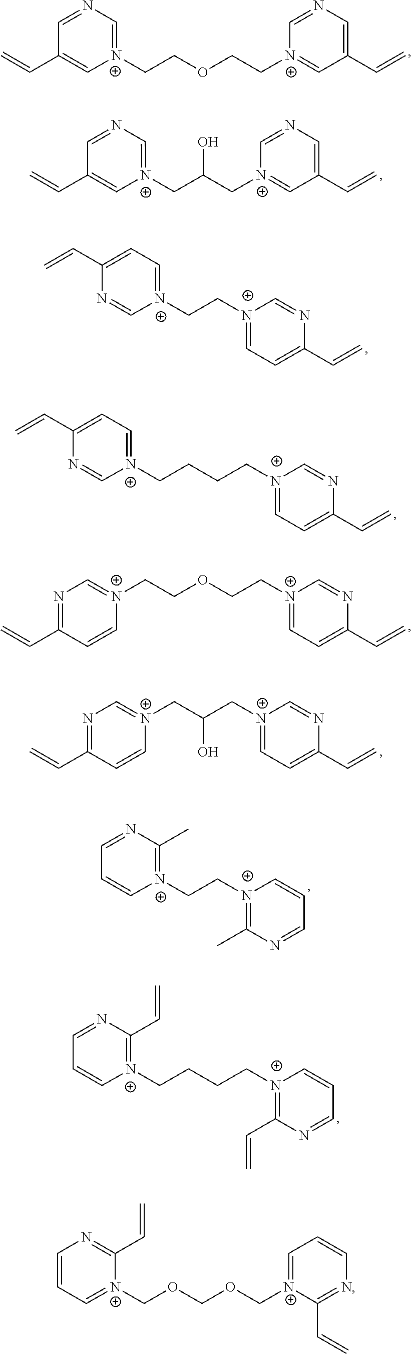 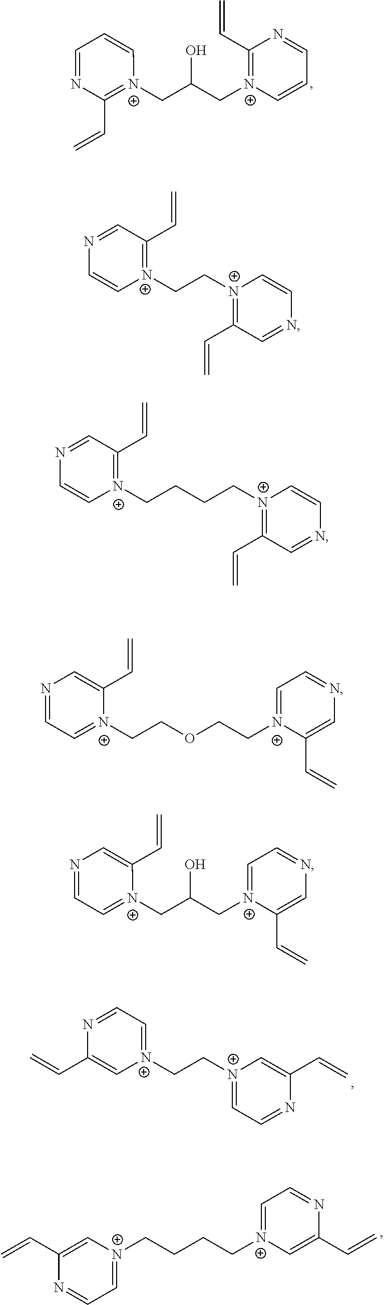 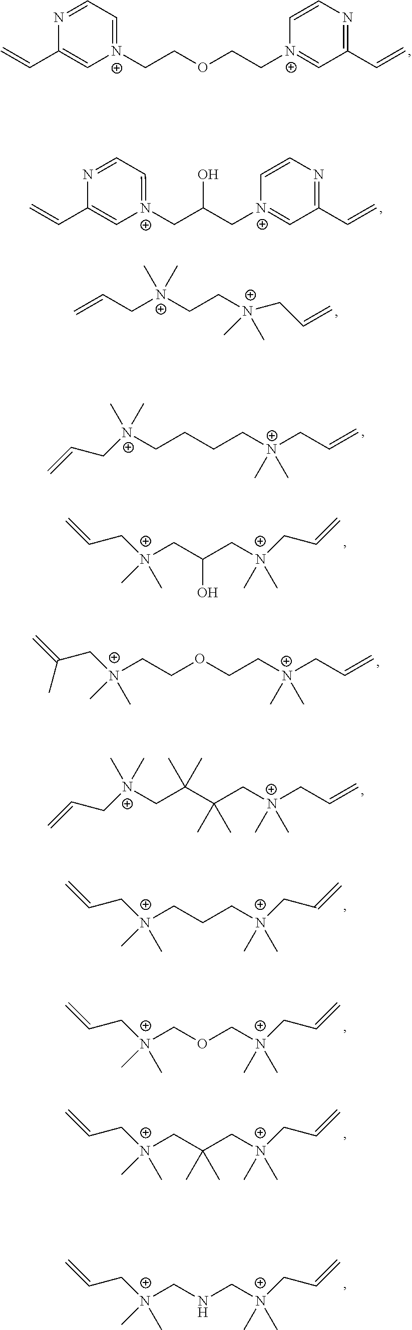 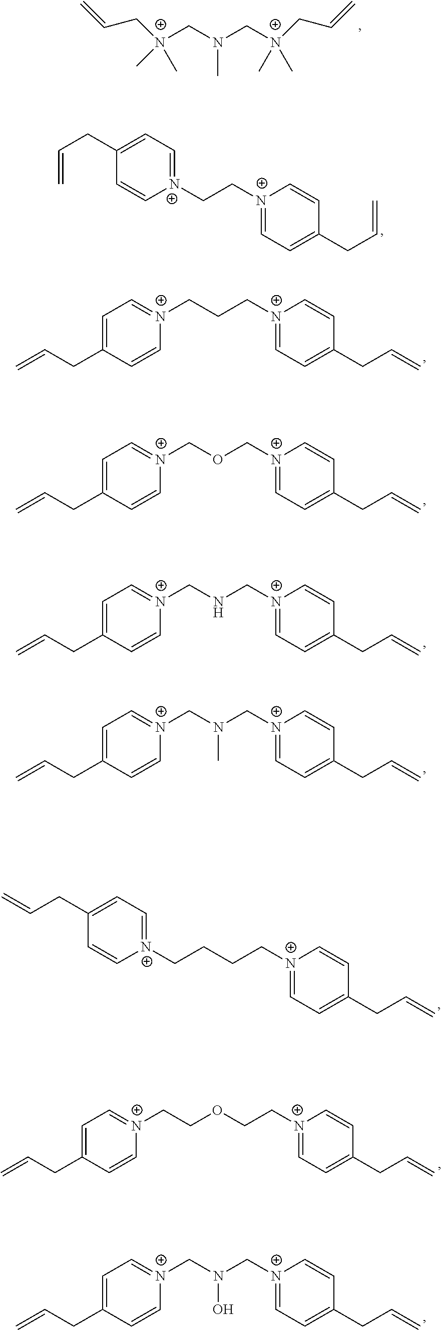 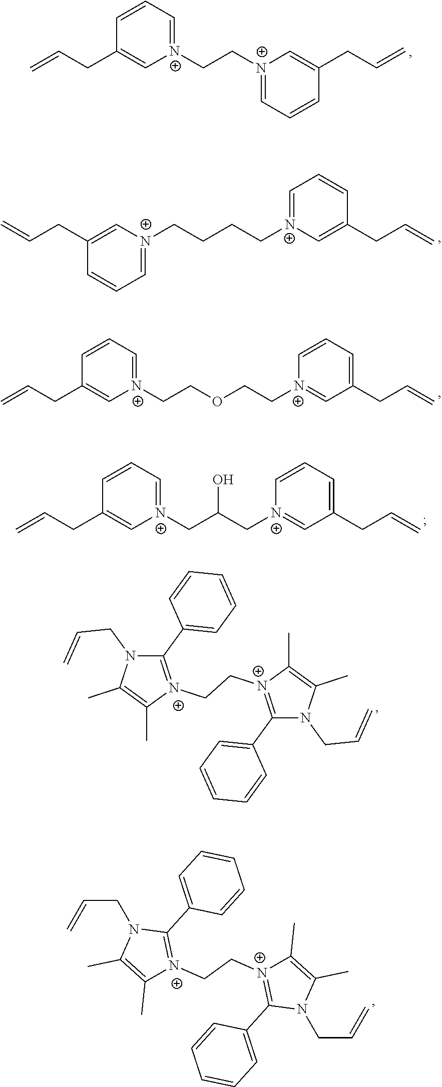 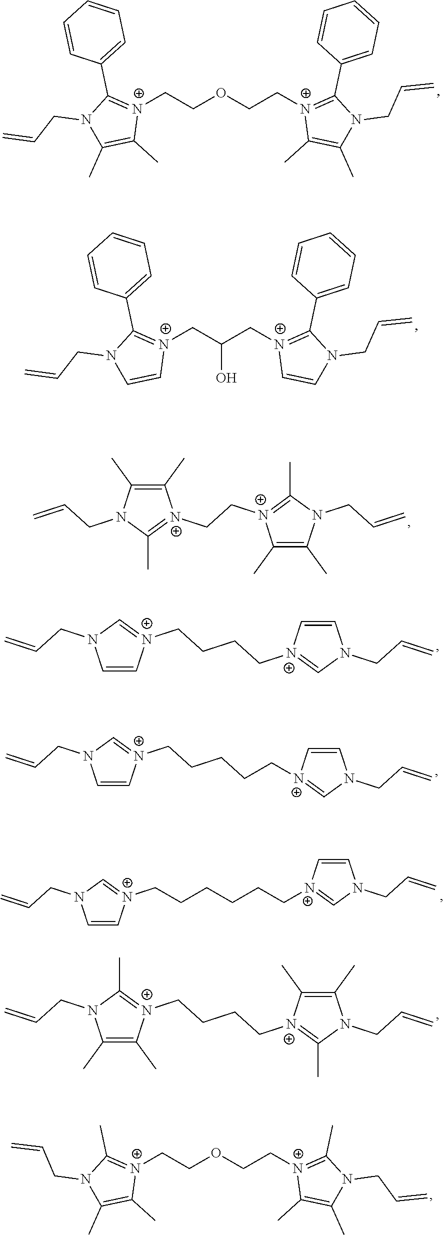 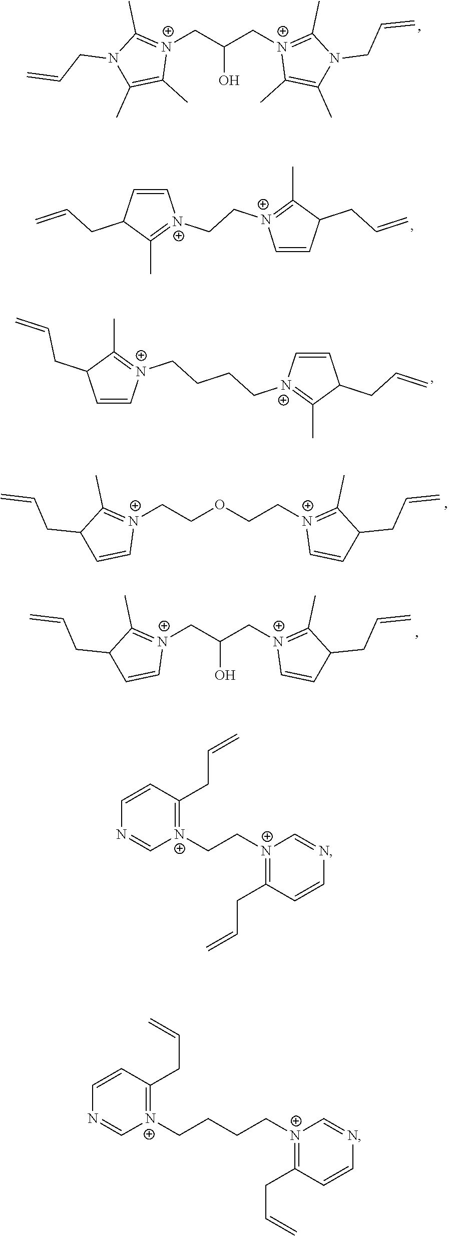 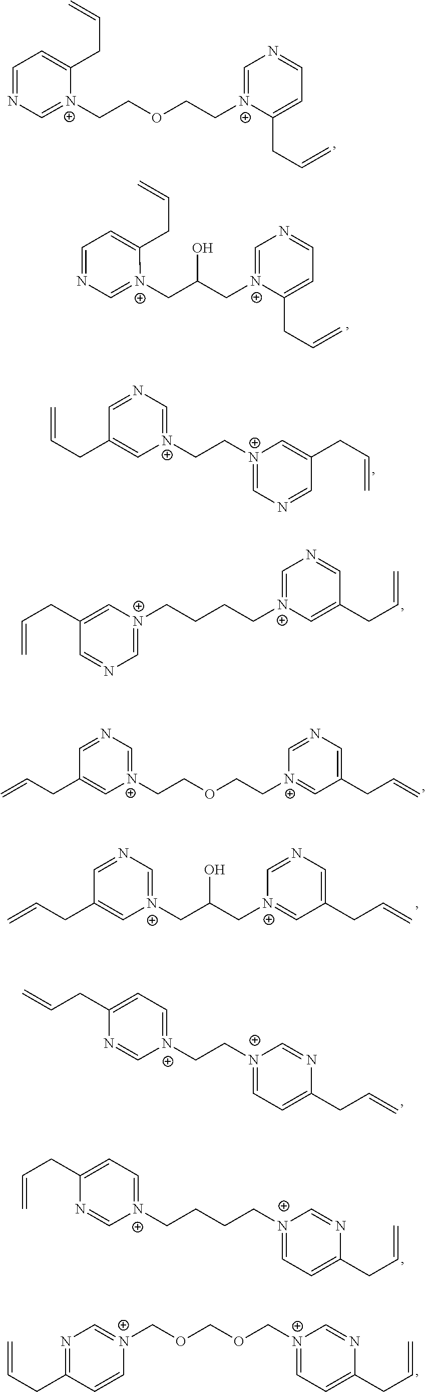 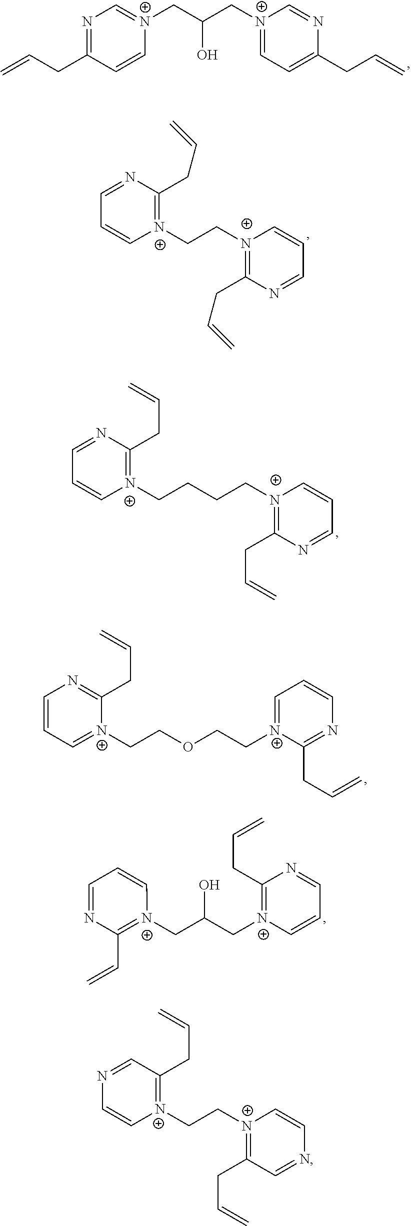 [SMILES: C=CCc1cc[n+](CC(O)C[n+]2ccc(CC=C)nc2)cn1 ; C=CCc1nccc[n+]1CC[n+]1cccnc1CC=C ; C=CCc1nccc[n+]1CCCC[n+]1cccnc1CC=C ; C=CCc1nccc[n+]1CCOCC[n+]1cccnc1CC=C ; C=CCc1nccc[n+]1CC(O)C[n+]1cccnc1C=C ; C=CCc1cncc[n+]1CC[n+]1ccncc1CC=C] 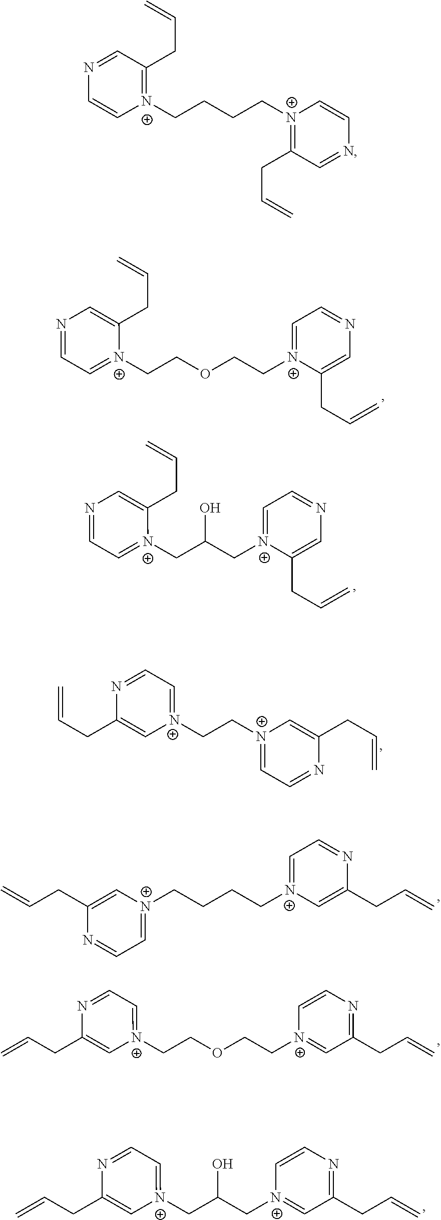 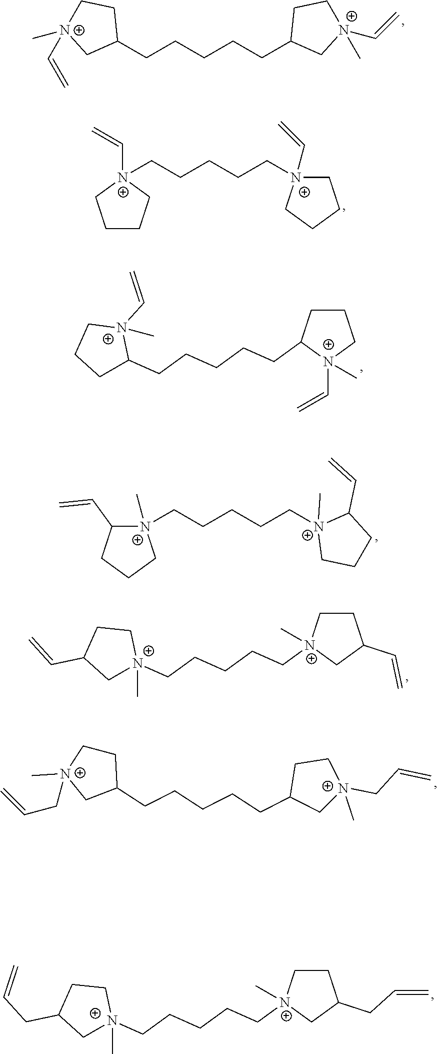 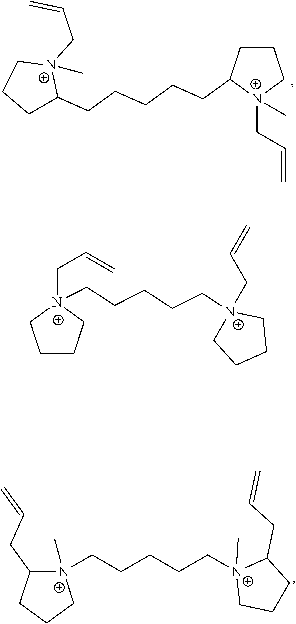 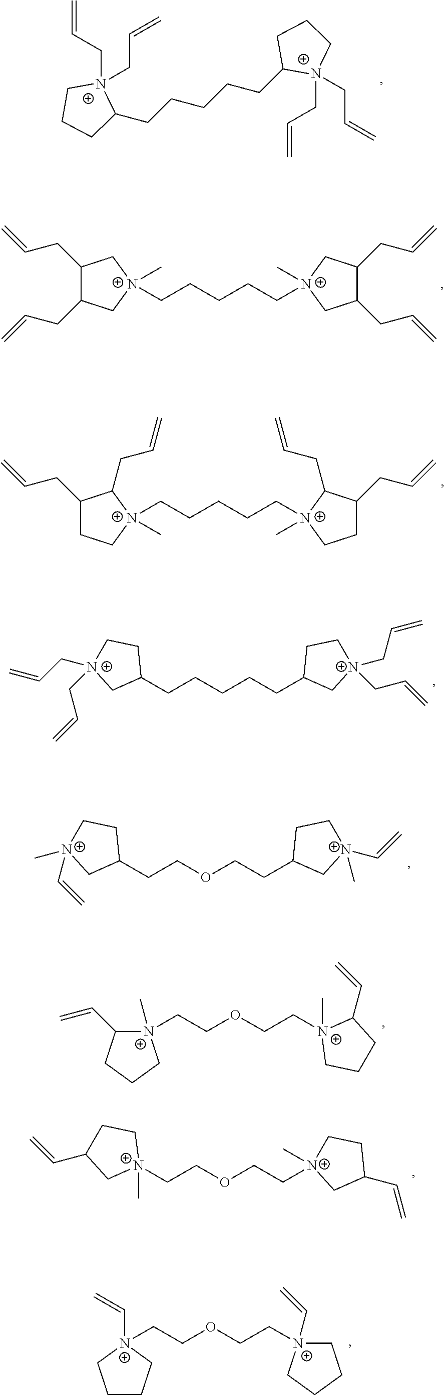 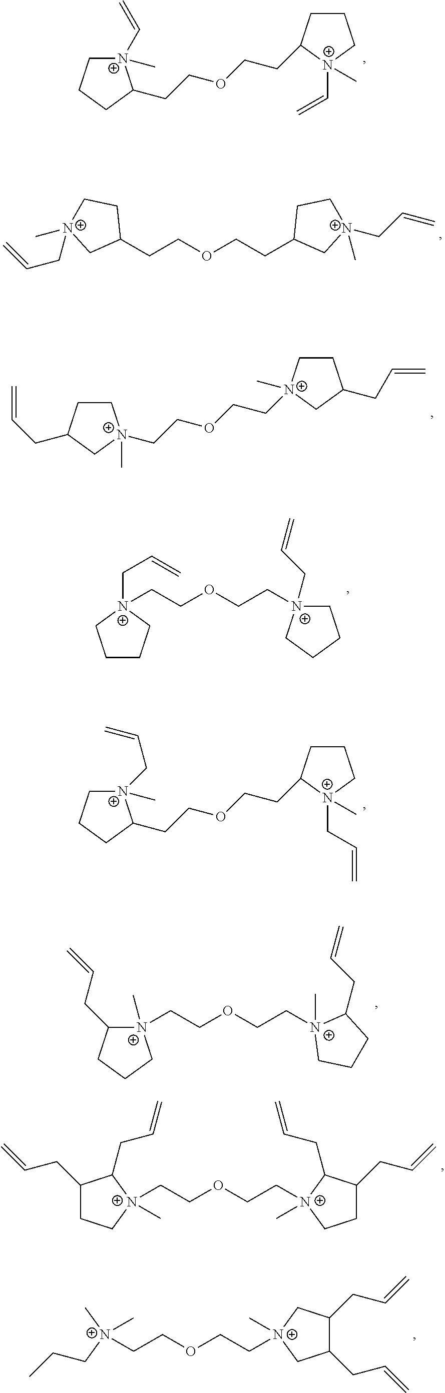 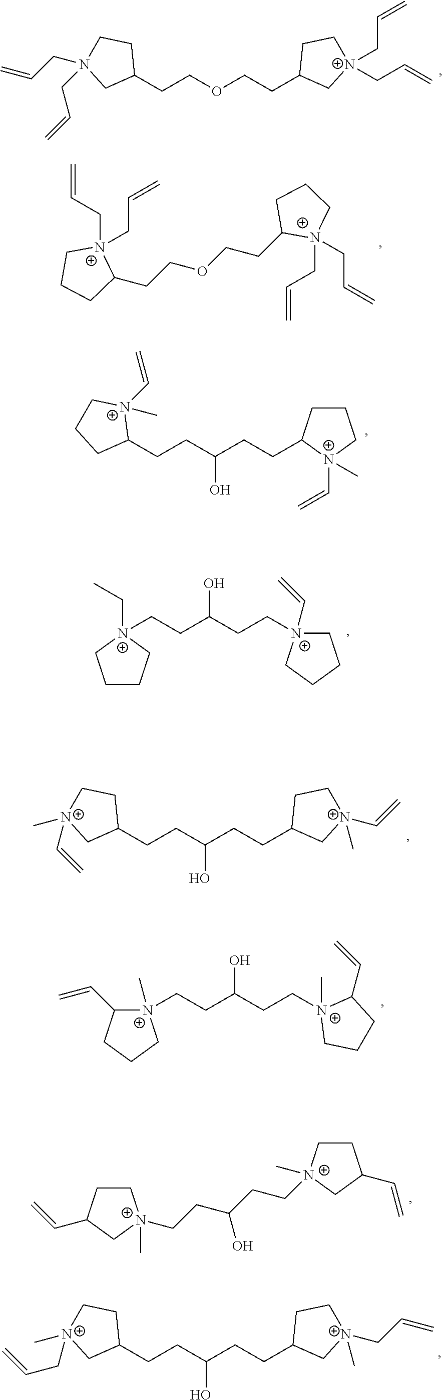 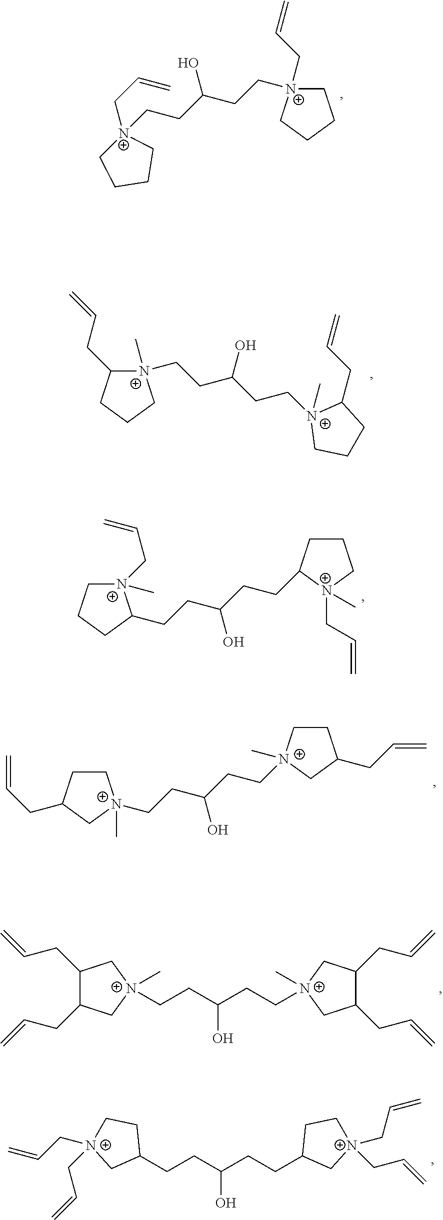 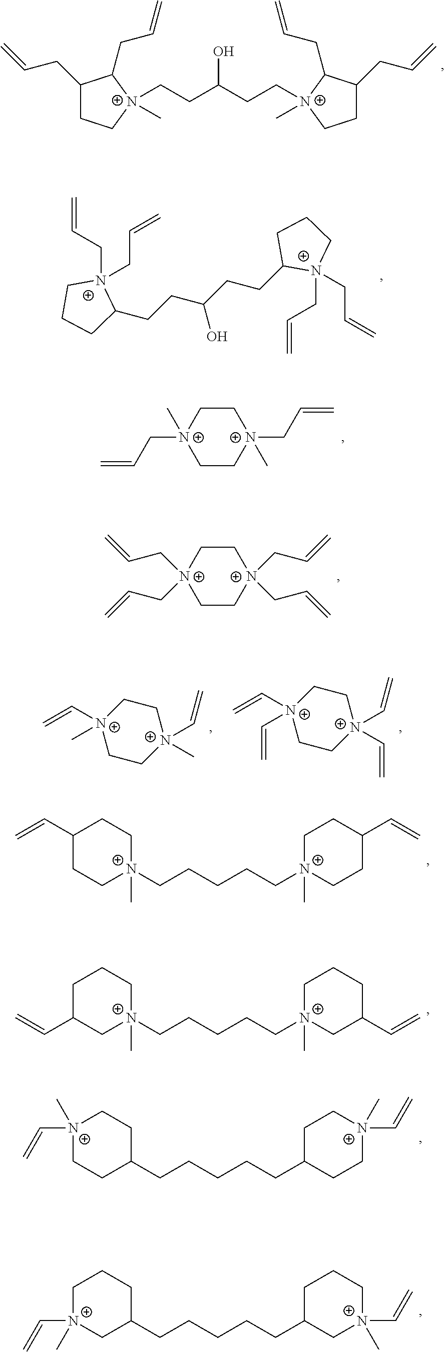 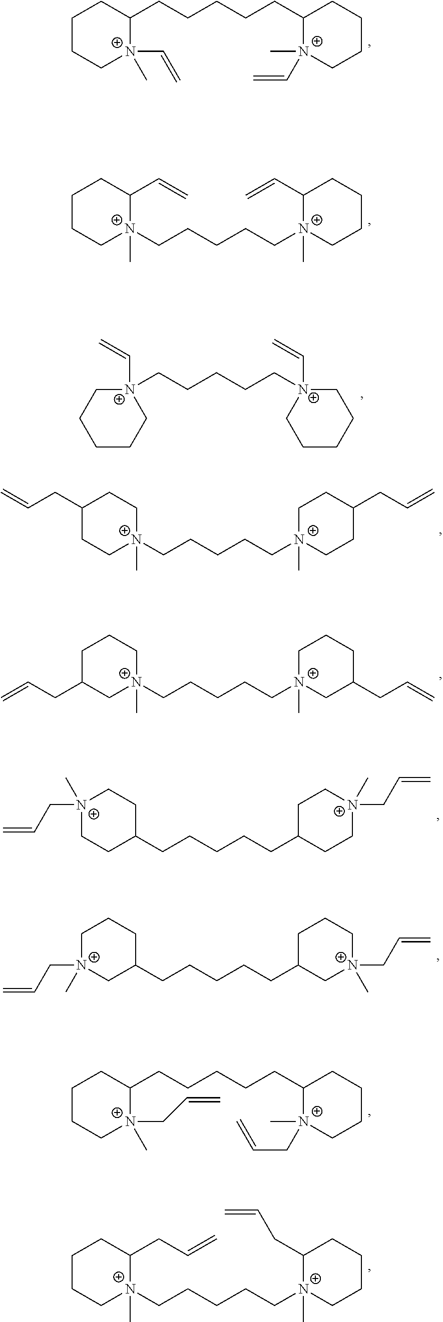 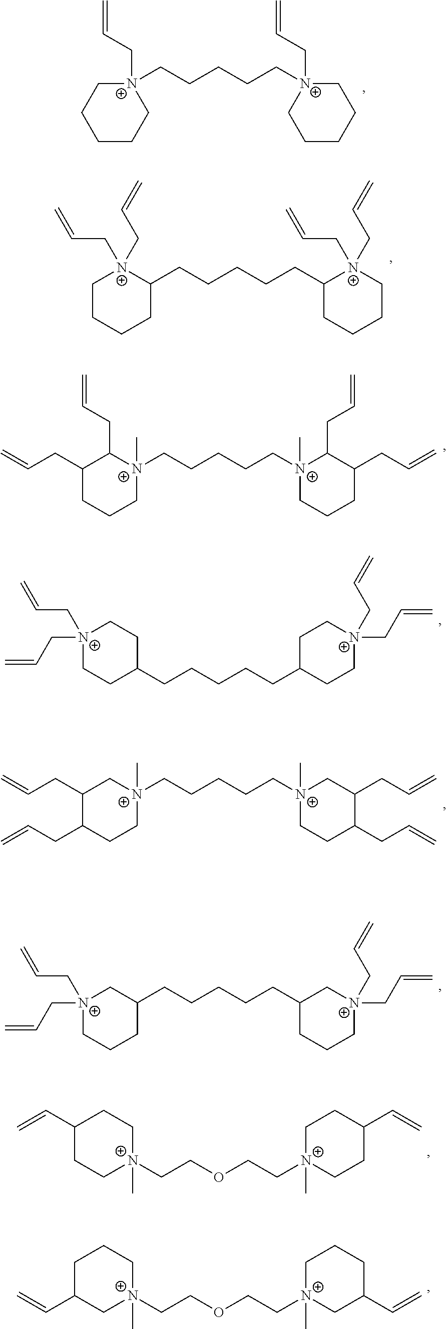 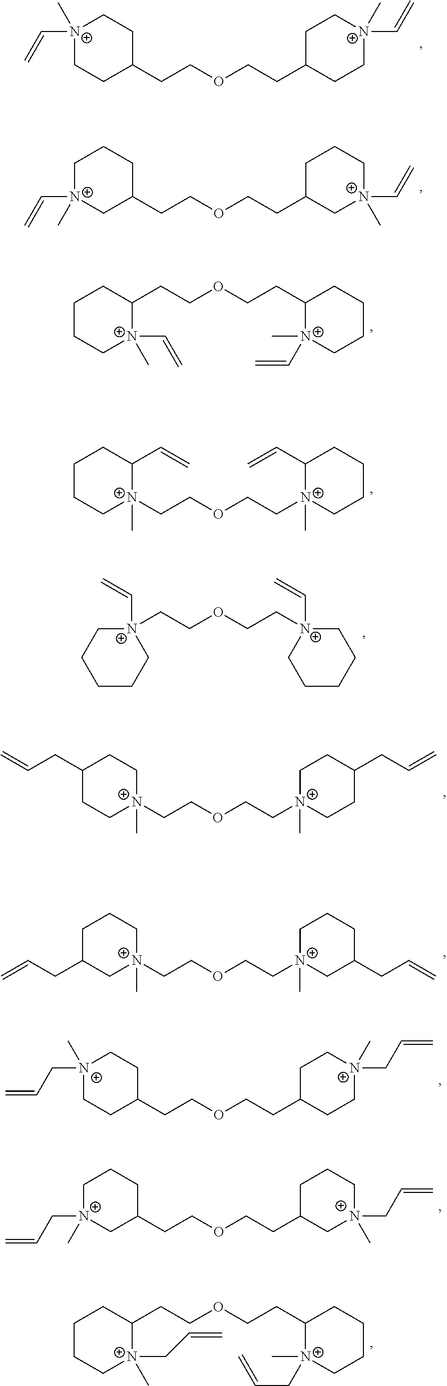 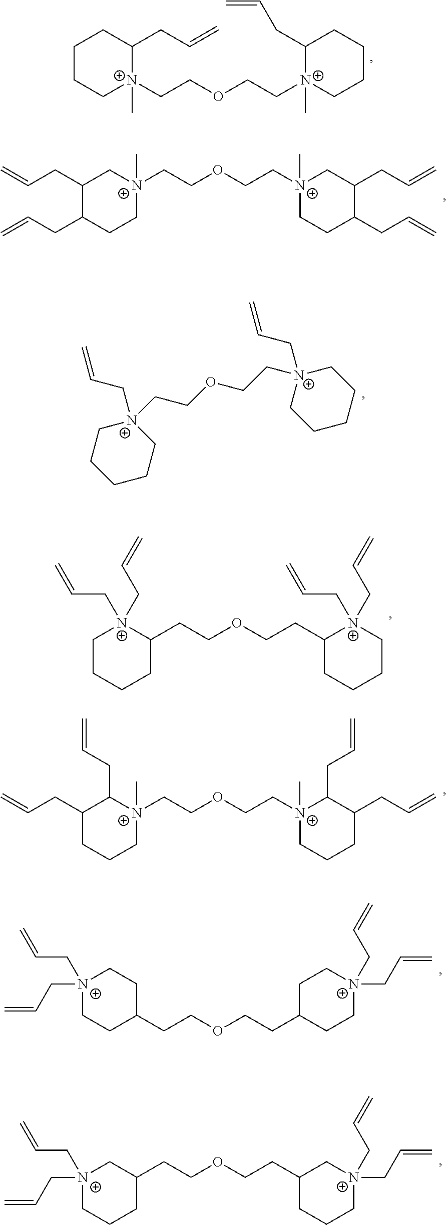 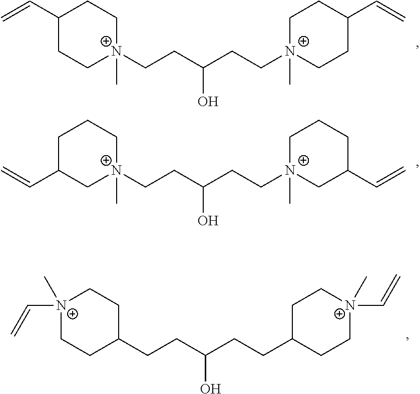 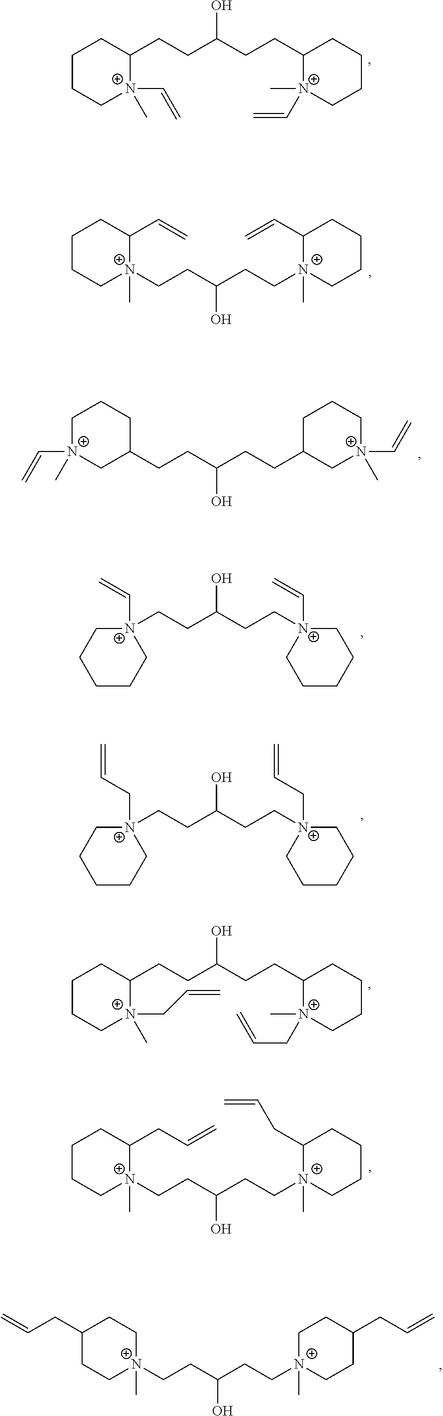 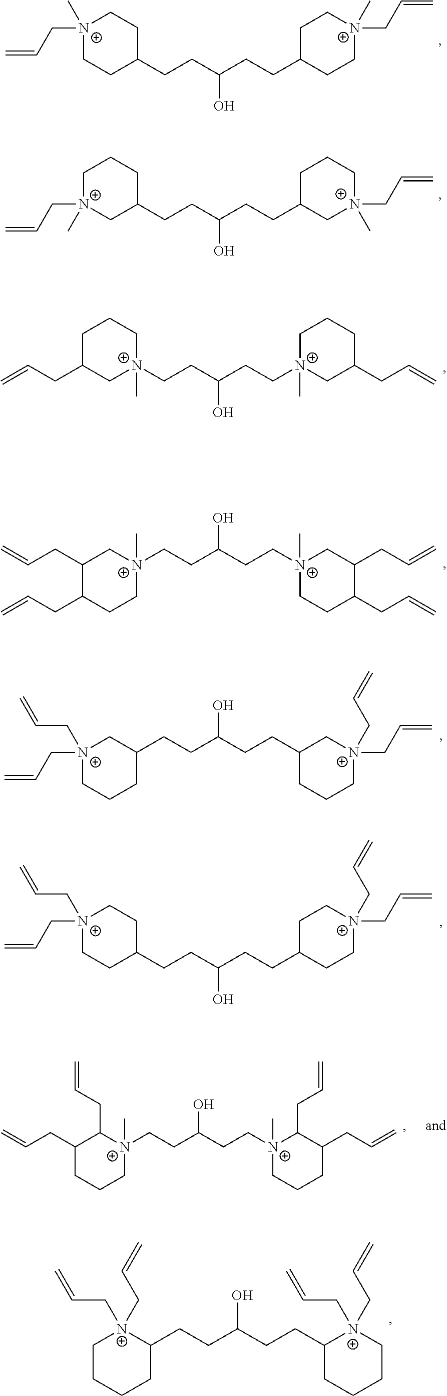
wherein the monomers further include counteranions such that the monomers have electroneutrality.

21. (canceled)

22. (canceled)

23. The ion exchange polymer according to claim 2, wherein the monomers comprise one or more of: 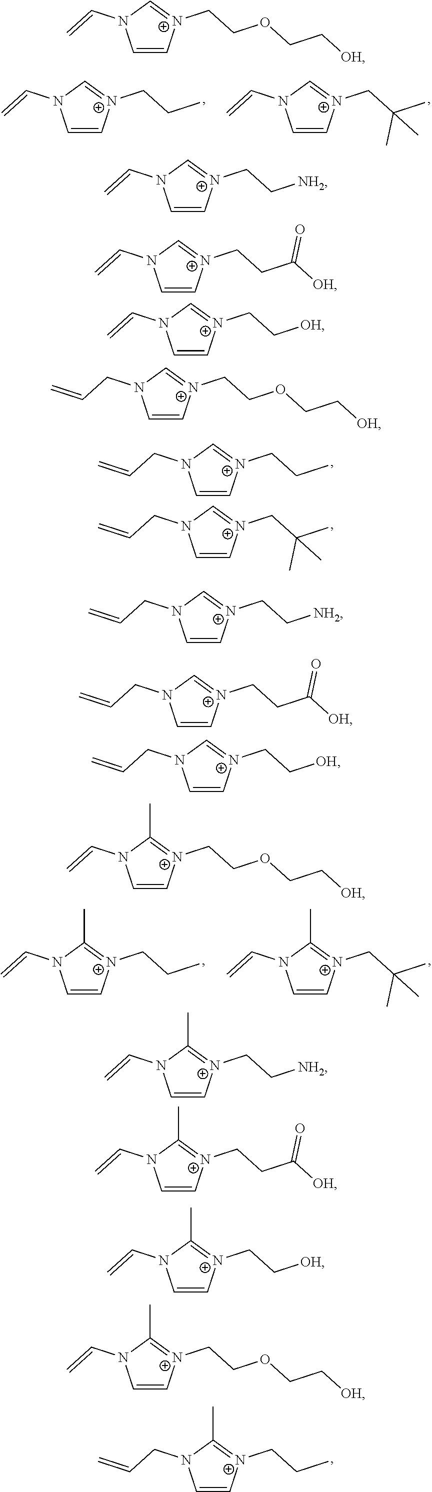 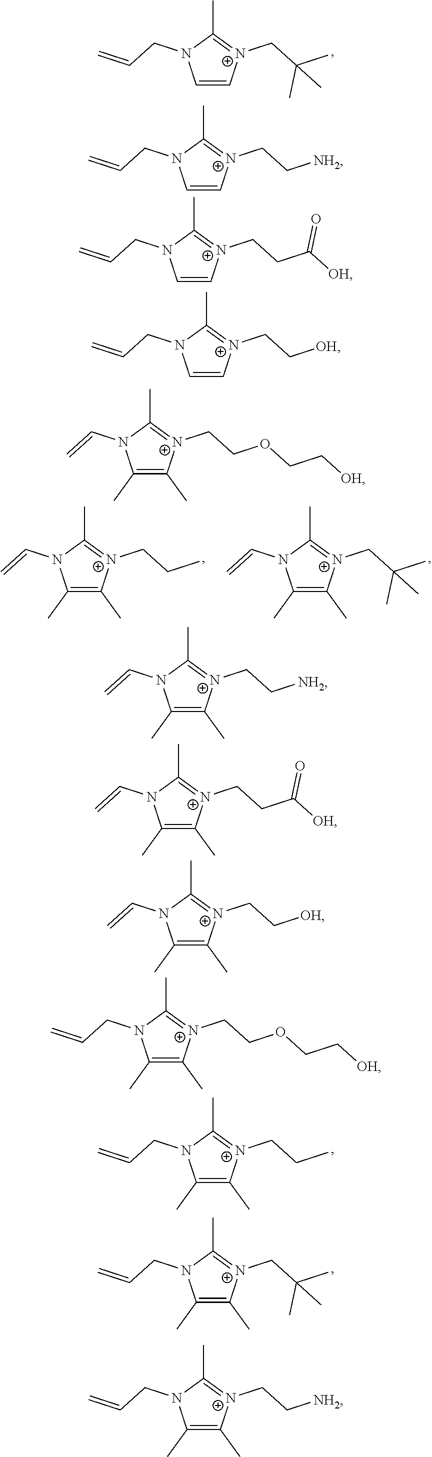 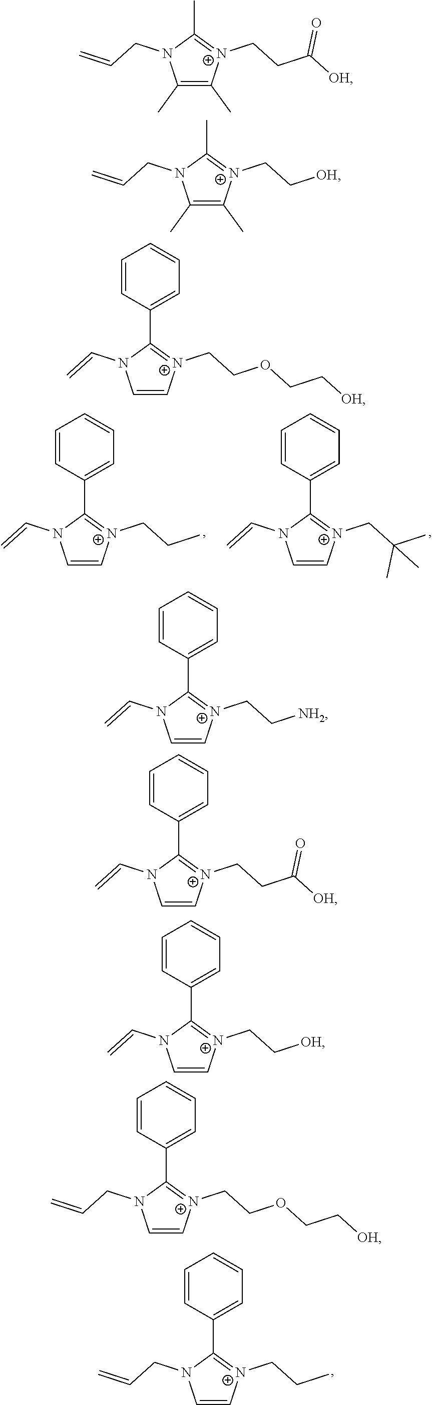 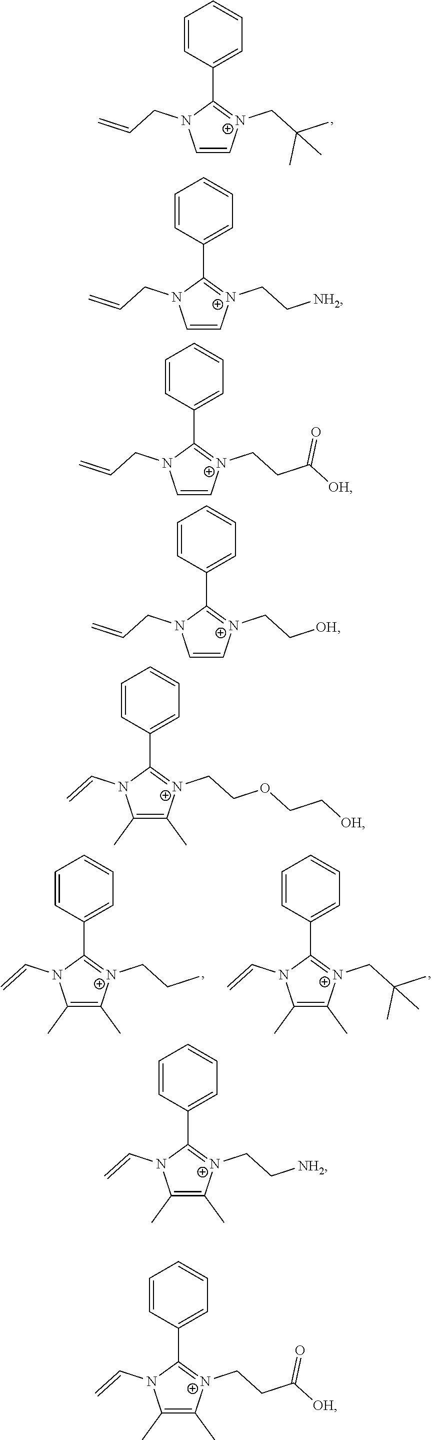 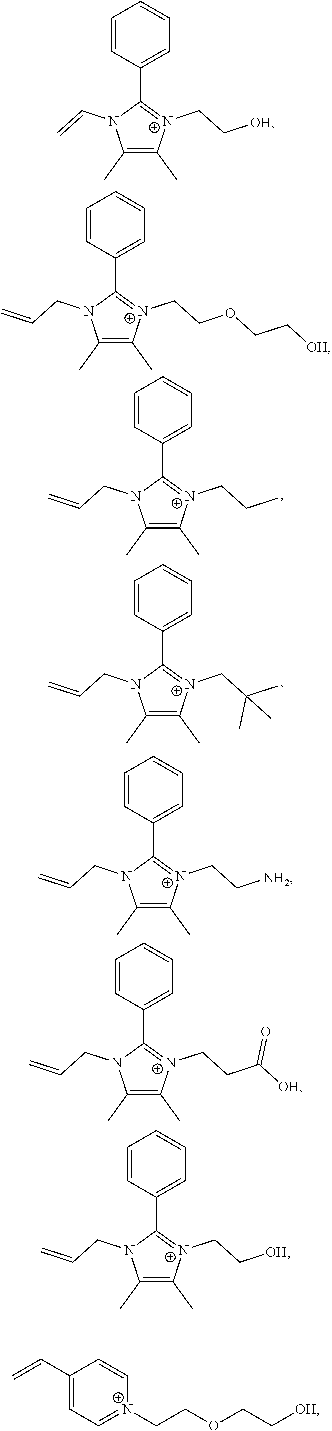 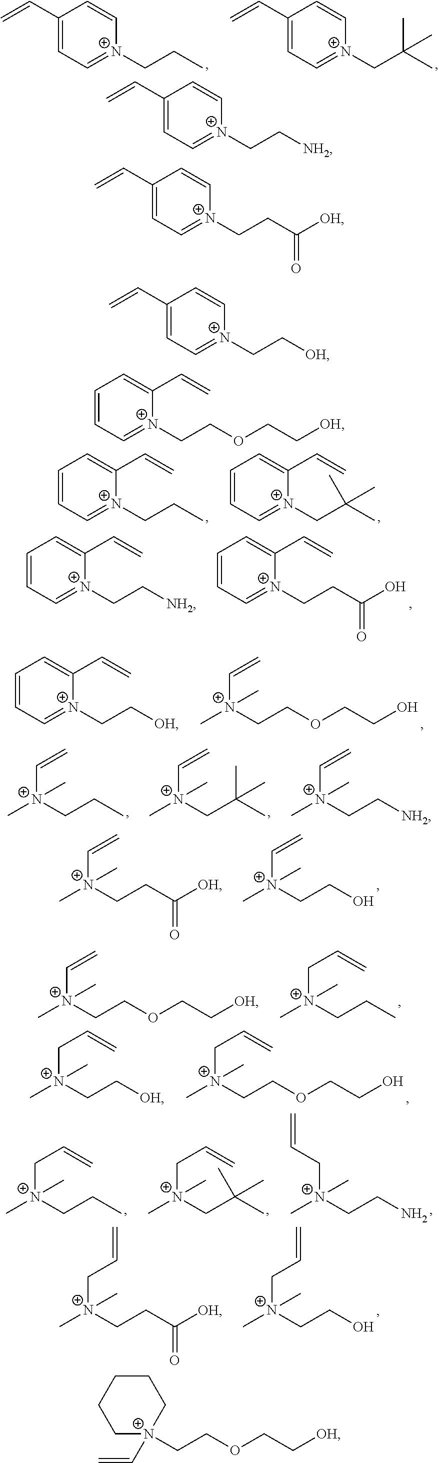 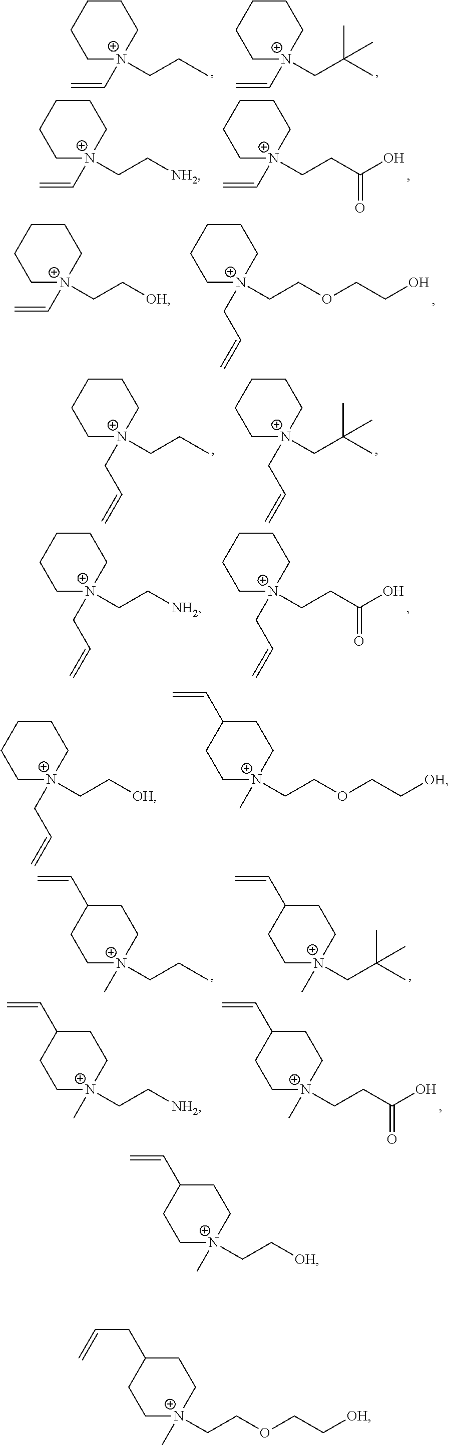 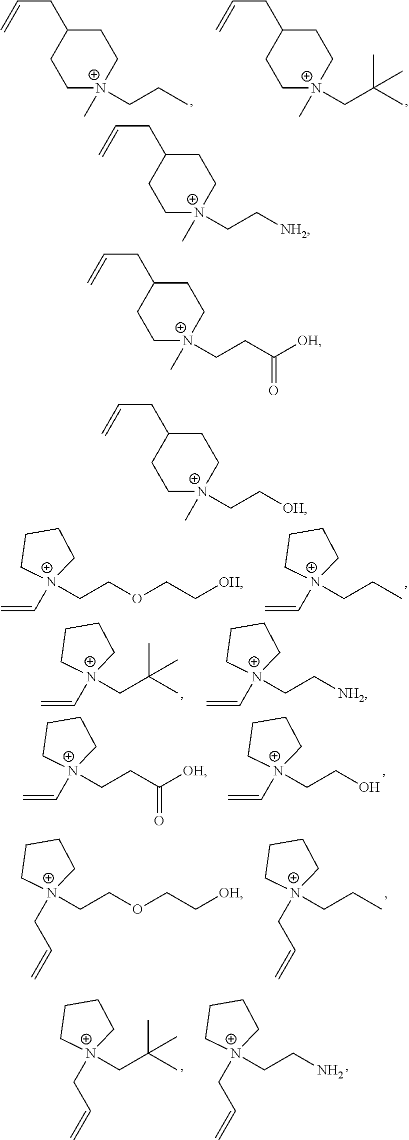 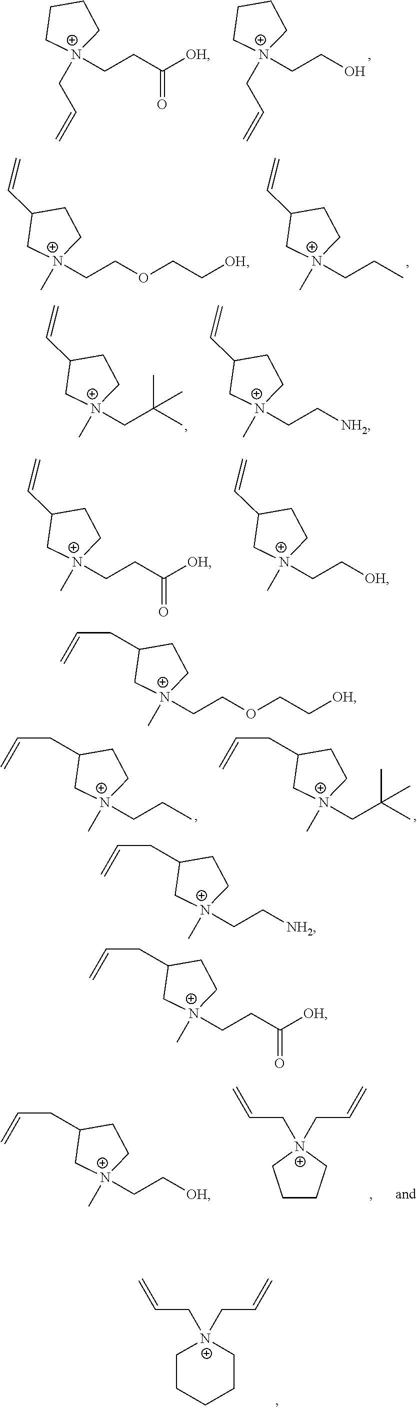
wherein the monomers further include counteranions such that the monomers have electroneutrality.

24. The ion-exchange polymer according to claim 1, wherein the ion-exchange polymer has a charge density in a range of about 1 to about 10 mol/L hydrated polymer at a water volume fraction of 40% or more.

25. The ion-exchange polymer according to claim 1, wherein the ion-exchange polymer has a 1 molal NaCl selectivity in a range of about 7 to about 1500.

26. The ion-exchange polymer according to claim 1, wherein the ion-exchange polymer has a salt permeability in a range of about 5×10⁻¹⁰ to about 3×10⁻⁶ cm² membrane.

27. The ion-exchange polymer according to claim 1, wherein the ion-exchange polymer has a chloride ion conductivity at 22±1° C. in a range of about 10 to about 90 mS/cm.

28. An ion-exchange polymer, comprising:
a structure represented by Formula (I), Formula (II), Formula (III), Formula (IV), Formula (V), Formula (VI), Formula (VII), Formula (VIII), Formula (IX), or Formula (X): 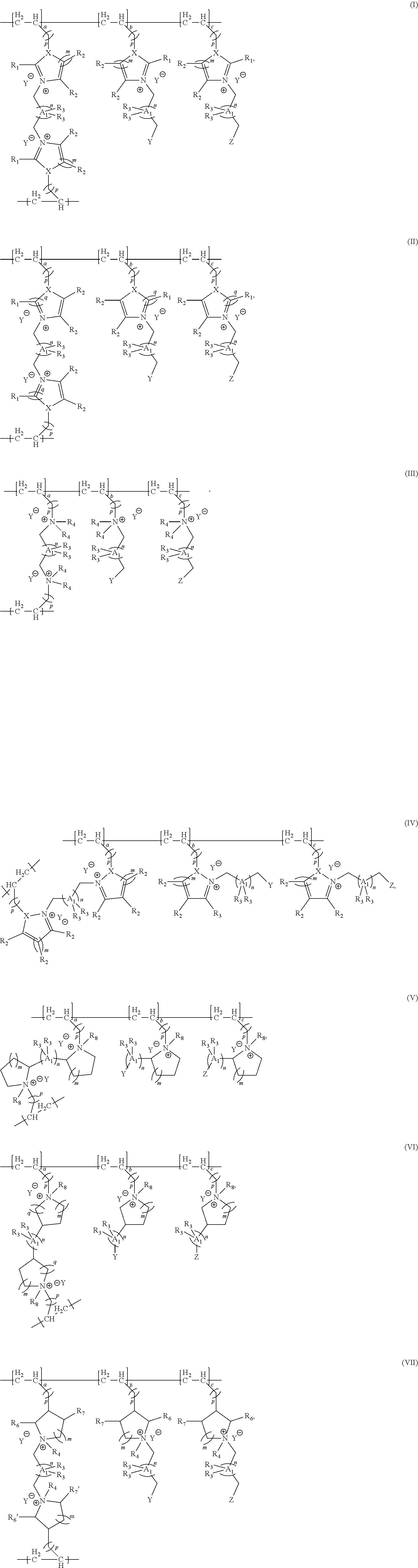 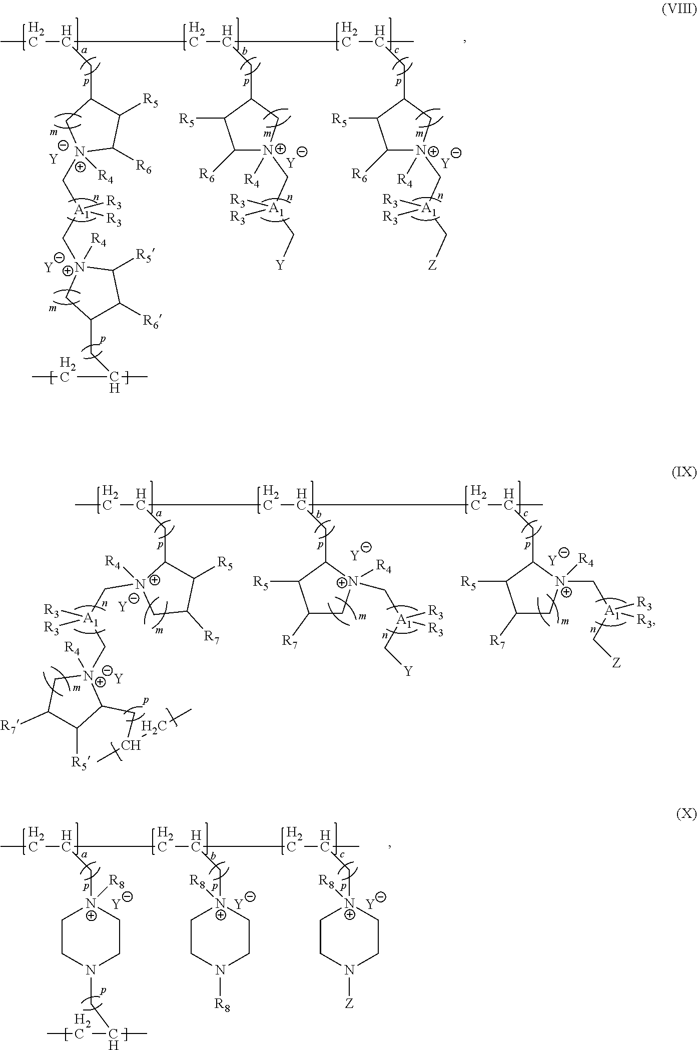
wherein:
each x is independently selected from C(H) and N;
each A₁ is independently selected from C, N, and O, wherein when two adjacent A₁ are N, then one R₃ on at least one N is absent;
n is 0, 1, 2, 3, 4, 5, 6, 7, 8, 9, or 10;
each m is independently 1 or 2;
each q is independently 1 or 2;
each p is independently 0 or 1;
each Y is independently an inorganic anion or an organic anion;
each R₁ is independently selected from H, OH, C₁-C₆alkyl, O—C₁-C₆alkyl, C₅-C₆cycloalkyl, and substituted or unsubstituted phenyl;
each R₂ is independently selected from H, OH, C₁-C₆alkyl, O—C₁-C₆alkyl, C₅-C₆cycloalkyl, and substituted or unsubstituted phenyl;
each R₃ is independently absent, H, OH, C₁-C₆alkyl, O—C₁-C₆alkyl, C₅-C₆cycloalkyl, or substituted or unsubstituted phenyl;
each R₄ is independently selected from C₁-C₆alkyl, C₅-C₆cycloalkyl, and substituted or unsubstituted phenyl, or two geminal R₄ together with the N atom to which they are attached form a 5- to 8-member heterocycloalkyl;
each of R₅, R₅′, R₆, R₆′, R₇, and R₇′ are independently selected from CH═CH₂, CH₂CH═CH₂, and H;
each R₈ is independently selected from CH═CH₂, CH₂CH═CH₂, C₁-C₆alkyl, C₅-C₆cycloalkyl, and substituted or unsubstituted phenyl;
and wherein 0.75≤a+c≤1, 0<a≤0.75, 0≤b≤0.25, 0≤c<0.75, and a+b+c=1.

29.-53. (canceled)

54. A method of preparing an ion-exchange polymer, the method comprising:
a) admixing
a polymerization initiator; and
a monomer solution consisting of an optional solvent and a plurality of monomers, the plurality of monomers consisting of monomers selected from the group of monomers according to Compound (I), Compound (II), Compound (III), Compound (IV), Compound (V), Compound (VII), Compound (VIII), and a combination thereof and, optionally, monomers selected from the group of monomers according to Compound (IX), Compound (X), Compound (XI), Compound (XII), Compound (XIII), Compound (XIV), Compound (XV), Compound (Ia), Compound (IIa), Compound (IIIa), Compound (IVa), Compound (Va), Compound (VIa), Compound (VIIa), Compound (VIIIa), and a combination thereof: 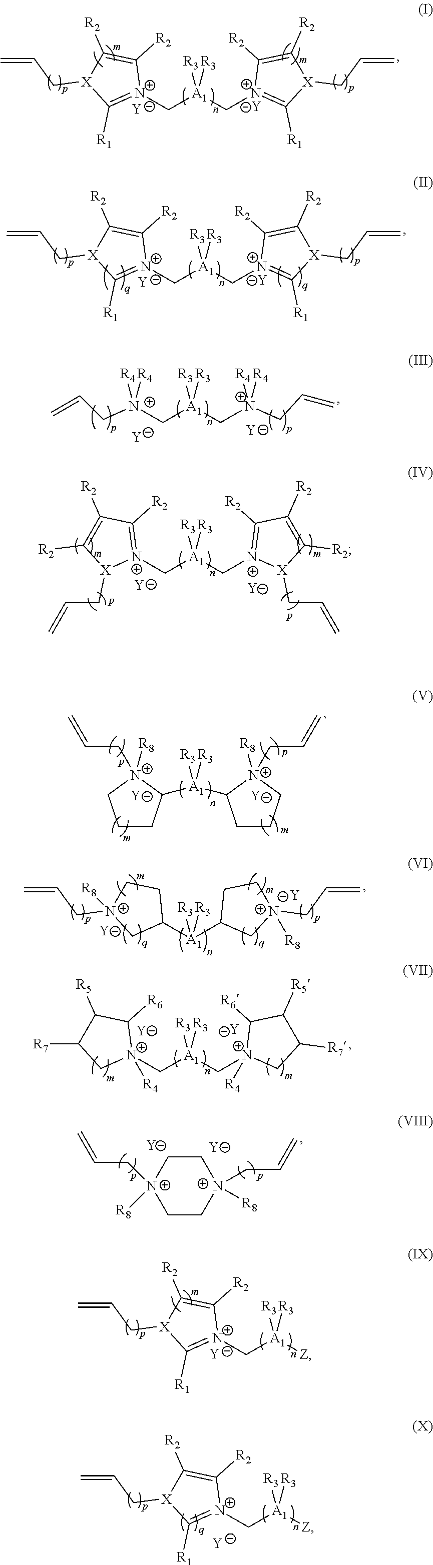 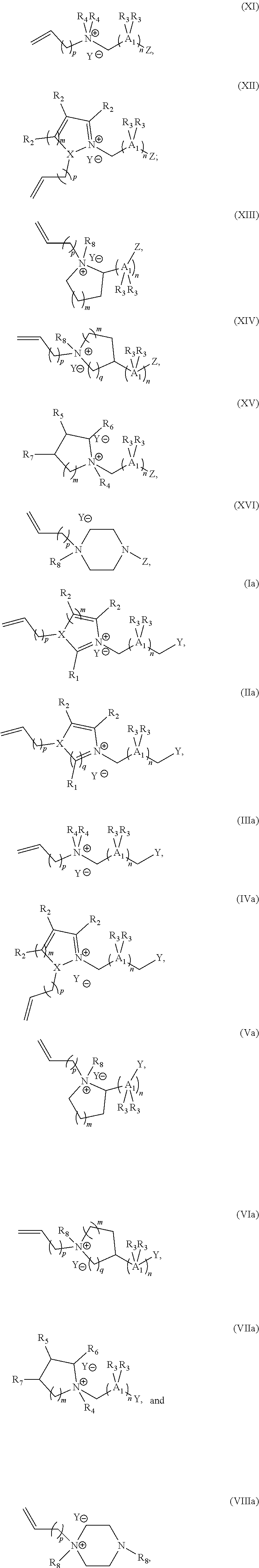
wherein
each x is independently selected from C(H) and N;
each A₁ is independently selected from C, N, and O, wherein when two adjacent A₁ are N, then one R₃ on at least one N is absent;
n is 0, 1, 2, 3, 4, or 5;
each m is independently 1 or 2;
each q is independently 1 or 2;
each p Is 0 or 1;
each R₁ is independently selected from H, OH, C₁-C₆alkyl, O—C₁-C₆alkyl, C₅-C₆cycloalkyl, and substituted or unsubstituted phenyl;
each R₂ is independently selected from H, OH, C₁-C₆alkyl, O—C₁-C₆alkyl, C₅-C₆cycloalkyl, and substituted or unsubstituted phenyl;
each R₃ is independently absent, H, OH, C₁-C₆alkyl, O—C₁-C₆alkyl, C₅-C₆cycloalkyl, or substituted or unsubstituted phenyl;
each R₄ is independently selected from C₁-C₆alkyl, C₅-C₆cycloalkyl, and substituted or unsubstituted phenyl or two geminal R₄ together with the N atom to which they are attached form a 5- to 8-member heterocycloalkyl;
each of R₅, R₅′, R₅, R₅′, R₇, and R₇′ are selected from CH═CH₂, CH₂CH═CH₂ and H, wherein at least one of R₅, R₅, and R₇ is CH═CH₂ or CH₂CH═CH₂ and at least one of R₅′, R₅′, and R₇′ is CH═CH₂ or CH₂CH═CH₂,
each R₈ is independently selected from CH═CH₂, CH₂CH═CH₂, C₁-C₆alkyl, C₅-C₆cycloalkyl, and substituted or unsubstituted phenyl;
each Y is independently an inorganic anion or an organic anion; and
each Z is independently selected from H, OH, NH₂, C(O)OH, C₁-C₆alkyl, C₁-C₆alkyl-OH, C₁-C₆alkyl-C(O)OH, CH═CH₂, and CH₂CH═CH₂; and
b) polymerizing the monomer solution to form the ion-exchange polymer.

55.-63. (canceled)
